(19) United States
(12) Patent Application Publication
(10) Pub. No.: US 2024/0134232 A1
(43) Pub. Date: Apr. 25, 2024

(54) LIQUID CRYSTAL LIGHT CONTROL APPARATUS, LIGHT CONTROL METHOD FOR LIQUID CRYSTAL LIGHT CONTROL APPARATUS, AND NON-TRANSITORY COMPUTER READABLE MEDIUM STORING LIQUID CRYSTAL LIGHT CONTROL PROGRAM

(71) Applicant: DIC Corporation, Tokyo (JP)

(72) Inventor: Yuichi Inoue, Kita-adachi-gun (JP)

(73) Assignee: DIC Corporation, Tokyo (JP)

(21) Appl. No.: 18/367,141

(22) Filed: Sep. 12, 2023

(30) Foreign Application Priority Data
Sep. 26, 2022 (JP) 2022-153157

(51) Int. Cl. G02F 1/1337; G02F 1/01; G02F 1/1343

(52) U.S. Cl. CPC G02F 1/133742; G02F 1/0123; G02F 1/13439

(57) ABSTRACT

A liquid crystal light control apparatus includes: a pair of electrodes; a liquid crystal composition that is disposed between the pair of electrodes and satisfies d/p≥2, where d (μm) is the distance between the electrodes and p (μm) is a chiral pitch; a voltage application unit that applies a voltage between the electrodes; and a controller that controls the voltage application unit such that an intermediate voltage for aligning liquid crystal molecules of the liquid crystal composition in a focal conic alignment state is applied between the electrodes after a first voltage for aligning the liquid crystal molecules in a homeotropic alignment state is applied between the electrodes but before a second voltage that is different in magnitude from the first voltage and is for aligning the liquid crystal molecules in a planar alignment state is applied between the electrodes.

### BACKGROUND OF THE INVENTION

### 1. Field of the Invention

Techniques of the present disclosure relate to a liquid crystal light control apparatus, a light control method for the liquid crystal light control apparatus, and a non-transitory computer readable medium storing a liquid crystal light control program.

### 2. Description of the Related Art

Liquid crystal materials have been used for display material devices typified by TV sets and smartphones that display text, images, and video and are also being considered for use in smart windows used as light control devices for controlling the amount of light transmission. The smart windows are windows capable of controlling the amount of sunlight passing therethrough, and their demand for use in maintaining comfortable indoor environments is growing. In one main mode of smart windows currently in practical use, a monomer/polymer or a dichroic dye is added to a liquid crystal. One known mode is a guest host liquid crystal (GHLC) layer formed of a p-type liquid crystal having positive dielectric anisotropy and a dye added thereto. In this case, when the potential difference between the upper and lower electrodes of the liquid crystal layer is zero or very small, the orientation of the liquid crystal molecules and the orientation of the dye are parallel to the electrodes, and the dye absorbs incident light and develops a color. When the potential difference between the upper and lower electrodes of the liquid crystal layer is increased, the orientation of the liquid crystal molecules and the orientation of the dye are parallel to the direction of the electric field between the electrodes (generally, the direction of the incident light). In this case, the dye absorbs almost no light and is transparent.

It is known that, in order to increase the contrast ratio between the transmittance of the guest host liquid crystal layer when the potential difference between the upper and lower electrodes is set to zero etc. and that when the potential difference is increased, increasing the distance between the pair of electrodes (cell gap) or increasing the number of twists of the liquid crystal molecules is effective (see Japanese Unexamined Patent Application Publication No. 06-027496).

### SUMMARY OF THE INVENTION

However, the above conventional technique has the following problem. When the number of twists is increased, a large number of alignment defects are formed when the potential difference is reduced from a large value to zero etc. and when the vertical alignment of the liquid crystal molecules is changed to twisted horizontal alignment, and the time required to eliminate the defects and obtain a stable state is long.

It is an object of the techniques of the present disclosure to provide a liquid crystal light control apparatus capable of reducing the time required to bring the liquid crystal molecules to a stable state as compared to that in the conventional technique and to provide a light control method for the liquid crystal light control apparatus and a non-transitory computer readable medium storing a liquid crystal light control program.

A first aspect of the techniques of the present disclosure for achieving the above object is a liquid crystal light control apparatus including: a pair of electrodes; a liquid crystal composition that is disposed between the pair of electrodes and satisfies d/p≥2, where d (μm) is the distance between the pair of electrodes and p (μm) is a chiral pitch; a voltage application unit that applies a voltage between the pair of electrodes; and a controller that controls the voltage application unit such that an intermediate voltage for aligning liquid crystal molecules of the liquid crystal composition in a focal conic alignment state is applied between the pair of electrodes after a first voltage for aligning the liquid crystal molecules in a homeotropic alignment state is applied between the pair of electrodes but before a second voltage that is different in magnitude from the first voltage and is for aligning the liquid crystal molecules in a planar alignment state is applied between the pair of electrodes.

A second aspect is a light control method for a liquid crystal light control apparatus including a pair of electrodes, a liquid crystal composition that is disposed between the pair of electrodes and satisfies d/p≥2, where d (μm) is the distance between the pair of electrodes and p (μm) is a chiral pitch, and a voltage application unit that applies a voltage between the pair of electrodes, the method including applying, between the pair of electrodes, an intermediate voltage for aligning liquid crystal molecules of the liquid crystal composition in a focal conic alignment state after a first voltage for aligning the liquid crystal molecules in a homeotropic alignment state is applied between the pair of electrodes but before a second voltage that is different in magnitude from the first voltage and is for aligning the liquid crystal molecules in a planar alignment state is applied between the pair of electrodes.

A third aspect is a non-transitory computer readable medium storing a liquid crystal light control program that causes a computer to function as the controller in the liquid crystal light control apparatus according to the first aspect.

### BRIEF DESCRIPTION OF THE DRAWINGS

FIG. 1 is a block diagram showing a schematic structure of a liquid crystal light control apparatus in an embodiment.

FIG. 2 shows conceptual illustrations of alignment states of liquid crystal molecules of a liquid crystal composition in the liquid crystal light control apparatus in the embodiment, the illustrations showing a planar alignment state (the left illustration) when a second voltage V2 is applied between a pair of electrodes and a homeotropic alignment state when a first voltage V1 is applied between the pair of electrodes.

FIG. 3 is a graph showing the relation between d/p and a dark state transmittance (%) in the planar alignment state when a cell thickness for the liquid crystal composition in the dark state is 10 (μm) and a prescribed amount of a dichroic dye is added.

FIG. 4 is a table showing that as d/p increases, the value of a contrast ratio (bright state transmittance/dark state transmittance) increases.

FIG. 5 is a flowchart of a liquid crystal light control program executed by a CPU of the liquid crystal light control apparatus.

FIG. 6 is a graph showing the relation between a first voltage and the transmittance.

FIG. 7 is a graph showing a first application pattern for an intermediate voltage.

FIG. 8 is a graph showing the relation between the temperature of the liquid crystal composition and the application time of a first intermediate voltage in the first application pattern.

FIG. 9 is a graph showing the relation between the temperature of the liquid crystal composition and a second intermediate voltage (a 1st second intermediate voltage) in the first application pattern.

FIG. 10 shows micrographs of observed alignment states of case (I) where no intermediate voltage was applied (I) and case (II) where the intermediate voltage was applied.

FIG. 11 is a graph showing a second application pattern for the intermediate voltage.

FIG. 12 is a graph showing a third application pattern for the intermediate voltage.

FIG. 13 is a graph showing a fourth application pattern for the intermediate voltage.

FIG. 14 is a table showing a first non-application pattern in which no intermediate voltage is applied and fifth to eighth application patterns for the intermediate voltage.

FIG. 15 is a table showing a second non-application pattern in which no intermediate voltage is applied and a ninth application pattern for the intermediate voltage.

### DESCRIPTION OF THE PREFERRED EMBODIMENTS

Referring to the drawings, embodiments of the techniques of the present disclosure will be described.

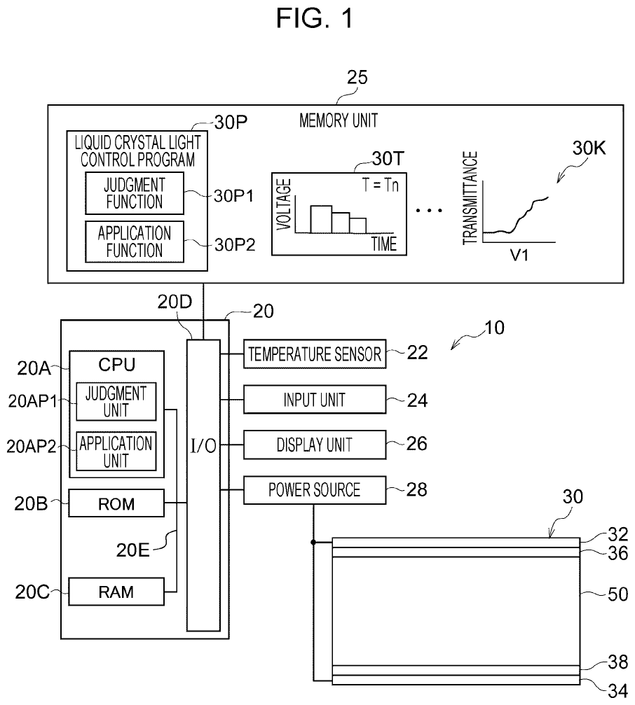

FIG. 1 shows an exemplary schematic structure of a liquid crystal light control apparatus 10 in an embodiment. As shown in FIG. 1, the liquid crystal light control apparatus 10 includes a computer 20, a memory unit 25, a temperature sensor 22, an input unit 24, a display unit 26, a power source 28, and a liquid crystal panel (liquid crystal light control device) 30.

The power source 28 is an example of a “voltage application unit” in the techniques of the present disclosure, and the temperature sensor 22 is an example of a “detection unit” in the techniques of the present disclosure. The computer 20 is an example of a “controller” in the techniques of the present disclosure.

The computer 20 includes a CPU (Central Processing Unit) 20A, a ROM (Read Only Memory) 20B, a RAM (Random Access Memory) 20C, and an input/output (I/O) port 20D. The CPU 20A, the ROM 20B, the RAM 20C, and the I/O port 20D are connected to each other through a bus 20E.

The liquid crystal panel 30 includes: a pair of transparent electrodes 32 and 34; a liquid crystal composition 50 that is disposed between the pair of electrodes 32 and 34 and satisfies d/p≥2, where d (μm) is the distance between the pair of electrodes 32 and 34 and p (μm) is a chiral pitch; and a pair of alignment films 36 and 38 that are provided for the respective electrodes 32 and 34 and horizontally align liquid crystal molecules of the liquid crystal composition 50. Preferably, the pair of alignment films 36 and 38 have been subjected to rubbing treatment. The directions of rubbing on the electrodes 32 and 34 may be parallel or antiparallel to each other or may be separated by 90° from each other. The alignment films 36 and 38 are alignment films for horizontal alignment.

As described later, the electrode 32 may be referred to as a first transparent electrode layer 32, and the electrode 34 may be referred to as a second transparent electrode layer 34.

The liquid crystal panel 30 includes an unillustrated substrate (such as glass) supporting the pair of transparent electrodes 32 and 34.

The memory unit 25, the temperature sensor 22, the input unit 24, the display unit 26, and the power source 28 are connected to the I/O port 20D of the computer 20.

The temperature sensor 22 detects the temperature of the liquid crystal composition 50. Specifically, the temperature sensor 22 detects the temperature of the liquid crystal composition 50 directly or indirectly. When the temperature sensor 22 detects the temperature of the liquid crystal composition 50 indirectly, the temperature sensor 22 detects, for example, the temperature of the liquid crystal panel 30 or the temperature around the liquid crystal panel 30 (its ambient temperature) to estimate the temperature of the liquid crystal composition 50.

The power source 28 is an AC power source. Voltages described later are effective values. The pair of electrodes 32 and 34 of the liquid crystal panel 30 are connected to the power source 28. An AC voltage is applied to the pair of electrodes 32 and 34 such that the potential difference between the pair of electrodes 32 and 34 takes on one of the voltage values described later. In particular, the power source 28 is preferably a square wave AC power source. The frequency is preferably 30 to 100 (Hz). The power source 28 may be a DC power source.

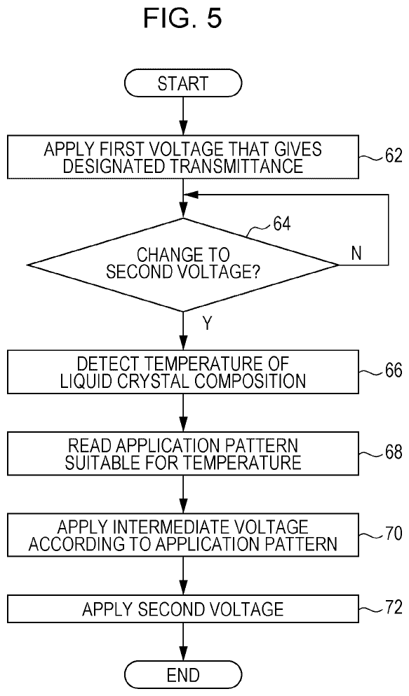

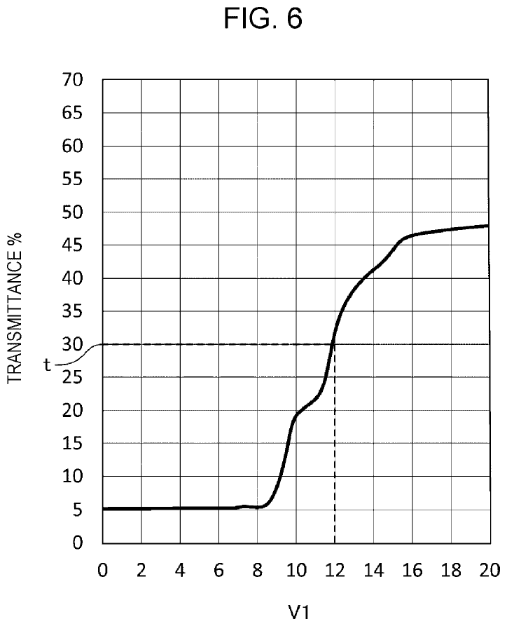

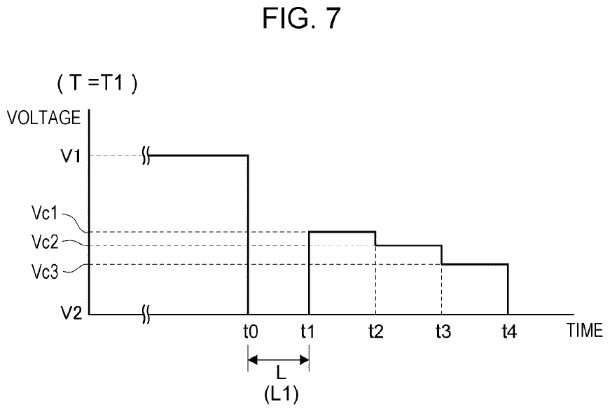

The memory unit 25 stores a liquid crystal light control program 30P described later (see FIG. 5), an application pattern 30T of an intermediate voltage (see FIG. 7) suitable for the temperature of the liquid crystal composition 50, and a graph 30K showing the relation between a first voltage and transmittance (see FIG. 6).

Functions of the CPU 20A that executes the liquid crystal light control program 30P include a judgment function 30P1 and an application function 30P2. The CPU 20A executes the liquid crystal light control program 30P and thereby functions as a judgment unit 20AP1 and an application unit 20AP2.

In the present embodiment, the liquid crystal panel 30 includes the pair of electrodes 32 and 34 for the liquid crystal composition 50 and is a smart window (liquid crystal shutter).

The liquid crystal panel 30 may be a liquid crystal display unit for displaying an image that includes a matrix electrode including a plurality of scan electrodes and a plurality of signal electrodes sandwiching the liquid crystal composition 50 and intersecting each other to form pixels and that further includes a scan driving circuit and a signal driving circuit that control the matrix electrode.

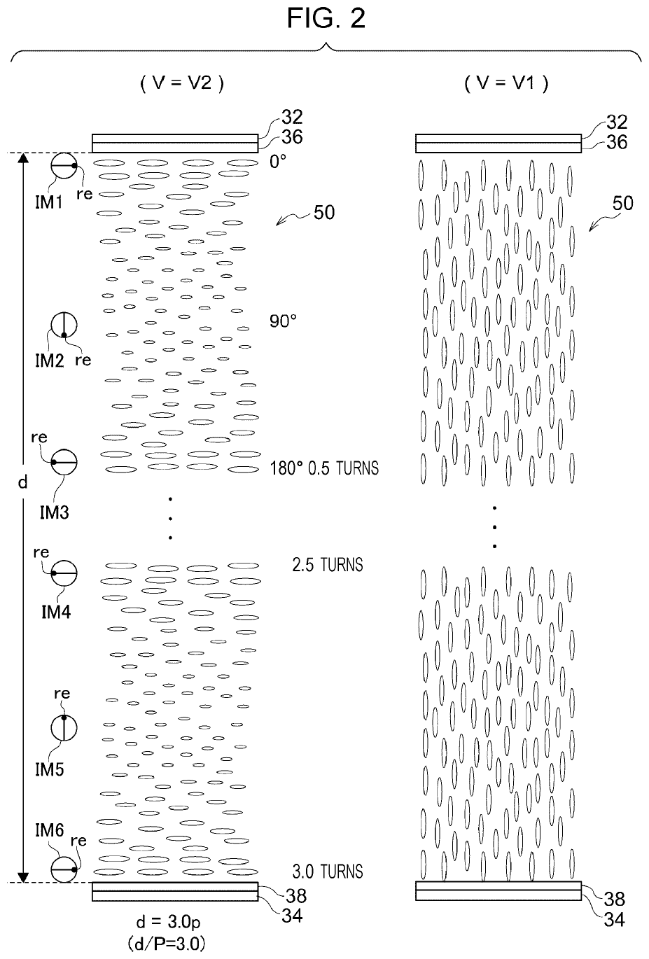

FIG. 2 shows conceptual illustrations of alignment states of liquid crystal molecules of the liquid crystal composition 50 in the liquid crystal light control apparatus 10 in the present embodiment. As described above, the liquid crystal composition 50 satisfies d/p≥2. Here, d (μm) is the distance between the pair of electrodes 32 and 34 (which may be referred to also as a “cell thickness”), and p (μm) is a chiral pitch. For example, d/p=3, and the chiral pitch p=3.8 (μm). The details of the liquid crystal composition 50 and a chiral agent will be described later.

The thickness of the liquid crystal composition 50 is several micrometers to 10 micrometers, while the thickness of the alignment films is 0.05 to 0.1 (μm). Therefore, the thickness of the alignment films is negligible with respect to the thickness of the liquid crystal composition 50. Thus, the distance between the pair of electrodes 32 and 34 is substantially the same as the thickness of the liquid crystal composition 50, and the thickness of the liquid crystal composition 50 is substantially the same as the distance between the pair of electrodes 32 and 34. Therefore, the distance between the pair of electrodes 32 and 34 is referred to also as the “cell thickness.” The thickness of the liquid crystal composition 50 may be interpreted as the distance between the pair of electrodes 32 and 34.

The distance between the pair of electrodes 32 and 34 is set to a prescribed gap using plastic particles.

By applying a voltage between the pair of electrodes 32 and 34, the light transmission state of the liquid crystal composition 50, i.e., its light transmission level, changes.

As shown in FIG. 2, the liquid crystal composition 50 is a liquid crystal with positive dielectric anisotropy. When a second voltage V2 is applied between the pair of electrodes 32 and 34 (the left illustration), the liquid crystal molecules of the liquid crystal composition 50 are aligned in a planar alignment state. When, for example, d/p=3 as described above, the liquid crystal molecules are twisted three times between the pair of electrodes 32 and 34. For example, as for liquid crystal molecules located closest to the upper electrode 32, one major axis end re of each liquid crystal molecule is located on the right side as shown in an image IM1 showing one liquid crystal molecule as viewed from above. When liquid crystal molecules are twisted 90°, the end re is located on the front side as shown in an image IM2. When liquid crystal molecules are twisted 180°, the end re is located on the left side as shown in an image IM3. Then, when liquid crystal molecules are twisted 2.5 times, the end re is located on the left side as shown in an image IM4. When liquid crystal molecules are further twisted 90° from the above state, the end re is located on the back side as shown in an image IM5. When liquid crystal molecules are twisted 3.0 times, the end re is located on the right side as shown in an image IM6.

When a first voltage V1 (>V2) is applied between the pair of electrodes 32 and 34 (the right illustration), the major axis direction of the liquid crystal molecules of the liquid crystal composition 50 is aligned in a direction along the electric field between the pair of electrodes 32 and 34, i.e., the liquid crystal molecules are aligned in a homeotropic alignment state.

In the techniques of the present disclosure, the liquid crystal composition is not limited to a liquid crystal composition whose liquid crystal molecules are aligned in the homeotropic alignment state when the first voltage V1 (>V2) is applied and aligned in the planar alignment state when the second voltage V2 (<V1) is applied. For example, the liquid crystal composition may be a liquid crystal composition in which the voltage for aligning the liquid crystal molecules in the homeotropic alignment state is smaller than the voltage for aligning the liquid crystal molecules in the planar alignment state (V1<V2).

The liquid crystal composition 50 contains a dichroic dye. In the example shown in FIG. 2, when the first voltage V1 (>V2) is applied between the pair of electrodes 32 and 34 and the liquid crystal composition 50 is brought to the homeotropic alignment state (the right illustration), almost no light is absorbed, and the liquid crystal composition 50 is almost colorless. When the second voltage V2 is applied between the pair of electrodes 32 and 34 and the liquid crystal composition 50 is brought to the planar alignment state (the left illustration), the liquid crystal composition 50 absorbs light with a specific wavelength and assumes a color. The liquid crystal composition 50 contains at least one dichroic dye.

When the liquid crystal panel 30 is a liquid crystal display unit for displaying an image that includes the matrix electrode, the scan driving circuit, and the signal driving circuit as described above, the liquid crystal composition 50 may contain no dichroic dye.

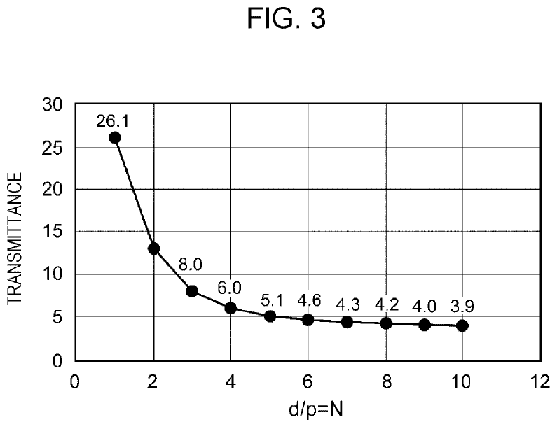

FIG. 3 shows the relation between d/p and the dark state transmittance (%) in the planar alignment state when the cell thickness of the liquid crystal composition 50 in the dark state is 10 (μm) and a prescribed amount of a dichroic dye is added. The dark state transmittance is a light transmittance when, for example, 0 (V) is applied between the pair of electrodes 32 and 34 to bring the liquid crystal composition 50 to a relatively dark state (dark state). The bright state transmittance is a light transmittance when, for example, 30 (V) is applied between the pair of electrodes 32 and 34 to bring the liquid crystal composition 50 to a relatively bright state (bright state). As shown in FIG. 3, when d/p is less than 2, the dark state transmittance is high, and the light blocking ability is insufficient. When d/p is 2 or more and less than 10, the dark state transmittance is low, and the light blocking ability can be increased. As d/p approaches 10, the dark state transmittance becomes saturated. It is therefore preferable that 2≤d/p<10. As the value of d/p increases, it is necessary to increase the voltage for driving the liquid crystal molecules (bringing them to the homeotropic alignment state or the bright state). Therefore, in order to achieve both a lower dark state transmittance and an appropriate driving voltage, it is preferable that 2≤d/p<6.

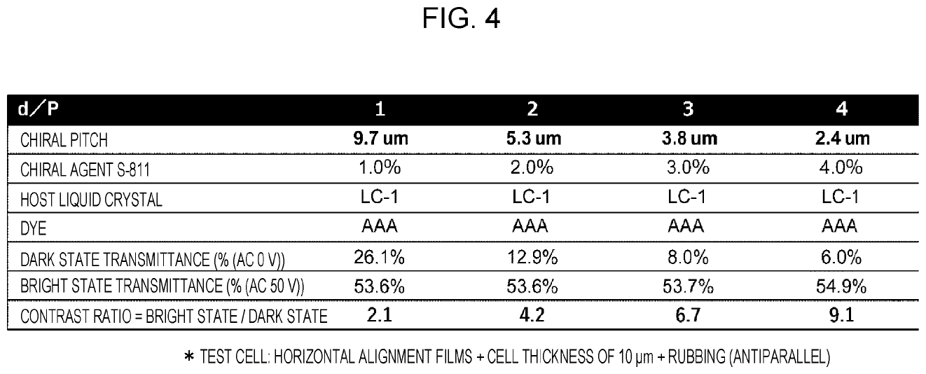

FIG. 4 shows that as d/p increases, the value of a contrast ratio increases. The contrast ratio is the ratio of the bright state transmittance/the dark state transmittance. The test shown in FIG. 4 was performed as follows. Specifically, d/p is 1, 2, 3, or 4. For each case, the host liquid crystal is LC-1, and the dye (AAA) contains G-472 at a dye concentration of 2.0(%), SI-426 at a dye concentration of 1.0(%), and SI-486 at a dye concentration of 1.0(%). In the test cell (the liquid crystal panel 30), the alignment films 36 and 38 are horizontal alignment films, and the cell thickness is 10 (μm). Rubbing is antiparallel. The bright state transmittance is the light transmittance when 50 (V) is applied between the pair of electrodes 32 and 34, and the dark state transmittance is the light transmittance when the voltage applied between the pair of electrodes 32 and 34 is 0 (V).

In the test performed, the test cell (the liquid crystal panel 30) was placed on a white light source and voltage-driven. The amount of light passing through the test cell (the liquid crystal panel 30) was measured using a luminance meter, and the transmittance in the bright state and the transmittance in the dark state (i.e., the ratio showing the percentage of light passing through the liquid crystal panel 30 with respect to the amount of light from the white light source) were measured. The test results are as follows.

When d/p was 1 (chiral pitch p: 9.7 (μm), chiral agent (S-811): 1.0(%)), the bright state transmittance was 53.6(%); the dark state transmittance was 26.1(%); and the contrast ratio was 2.1.

When d/p was 2 (chiral pitch p: 5.3 (μm), chiral agent (S-811): 2.0(%)), the bright state transmittance was 53.6(%); the dark state transmittance was 12.9(%); and the contrast ratio was 4.2.

When d/p was 3 (chiral pitch p: 3.8 (μm), chiral agent (S-811): 3.0(%)), the bright state transmittance was 53.7(%); the dark state transmittance was 8.0(%); and the contrast ratio was 6.7.

When d/p was 4 (chiral pitch p: 2.4 (μm), chiral agent (S-811): 4.0(%)), the bright state transmittance was 54.9(%); the dark state transmittance was 6.0(%); and the contrast ratio was 9.1.

As can be seen from the above, as d/p increases, the value of the contrast ratio increases. As described above, when d/p was 1, the contrast ratio was 2.1. It can therefore be understood that the degree of change between the bright state transmittance and the dark state transmittance was very small. d/p is preferably 2 or more because the value of the contrast ratio is large.

Next, the operation of the present embodiment will be described. FIG. 5 shows a flowchart of the liquid crystal light control program executed by the CPU 20A of the liquid crystal light control apparatus 10. When the CPU 20A executes the liquid crystal light control program, the following liquid crystal light control processing and liquid crystal light control method are performed.

Although the details will be described later, the computer 20 controls the power source 28 according to the liquid crystal light control program 30P such that, after the first voltage V1 is applied between the pair of electrodes 32 and 34 but before the second voltage V2 smaller in magnitude than the first voltage V1 is applied, the intermediate voltage for bringing the liquid crystal molecules of the liquid crystal composition 50 to a focal conic alignment state is applied.

The application time of the intermediate voltage is preferably 3 minutes or shorter, 2 minutes or shorter, 1 minute or shorter and more preferably 30 seconds or shorter.

A detailed description will be given below.

In step 62, the application unit 20AP2 controls the power source 28 such that a first voltage (effective value) that gives a designated transmittance is applied between the pair of electrodes 32 and 34. In this manner, the liquid crystal composition 50 is brought to a homeotropic alignment state. Therefore, light is less likely to be absorbed by the dye, and the liquid crystal panel 30 becomes more colorless and is in a bright state.

As described above, in the present embodiment, the transmittance of the liquid crystal panel 30 is set to the designated transmittance. FIG. 6 shows the relation between the first voltage and the transmittance. The relation between the first voltage and the transmittance is stored in the memory unit 25 as a graph, a date table, or a formula. The liquid crystal panel 30 is the liquid crystal panel used for the test with d/p=3 in FIG. 4. The user designates the transmittance of the liquid crystal panel 30 using the input unit 24. On the basis of the relation between the first voltage and the transmittance shown in FIG. 6, the first voltage for changing the transmittance of the liquid crystal panel 30 to the designated transmittance is read, and the power source 28 is controlled such that the read first voltage is applied between the pair of electrodes 32 and 34.

The relation between the first voltage and the transmittance shown in FIG. 6 is the relation when the temperature of the liquid crystal composition 50 is a certain value. The relation between the first voltage and the transmittance is determined depending on the temperature of the liquid crystal composition 50. Therefore, the relations between the first voltage and the transmittance that are determined for different temperatures of the liquid crystal composition 50 are pre-stored in the memory unit 25. In step 62, the temperature of the liquid crystal composition 50 is detected, and the first voltage that gives the designated transmittance is read from the relation corresponding to the detected temperature, and the power source 28 is controlled such that the read first voltage is applied between the pair of electrodes 32 and 34. In step 62, only the relation when the temperature of the liquid crystal composition 50 is, for example, 25° C. may be pre-stored in the memory unit 25, and this relation stored in the memory unit 25 may be used irrespective of the temperature of the liquid crystal composition 50.

Suppose that the user designates that the transmittance is t=30.0%. Then 12 (V) is read from the relation shown in FIG. 6 as the first voltage V1. In step 62, the application unit 20AP2 controls the power source 28 such that 12 (V) that changes the transmittance of the liquid crystal composition 50 to the designated transmittance t=30.0% is applied between the pair of electrodes 32 and 34.

The techniques of the present disclosure are not limited to the control of the power source 28 such that the first voltage that gives the designated transmittance is applied between the pair of electrodes 32 and 34, and the haze may be used instead of the transmittance.

In step 64, the judgment unit 20AP1 makes a determination as to whether the voltage is changed to the second voltage, and the determination is repeated until a decision is made to switch to the second voltage. For example, if the user decides to close the liquid crystal panel 30 (bring it to the dark state), the user uses the input unit 24 to input an instruction to close the shutter (switch to the dark state). In this manner, an affirmative determination is made in step 64.

When the affirmative determination is made in step 64, step 66 is performed, and the application unit 20AP2 detects the temperature of the liquid crystal composition 50 from the output of the temperature sensor 22. In the present embodiment, the temperature sensor 22 detects the temperature of the liquid crystal composition 50 indirectly. Specifically, the temperature sensor 22 detects the temperature around the liquid crystal panel 30 (its ambient temperature), and the application unit 20AP2 estimates the temperature of the liquid crystal composition 50 from the output of the temperature sensor 22 using a predetermined relational expression for estimating the temperature of the liquid crystal composition 50 from the ambient temperature. The ambient temperature of the liquid crystal panel 30 may be used as an estimated temperature of the liquid crystal composition 50.

In step 68, the application unit 20AP2 reads an application pattern suitable for the temperature. FIG. 7 shows a predetermined first application pattern for the intermediate voltage when the temperature of the liquid crystal composition 50 is T1. The intermediate voltage applied according to the first application pattern includes voltages for aligning the liquid crystal molecules of the liquid crystal composition 50 in a focal conic alignment state, e.g., voltages (Vc1 to Vc3) between the first voltage V1 and the second voltage V2.

The focal conic alignment state is an alignment state different from the homeotropic alignment state and the planar alignment state.

As shown in FIG. 7, the application of the first voltage V1 is terminated at time t0, and the intermediate voltage applied according to the first application pattern includes a first intermediate voltage and second intermediate voltages Vc1 to Vc3 larger in magnitude than the first intermediate voltage. The first intermediate voltage is applied between time t0 and time t1, and the three second intermediate voltages Vc1 to Vc3 are applied between time t1 and time t4. The magnitude of the first intermediate voltage is the same as the magnitude of the second voltage V2. The second intermediate voltages Vc1 to Vc3 gradually decrease in a stepwise manner with time. The intermediate voltage includes the three second intermediate voltages Vc1 to Vc3 that differ in magnitude from each other, and the second intermediate voltages Vc1 to Vc3 are applied in descending order of magnitude.

When the three second intermediate voltages Vc1 to Vc3 that differ in magnitude are applied between the pair of electrodes 32 and 34, the liquid crystal molecules of the liquid crystal composition 50 are aligned in respective different focal conic alignment states. The application of the first intermediate voltage between time t0 and time t1 causes the liquid crystal molecules of the liquid crystal composition 50 to align in the planar alignment state.

The number of alignment defects formed when the second voltage V2 is applied after the application of the first voltage V1, the first intermediate voltage, and the second intermediate voltages Vc1 to Vc3 larger in magnitude than the first intermediate voltage is smaller than the number of alignment defects formed when the second voltage V2 is applied after the application of the first voltage V1 with no intermediate voltages applied.

The application pattern described above includes the three second intermediate voltages Vc1 to Vc3, but this is not a limitation. One second intermediate voltage may be used (see an eighth application pattern described later), or two intermediate voltages may be used (see a sixth application pattern described later).

As described above, the first application pattern is a predetermined application pattern for the intermediate voltage when the temperature of the liquid crystal composition 50 is T1, and the application state of the voltage varies depending on the temperature. The application state of the voltage is specified according to at least one of the magnitude of the voltage and the application time of the voltage.

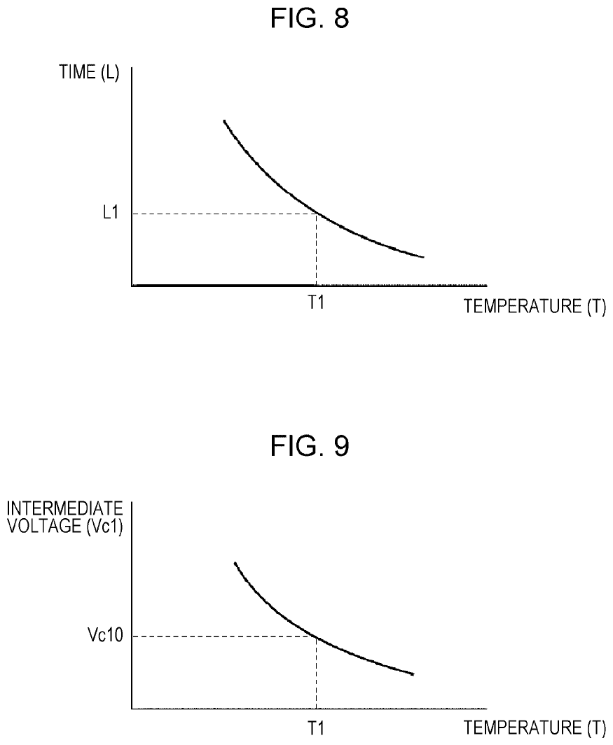

FIG. 8 shows the relation between the temperature of the liquid crystal composition 50 and the application time of the first intermediate voltage (time period L between time t0 and time t1) in the first application pattern. As the temperature of the liquid crystal composition 50 increases, the application time L of the first intermediate voltage decreases. When the temperature T of the liquid crystal composition 50 is T1, the application time L of the first intermediate voltage is L1.

The value of the first intermediate voltage is predetermined according to the temperature of the liquid crystal composition 50.

FIG. 9 is a graph showing the relation between the temperature of the liquid crystal composition and the second intermediate voltage (1st second intermediate voltage) Vc1 in the first application pattern. As shown in FIG. 9, as the temperature of the liquid crystal composition 50 increases, the second intermediate voltage (1st second intermediate voltage) Vc1 decreases. When the temperature T of the liquid crystal composition 50 is T1, the second intermediate voltage Vc1 is Vc10.

The application time of the second intermediate voltage (1st second intermediate voltage) Vc1 is predetermined according to the temperature of the liquid crystal composition 50.

Moreover, the application state of the 2nd second intermediate voltage Vc2 and the application state of the 3rd second intermediate voltage Vc3 (each of which is specified according to the magnitude of the voltage and the application time of the voltage) are predetermined according to the temperature of the liquid crystal composition 50.

The application states of the second intermediate voltages (the 1st to 3rd second intermediate voltages) may be determined according to the temperature of the liquid crystal composition 50. However, the application states when the temperature of the liquid crystal composition 50 is a given value, for example, 25° C., may be used even when the temperature of the liquid crystal composition 50 changes. For example, only the magnitudes of the voltages may be used.

In the present embodiment, a plurality of first application patterns for different temperatures of the liquid crystal composition 50 are pre-stored in the memory unit 25. In step 68, a first application pattern suitable for the temperature of the liquid crystal composition 50 is read from the memory unit 25.

The techniques of the present disclosure are not limited to the embodiment in which the plurality of first application patterns for different temperatures of the liquid crystal composition 50 are prestored in the memory unit 25. For example, a basic first application pattern and the relations between the temperature of the liquid crystal composition 50 and the application states of the first intermediate voltage and the three second intermediate voltages Vc1 to Vc3 may be prestored in the memory unit 25. In step 68, the application unit 20AP2 may specify the application states of the first intermediate voltage and the three second intermediate voltages Vc1 to Vc3 according to the temperature of the liquid crystal composition 50 using the above relations, and a first application pattern suitable for the temperature of the liquid crystal composition 50 may be specified.

The first application pattern is not limited to that determined according to the temperature of the liquid crystal composition 50. For example, the first application pattern may be determined according to the concentration of the chiral agent in the liquid crystal composition 50, the chiral pitch p (μm), or the type of chiral agent. Specifically, the first application pattern may be determined according to the physical property values of the liquid crystal composition such as the temperature of the liquid crystal composition 50, the concentration of the chiral agent in the liquid crystal composition 50, the chiral pitch p (μm), and the type of chiral agent. The first application pattern may be determined according to the cell thickness. As described above, the first application pattern may be determined according to at least one of the physical properties of the liquid crystal composition 50 and the cell thickness.

In step 70, the application unit 20AP2 applies the intermediate voltage according to a predetermined application pattern (for example, the first application pattern).

The intermediate voltage is applied according to the predetermined application pattern (for example, the first application pattern). Then, in step 72, the application unit 20AP2 applies the second voltage. The second voltage is, for example, V2 (V). Therefore, in this case, the application unit 20AP2 applies V2 (V) between the pair of electrodes 32 and 34. When the second voltage V2 is applied as described above, the liquid crystal molecules are aligned in a twisted state, i.e., a planar alignment state. In this case, the dye in the liquid crystal composition 50 absorbs light with a specific wavelength and develops a color, and the shutter is closed (in a dark state).

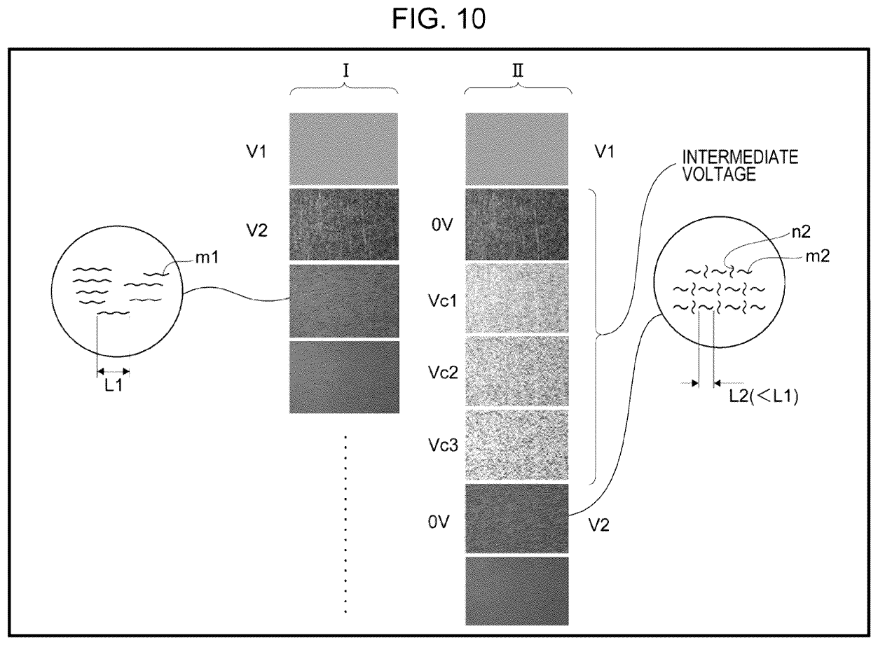

In the present embodiment described above, the time required for the liquid crystal molecules to align in the original orientation, i.e., the response time required for the liquid crystal molecules to return to a stable alignment state, can be shorter than that when no intermediate voltage is applied (a conventional technique). More specifically, when the voltage is changed from the first voltage V1 to the second voltage V2, as in the conventional technique shown in FIG. 10 (see I), the liquid crystal molecules try to align in the original orientation. However, when the liquid crystal molecules are brought to (I) while the voltage is maintained at the second voltage V2=0 (V), relatively long alignment defects (with a length of (L1)) are formed (the liquid crystal molecules are brought to a non-uniform alignment state including disclination lines and oily streaks), and this causes adverse effects such as a reduction in contrast ratio and an increase in haze. If the alignment defects are relatively long, the time required for the alignment defects to disappear is long. In this case, the adverse effects such as a reduction in contrast ratio are relatively long-lasting, and the quality of the performance of the liquid crystal panel 30 deteriorates. Specifically, the brightness of the display surface of the liquid crystal panel 30 is nonuniform. For example, brightness unevenness occurs on the display surface of the liquid crystal panel, and flickering (such as glare) occurs.

However, in the present embodiment (see II), the intermediate voltages (0, Vc1, Vc2, and Vc3) for bringing the liquid crystal molecules to the focal conic alignment state are applied after the application of the first voltage V1 but before the application of the second voltage V2. In this case, the alignment state (focal conic alignment state) different from the alignment state of the liquid crystal molecules under the application of the first voltage V1 is formed, so that the disclination lines formed have a relatively short length (L2<L1).

As described above, the intermediate voltage is gradually decreased from Vc1 to Vc2 (<Vc1) to Vc3 (<Vc2) to form different alignment states, and then the intermediate voltage is switched to V2. In this case, although alignment defects (such as disclination lines and oily streaks) are formed, the survival time of the alignment defects is shorter.

Disclination lines m2 and n2 formed in the present embodiment (II) are shorter than disclination lines m1 formed in the conventional technique (see I). Among the disclination lines m2 and n2 formed in the present embodiment (II), the disclination lines n2 are characterized by their direction that intersects the direction of the disclination lines m1, and the alignment defects can be eliminated rapidly.

As described above, in the present embodiment, the intermediate voltage is applied to bring the liquid crystal molecules of the liquid crystal composition in the homeotropic alignment state to the focal conic alignment state. In this manner, alignment defects, e.g., disclination lines, are shortened, and the survival time of the alignment defects such as the disclination lines can be shortened.

Moreover, the intermediate voltage is applied according to the application pattern suitable for the temperature of the liquid crystal composition 50. Therefore, even when the temperature of the liquid crystal composition 50 changes, the time required for the liquid crystal molecules to align in the original orientation can be shorter than that in the conventional technique.

In the embodiment described above, the application unit 20AP2 applies the intermediate voltage according to the predetermined first application pattern. In the techniques of the present disclosure, the application pattern for the intermediate voltage is not limited to the first application pattern, and other application patterns may be used. For each of the other application patterns, a plurality of application patterns for different temperatures of the liquid crystal composition 50 may be stored in the memory unit 25, or a basic application pattern and the relation between the temperature of the liquid crystal composition 50 and the application states of the intermediate voltages in the application pattern may be stored in the memory unit 25. In this case, as in the first application pattern, an application pattern suitable for the temperature of the liquid crystal composition 50 is specified.

### (Second Application Pattern)

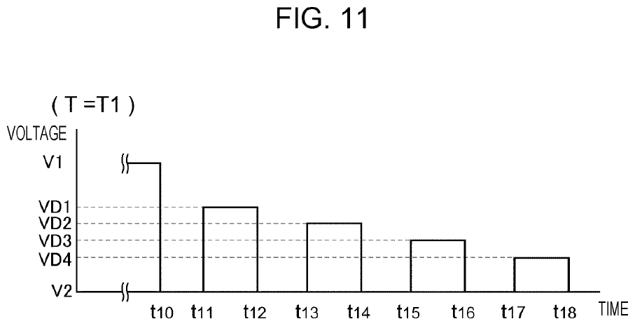

FIG. 11 shows a second application pattern for the intermediate voltage. As shown in FIG. 11, the intermediate voltage in the second application pattern includes a first intermediate voltage (V2) and four second intermediate voltages (VD1 to VD4) larger in magnitude than the first intermediate voltage (V2). The first intermediate voltage (V2) and the four second intermediate voltages (VD1, VD2, VD3, and VD4) are applied in an alternating manner. The four second intermediate voltages (VD1, VD2, VD3, and VD4) gradually decrease in a stepwise manner with time. The four second intermediate voltages (VD1, VD2, VD3, and VD4) are applied in the descending order of magnitude.

Specifically, the second application pattern from time t10 at which the application of the first voltage V1 is terminated is defined as follows.

[Period] [Voltage applied]
Period between time t10 to t11 First intermediate voltage (V2)
Period between time t11 to t12 1st second intermediate voltage VD1
Period between time t12 to t13 First intermediate voltage (V2)
Period between time t13 to t14 2nd second intermediate voltage VD2
Period between time t14 to t15 First intermediate voltage (V2)
Period between time t15 to t16 3rd second intermediate voltage VD3
Period between t16 to t17 First intermediate voltage (V2)
Period between t17 to t18 4th second intermediate voltage VD4

The second application pattern includes the four second intermediate voltages (VD1 to VD4). However, the techniques of the present disclosure are not limited thereto, and the number of intermediate voltages may be, for example, 3 or 5.

### (Third Application Pattern)

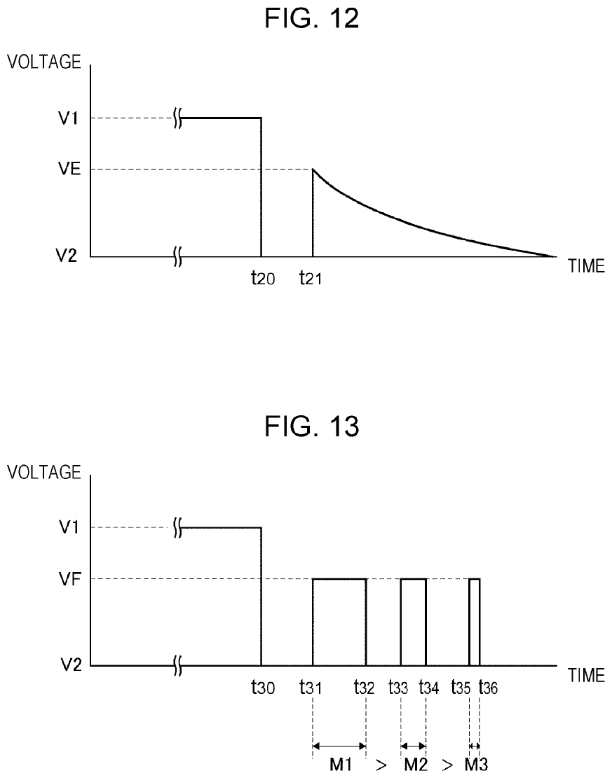

FIG. 12 shows a third application pattern for the intermediate voltage. As shown in FIG. 12, the intermediate voltage in the third application pattern includes a first intermediate voltage (V2) and a second intermediate voltage whose magnitude gradually decreases from a prescribed value (VE) continuously.

### (Fourth Application Pattern)

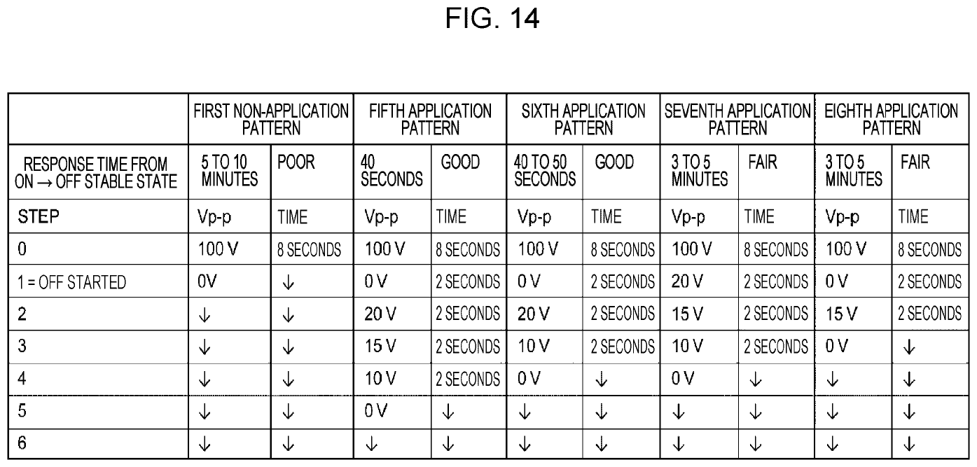

FIG. 13 shows a fourth application pattern for the intermediate voltage. As shown in FIG. 13, the intermediate voltage in the fourth application pattern includes a first intermediate voltage (V2) and a second intermediate voltage VF larger in magnitude than the first intermediate voltage (V2), and the first intermediate voltage (V2) and the second intermediate voltage VF are applied alternately. The constant magnitude second intermediate voltage VF is applied a plurality of times such that the application time gradually decreases.

Specifically, the fourth application pattern from time t30 at which the application of the first voltage V1 is terminated is defined as follows.

[Period] [Voltage applied]
Period from time t30 to t31 First intermediate voltage (V2)
Period from time t31 to t32 Second intermediate voltage VF
Period from time t32 to t33 First intermediate voltage (V2)
Period from time t33 to t34 Second intermediate voltage VF
Period from time t34 to t35 First intermediate voltage (V2)
Period from time t35 to t36 Second intermediate voltage VF

Here, the period from time t31 to t32=M1>the period from time t33 to t34=M2>the period from time t35 to t36=M3.

In the fourth application pattern, the constant magnitude second intermediate voltage VF is applied three times. However, the techniques of the present disclosure are not limited thereto. The second intermediate voltage VF may be applied, for example, twice or four times, and the second intermediate voltage applied in the period from time t33 to t34 and the period from time t35 to t36 may be larger by a prescribed value than VF.

### (Fifth to Eighth Application Patterns)

FIG. 14 is a table showing a pattern in which no intermediate voltage is applied (a first non-application pattern) and fifth to eighth application patterns for the intermediate voltage. In FIG. 14, the voltage V is a p−p voltage. For example, Vp−p=100 V means that a square wave AC voltage of 50 (V) is applied. In the following patterns, the frequency of the square-wave voltage is 60 Hz.

In the first non-application pattern, the first voltage V1 is 100 (V) and is applied for 8 (seconds), and the second voltage is 0 (V). In this case, the response time for the liquid crystal molecules to return to the stable alignment state, i.e., the response time for alignment defects to disappear under a microscope, was 5 minutes to 10 minutes.

In the fifth application pattern, the first voltage V1 is 100 (V) and is applied for 8 (seconds). Then the intermediate voltage is applied (at 0 (V) for 2 (seconds), at 20 (V) for 2 (seconds), at 15 (V) for 2 (seconds), and at 10 (V) for 2 (seconds)), and then the second voltage is set to 0 (V). The response time was 40 (seconds).

In the sixth application pattern, the first voltage V1 is 100 (V) and is applied for 8 (seconds). Then the intermediate voltage is applied (at 0 (V) for 2 (seconds), at 20 (V) for 2 (seconds), and at 10 (V) for 2 (seconds)), and then the second voltage is set to 0 (V). The response time was 40 to 50 (seconds).

In the seventh application pattern, the first voltage V1 is 100 (V) and is applied for 8 (seconds). Then the intermediate voltage is applied (at 20 (V) for 2 (seconds), at 15 (V) for 2 (seconds), and at 10 (V) for 2 (seconds)), and then the second voltage is set to 0 (V). The response time was 3 to 5 (minutes). In the seventh application pattern, the voltage is not brought to 0 V immediately after the termination of the application of the first voltage V1 (100 [V]).

In the eighth application pattern, the first voltage V1 is 100 (V) and is applied for 8 (seconds). Then the intermediate voltage is applied (at 0 (V) for 2 (seconds) and at 15 (V) for 2 (seconds), and then the second voltage is set to 0 (V). The response time was 3 to 5 (minutes). In the eighth application pattern, the intermediate voltage includes a first intermediate voltage (0 (V)) applied once and a second intermediate voltage (15 (V)) applied once.

### (Ninth Application Pattern)

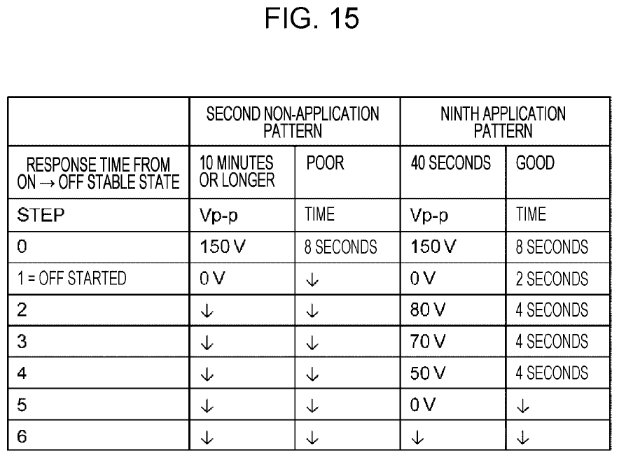

FIG. 15 is a table showing a pattern in which no intermediate voltage is applied (a second non-application pattern) and a ninth application pattern for the intermediate voltage.

In the second non-application pattern, the first voltage V1 is 150 (V) and is applied for 8 (seconds), and then the voltage application is terminated. In this case, the response time was 10 minutes or longer.

In the ninth application pattern, the first voltage V1 is 150 (V) and is applied for 8 (seconds). Then the intermediate voltage is applied (at 0 (V) for 2 (seconds), at 80 (V) for 4 (seconds), at 70 (V) for 4 (seconds), and at 50 (V) for 4 (seconds)), and then the second voltage is set to 0 (V). The response time was 40 (seconds).

The liquid crystal light control apparatus 10 is used for buildings, vehicle-mounted applications, and interior applications. For example, the liquid crystal light control apparatus 10 may be installed on the inner side of a window of a structure such as a house or a building or a vehicle in order to control the amount of sunlight transmitted through the window.

In the embodiments described above, the computer 20 automatically applies the intermediate voltage according to the predetermined application pattern. However, the techniques of the present disclosure are not limited thereto. The user may input a voltage value using the input unit 24 at a given timing according to an application pattern to thereby apply the intermediate voltage.

Next, the liquid crystal composition will be described.

### (Compound Represented by General Formula (i))

The dye compound-containing liquid crystal composition in the present invention contains one or two or more alkenyl compounds represented by the following general formula (i).

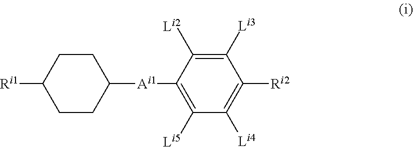

In general formula (i), Rⁱ¹ represents an alkenyl group having 2 to 20 carbon atoms.

The alkenyl group having 2 to 20 carbon atoms is a linear, branched, or cyclic alkenyl group and is preferably a linear alkenyl group.

The number of carbon atoms in the alkenyl group having 2 to 20 carbon atoms is preferably 2 to 10 and preferably 2 to 6.

One or two or more —CH₂— groups in the alkenyl group may each independently be replaced with —O— and/or —CO—.

One or two or more —CH₂—CH₂— groups in the alkenyl group may each independently be replaced with —CH═CH— and/or —C≡C—.

One or two or more hydrogen atoms in the alkenyl group may each independently be replaced with a halogen atom.

Examples of the halogen atom include a fluorine atom, a chlorine atom, and a bromine atom.

When the alkenyl group is substituted with a prescribed group, no oxygen atoms are bonded directly to each other.

For example, Rⁱ¹ may represent an alkenyloxy group having 2 to 19 carbon atoms when one —CH₂— group in the alkenyl group is replaced with —O—.

The alkenyloxy group is a linear, branched, or cyclic alkenyloxy group and is preferably a linear alkenyloxy group.

The number of carbon atoms in the alkenyloxy group is preferably 2 to 10 and preferably 2 to 6.

Specific examples of the alkenyl group represented by Rⁱ¹ and having 2 to 20 carbon atoms (including the substituted groups) include groups represented by formulas (Rⁱ¹-1) to (Rⁱ¹-10).

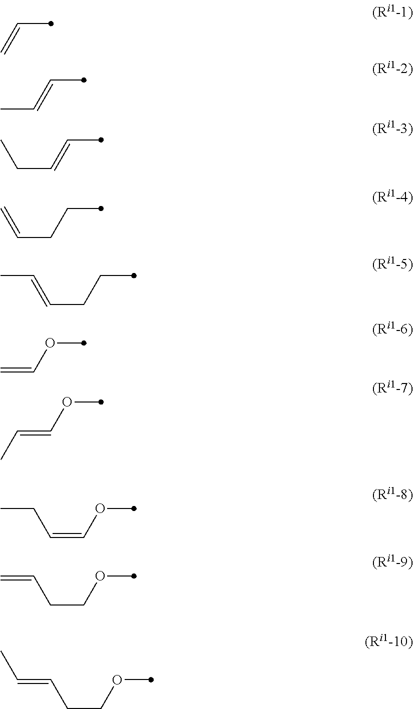

In formulas (Rⁱ¹-1) to (Rⁱ¹-10), each solid circle represents a bond to a cyclic structure.

From the viewpoint of improving the solubility of the dye compound, Rⁱ¹ is preferably a linear alkenyl group having 2 to 6 carbon atoms.

In general formula (i), Rⁱ² represents an alkyl group having 1 to 20 carbon atoms.

The alkyl group having 1 to 20 carbon atoms is a linear, branched, or cyclic alkyl group and is preferably a linear alkyl group.

The number of carbon atoms in the alkyl group having 1 to 20 carbon atoms is preferably 2 to 10 and preferably 2 to 6.

One or two or more —CH₂— groups in the alkyl group may each independently be replaced with —O— and/or —CO—.

One or two or more —CH₂—CH₂— groups in the alkyl group may each independently be replaced with —CH═CH— and/or —C≡C—.

One or two or more hydrogen atoms in the alkyl group may each independently be replaced with a halogen atom.

Examples of the halogen atom include a fluorine atom, a chlorine atom, and a bromine atom.

When the alkyl group is substituted with a prescribed group, no oxygen atoms are bonded directly to each other.

For example, Rⁱ² may represent an alkoxy group having 1 to 19 carbon atoms when one —CH₂— group in the alkyl group is replaced with —O—.

The alkoxy group is a linear, branched, or cyclic alkoxy group and is preferably a linear alkoxy group.

The number of carbon atoms in the alkoxy group is preferably 2 to 10 and preferably 2 to 6.

Rⁱ² may represent an alkenyl group having 1 to 20 carbon atoms when one or two or more —CH₂—CH₂— groups in the alkyl group are replaced with —CH═CH—.

The alkenyl group is a linear, branched, or cyclic alkenyl group and is preferably a linear alkenyl group.

The number of carbon atoms in the alkenyl group is preferably 2 to 10 and preferably 2 to 6.

Rⁱ² may represent an alkynyl group having 1 to 20 carbon atoms when one or two or more —CH₂—CH₂— groups in the alkyl group are replaced with —C≡C—.

The alkynyl group is a linear, branched, or cyclic alkynyl group and is preferably a linear alkynyl group.

The number of carbon atoms in the alkynyl group is preferably 2 to 10 and preferably 2 to 6.

Rⁱ² may represent an alkenyloxy group having 1 to 19 carbon atoms when one —CH₂— group in the alkyl group is replaced with —O— and one or two or more —CH—CH₂— groups are replaced with —CH═CH—.

The alkenyloxy group is a linear, branched, or cyclic alkenyloxy group and is preferably a linear alkenyloxy group.

The number of carbon atoms in the alkenyloxy group is preferably 2 to 10 and preferably 2 to 6.

Rⁱ² may represent a halogenated alkyl group having 1 to 20 carbon atoms when one or two or more hydrogen atoms in the alkyl group are replaced with halogen atoms.

The halogenated alkyl group is a linear, branched, or cyclic halogenated alkyl group and is preferably a linear halogenated alkyl group.

The number of carbon atoms in the halogenated alkyl group is preferably 2 to 10 and preferably 2 to 6.

Specific examples of the alkyl group represented by Rⁱ² and having 1 to 20 carbon atoms (including the substituted groups) include groups represented by formulas (Rⁱ²-1) to (Rⁱ²-31).

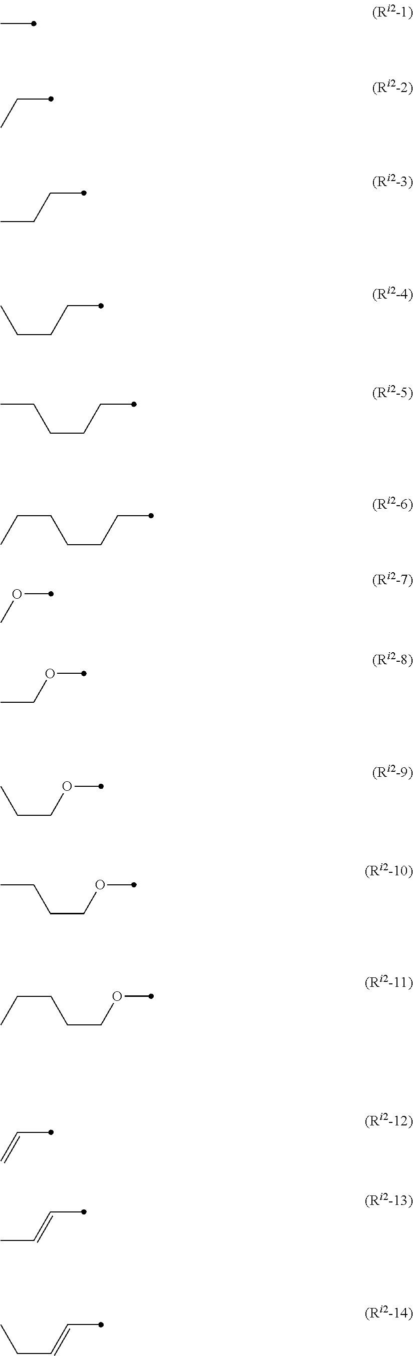

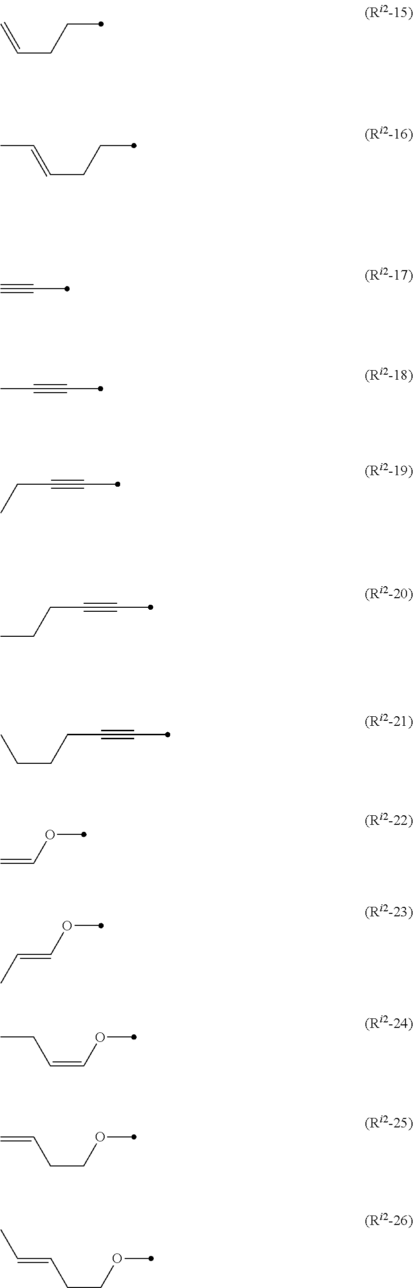

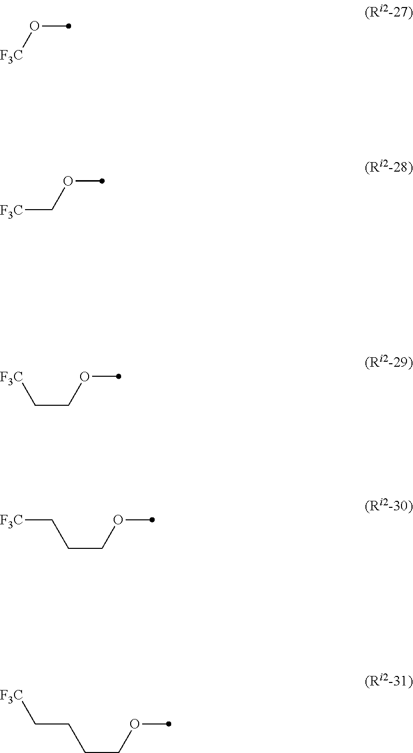

In formulas (Rⁱ¹-1) to (Rⁱ²-31), each solid circle represents a bond to a cyclic structure.

From the viewpoint of obtaining high solubility and reducing the viscosity of the dye compound-containing liquid crystal composition, Rⁱ² is preferably a linear alkyl group having 1 to 6 carbon atoms.

In general formula (i), Aⁱ¹ represents a group selected from the group consisting of the following group (a) and group (b):
(a) a 1,4-cyclohexylene group (one —CH₂— group or two or more non-adjacent —CH₂— groups present in this group may be replaced with —O— and/or —S—); and
(b) a 1,4-phenylene group (one —CH═ group or two or more non-adjacent —CH═ groups present in this group may be replaced with —N═).

One or two or more hydrogen atoms in Aⁱ¹ may each independently be replaced with a halogen atom.

Examples of the halogen atom include a fluorine atom, a chlorine atom, a bromine atom, and an iodine atom.

More specifically, Aⁱ¹ preferably represents one of the following formulas (Aⁱ¹-1) to (Aⁱ¹-2).

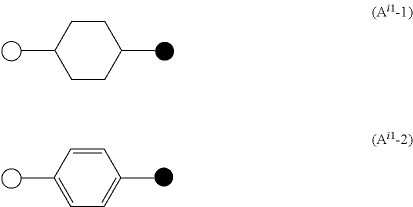

In formulas (Aⁱ¹-1) to (Aⁱ¹-2), each open circle represents a bond to the 1,4-cyclohexylene group, and each solid circle represents a bond to the 1,4-phenylene group.

In general formula (i), Lⁱ², Lⁱ³, Lⁱ⁴, and Lⁱ⁵ each independently represent a hydrogen atom or a halogen atom.

Examples of the halogen atom include a fluorine atom, a chlorine atom, a bromine atom, and a n iodine atom.

From the viewpoint of allowing the dye compound-containing liquid crystal composition to have high light fastness, it is preferable that Lⁱ², Lⁱ³, Lⁱ⁴, and Lⁱ⁵ are all hydrogen atoms.

The compound represented by general formula (i) is preferably a compound represented by any of the following general formulas (i-1) to (i-2).

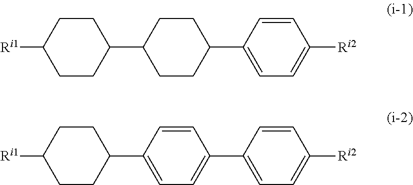

In general formulas (i-1) to (i-2), Rⁱ¹ and Rⁱ² have the same meanings as Rⁱ¹ and Rⁱ², respectively, in general formula (i) above, and their preferred examples are also the same as the groups exemplified for Rⁱ¹ and Rⁱ² in general formula (i).

Preferred examples of the compound represented by general formula (i-1) include compounds represented by the following structural formulas (i-1.1) to (i-1.8).

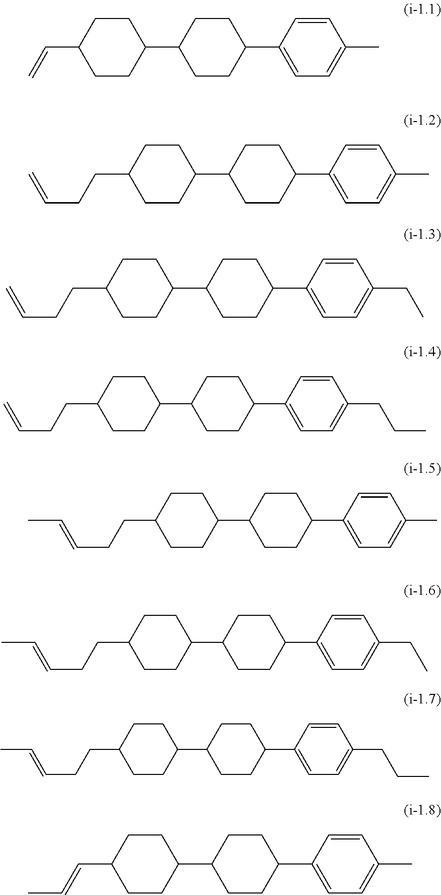

Preferred examples of the compound represented by general formula (i-2) include compounds represented by the following structural formulas (i-2.1) to (i-2.2).

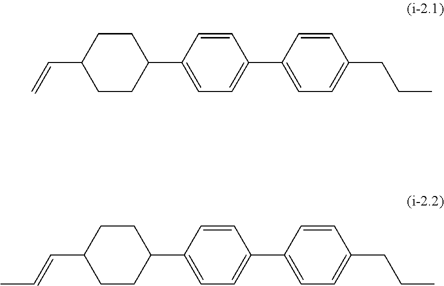

The number of compounds represented by general formula (i), general formulas (i-1) to (i-2), structural formulas (i-1.1) to (i-1.8), and structural formulas (i-2.1) to (i-2.2) that are used for the dye compound-containing liquid crystal composition is one or two or more and is preferably one to five, preferably one to four, preferably one to three, preferably one to two, and preferably one.

The lower limit of the total content of the compounds represented by general formula (i), general formulas (i-1) to (i-2), structural formulas (i-1.1) to (i-1.8), and structural formulas (i-2.1) to (i-2.2) based on 100% by mass of the dye compound-containing liquid crystal composition is preferably 1% by mass or more, preferably 5% by mass or more, and preferably 10% by mass or more.

The upper limit of the total content of the compounds represented by general formula (i), general formulas (i-1) to (i-2), structural formulas (i-1.1) to (i-1.8), and structural formulas (i-2.1) to (i-2.2) based on 100% by mass of the dye compound-containing liquid crystal composition is preferably 35% by mass or less, preferably 30% by mass or less, and preferably 25% by mass or less.

The total content of the compounds represented by general formula (i), general formulas (i-1) to (i-2), structural formulas (i-1.1) to (i-1.8), and structural formulas (i-2.1) to (i-2.2) based on 100% by mass of the dye compound-containing liquid crystal composition is preferably 1 to 35% by mass, preferably 5 to 30% by mass, and preferably 10 to 25% by mass.

The compounds represented by general formula (i), general formulas (i-1) to (i-2), structural formulas (i-1.1) to (i-1.8), and structural formulas (i-2.1) to (i-2.2) can each be synthesized using a well-known synthesis method.

(Compound Represented by General Formula (ii))

The dye compound-containing liquid crystal composition in the invention contains one or two or more compounds having a difluorine structure represented by the following general formula (ii).

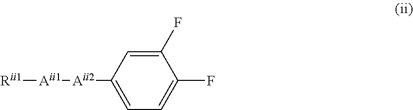

In general formula (ii), Rⁱⁱ¹ represents an alkyl group having 1 to 20 carbon atoms.

The alkyl group having 1 to 20 carbon atoms is a linear, branched, or cyclic alkyl group and is preferably a linear alkyl group.

The number of carbon atoms in the alkyl group having 1 to 20 carbon atoms is preferably 2 to 10 and preferably 2 to 6.

One or two or more —CH₂— groups in the alkyl group may each independently be replaced with —O— and/or —CO—.

One or two or more —CH₂—CH₂— groups in the alkyl group may each independently be replaced with —CH═CH— and/or —C≡C—.

One or two or more hydrogen atoms in the alkyl group may each independently be replaced with a halogen atom.

Examples of the halogen atom include a fluorine atom, a chlorine atom, and a bromine atom.

When the alkyl group is substituted with a prescribed group, no oxygen atoms are bonded directly to each other.

For example, Rⁱⁱ¹ may represent an alkoxy group having 1 to 19 carbon atoms when one —CH₂— group in the alkyl group is replaced with —O—.

The alkoxy group is a linear, branched, or cyclic alkoxy group and is preferably a linear alkoxy group.

The number of carbon atoms in the alkoxy group is preferably 2 to 10 and preferably 2 to 6.

Rⁱⁱ¹ may represent an alkenyl group having 1 to 20 carbon atoms when one or two or more —CH₂—CH₂— groups in the alkyl group are replaced with —CH═CH—.

The alkenyl group is a linear, branched, or cyclic alkenyl group and is preferably a linear alkenyl group.

The number of carbon atoms in the alkenyl group is preferably 2 to 10 and preferably 2 to 6.

Rⁱⁱ¹ may represent an alkynyl group having 1 to 20 carbon atoms when one or two or more —CH₂—CH₂— groups in the alkyl group are replaced with —C≡C—.

The alkynyl group is a linear, branched, or cyclic alkynyl group and is preferably a linear alkynyl group.

The number of carbon atoms in the alkynyl group is preferably 2 to 10 and preferably 2 to 6.

Rⁱⁱ¹ may represent an alkenyloxy group having 1 to 19 carbon atoms when one —CH₂— group in the alkyl group is replaced with —O— and one or two or more —CH₂—CH₂— groups are replaced with —CH═CH—.

The alkenyloxy group is a linear, branched, or cyclic alkenyloxy group and is preferably a linear alkenyloxy group.

The number of carbon atoms in the alkenyloxy group is preferably 2 to 10 and preferably 2 to 6.

Rⁱⁱ¹ may represent a halogenated alkyl group having 1 to 20 carbon atoms when one or two or more hydrogen atoms in the alkyl group are replaced with a halogen atom.

The halogenated alkyl group is a linear, branched, or cyclic halogenated alkyl group and is preferably a linear halogenated alkyl group.

The number of carbon atoms in the halogenated alkyl group is preferably 2 to 10 and preferably 2 to 6.

Specific examples of the alkyl group represented by Rⁱⁱ¹ and having 1 to 20 carbon atoms (including the substituted groups) include compounds represented by formulas (Rⁱⁱ¹-1) to (Rⁱⁱ¹-31).

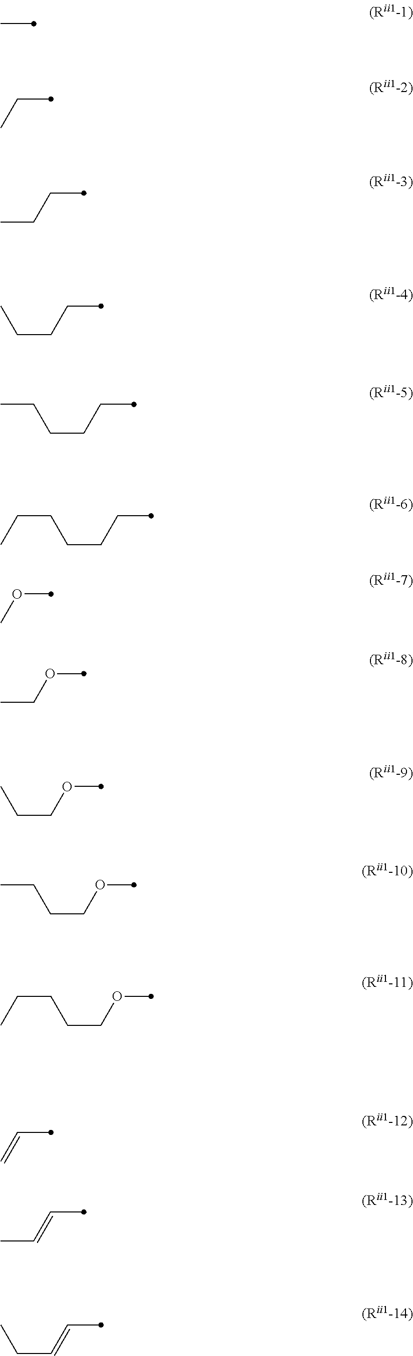

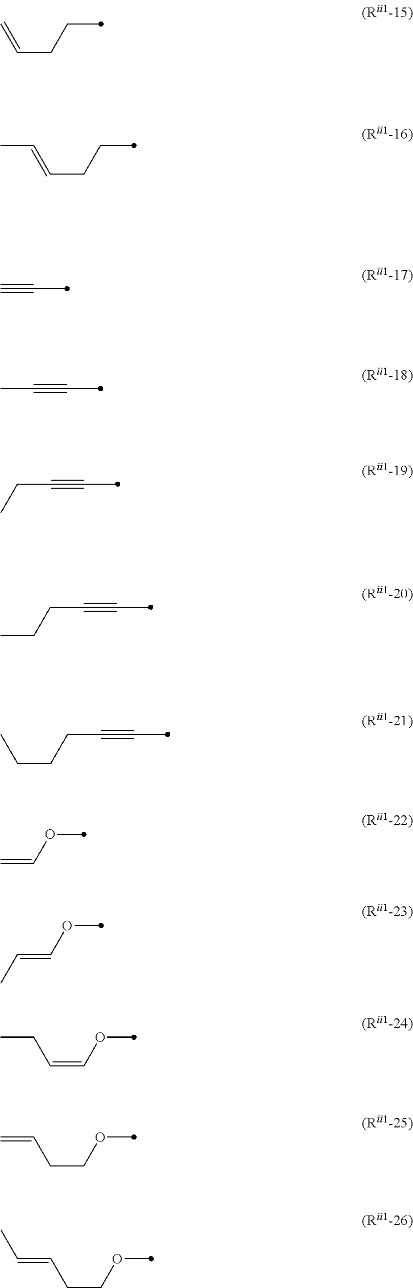

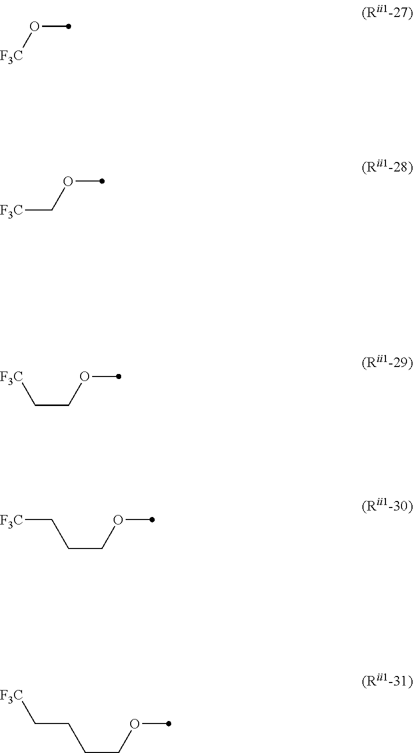

In formulas (Rⁱⁱ¹-1) to (Rⁱⁱ¹-31), each solid circle represents a bond to a cyclic structure.

From the viewpoint of obtaining high solubility and reducing the viscosity of the dye compound-containing liquid crystal composition, Rⁱⁱ¹ is preferably a linear alkyl group having 1 to 6 carbon atoms or a linear alkenyl group having 1 to 6 carbon atoms.

In general formula (ii), Aⁱⁱ¹ and Aⁱⁱ² each independently represent a group selected from the group consisting of the following groups (a) and (b):
(a) a 1,4-cyclohexylene group (one —CH₂— group or two or more non-adjacent —CH₂— groups present in this group may be replaced with —O— and/or —S—); and
(b) a 1,4-phenylene group (one —CH═ group or two or more non-adjacent —CH═ groups present in this group may be replaced with —N═).

One or two or more hydrogen atoms in Aⁱⁱ¹ and Aⁱⁱ² may each independently be replaced with a halogen atom.

Examples of the halogen atom include a fluorine atom, a chlorine atom, a bromine atom, and an iodine atom.

More specifically, Aⁱⁱ¹ and Aⁱⁱ² each preferably represent any of the following groups (A^{ii1/2}-1) to (A^{ii1/2}-2).

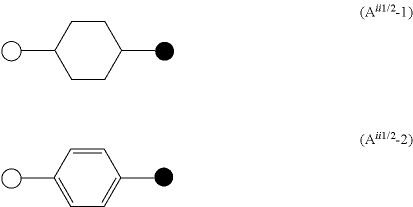

In formulas (A^{ii1/2}-1) to (A^{ii1/2}-2), each open circle represents a bond to Rⁱⁱ¹ or Aⁱⁱ¹, and each solid circle represents a bond to Aⁱⁱ² or the (3F)-1,4-phenylene group.

The compound represented by general formula (ii) is preferably a compound represented by any of the following general formulas (ii-1) to (ii-3).

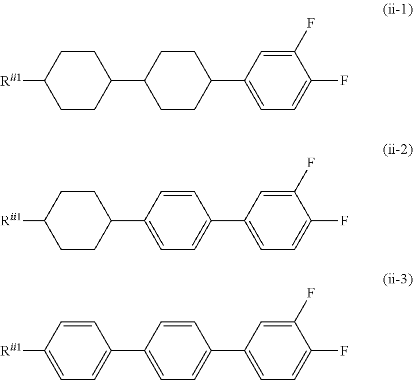

In general formulas (ii-1) to (ii-3), Rⁱⁱ¹ has the same meaning as Rⁱⁱ¹ in general formula (ii), and its preferred examples are also the same as the groups exemplified for Rⁱⁱ¹ in general formula (ii).

The compound represented by general formula (ii-1) is preferably a compound represented by any of the following structural formulas (ii-1.1) to (ii-1.4).

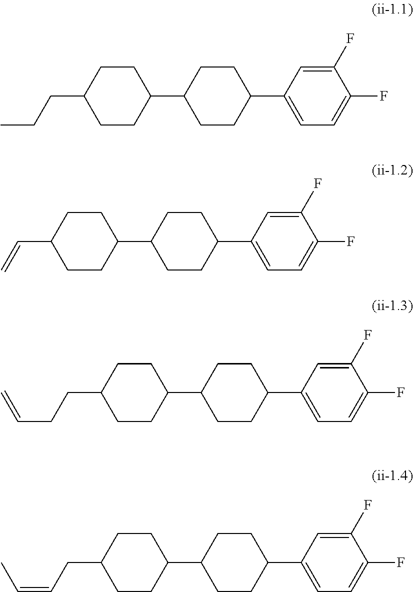

The compound represented by general formula (ii-2) is preferably a compound represented by any of the following structural formulas (ii-2.1) to (ii-2.4).

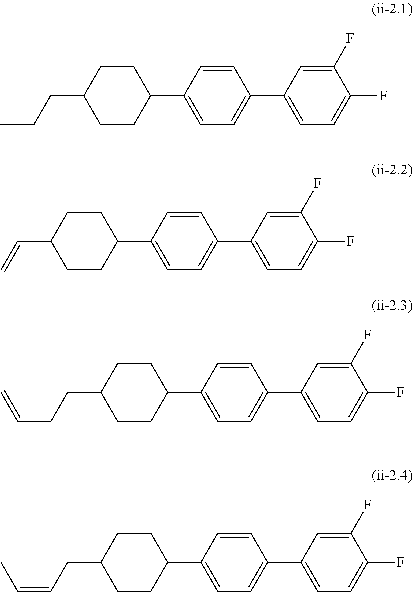

The compound represented by general formula (ii-3) is preferably a compound represented by any of the following structural formulas (ii-3.1) to (ii-3.4).

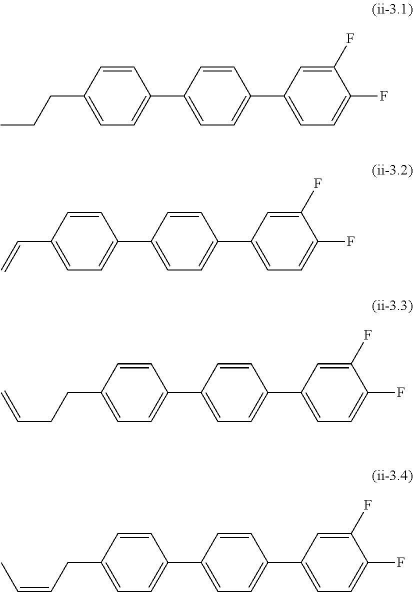

The number of compounds represented by general formula (ii), general formulas (ii-1) to (ii-3), structural formulas (ii-1.1) to (ii-1.4), structural formulas (ii-2.1) to (ii-2.4), and structural formulas (ii-3.1) to (ii-3.4) that are used for the dye compound-containing liquid crystal composition is one or two and is preferably one to five, preferably one to four, preferably one to three, and preferably one to two.

The lower limit of the total content of the compounds represented by general formula (ii), general formulas (ii-1) to (ii-3), structural formulas (ii-1.1) to (ii-1.4), structural formulas (ii-2.1) to (ii-2.4), and structural formulas (ii-3.1) to (ii-3.4) based on 100% by mass of the dye compound-containing liquid crystal composition is preferably 1% by mass or more, preferably 5% by mass or more, and preferably 10% by mass or more.

The upper limit of the total content of the compounds represented by general formula (ii), general formulas (ii-1) to (ii-3), structural formulas (ii-1.1) to (ii-1.4), structural formulas (ii-2.1) to (ii-2.4), and structural formulas (ii-3.1) to (ii-3.4) based on 100% by mass of the dye compound-containing liquid crystal composition is preferably 30% by mass or less, preferably 25% by mass or less, and preferably 20% by mass or less.

The total content of the compounds represented by general formula (ii), general formulas (ii-1) to (ii-3), structural formulas (ii-1.1) to (ii-1.4), structural formulas (ii-2.1) to (ii-2.4), and structural formulas (ii-3.1) to (ii-3.4) based on 100% by mass of the dye compound-containing liquid crystal composition is preferably 1 to 30% by mass, preferably 5 to 25% by mass, and preferably 10 to 20% by mass.

The compounds represented by general formula (ii), general formulas (ii-1) to (ii-3), structural formulas (ii-1.1) to (ii-1.4), structural formulas (ii-2.1) to (ii-2.4), and structural formulas (ii-3.1) to (ii-3.4) can each be synthesized using a well-known synthesis method.

### (Additional Compounds)

(Compound Represented by General Formula (iii))

From the viewpoint of further increasing the dielectric anisotropy of the dye compound-containing liquid crystal composition in the invention, the dye compound-containing liquid crystal composition may further contain one or two or more compounds having a trifluorine structure represented by the following general formula (iii).

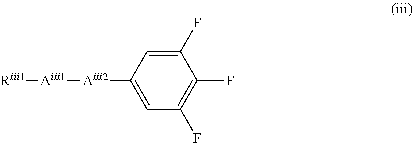

In general formula (iii), Rⁱⁱⁱ¹ represents an alkyl group having 1 to 20 carbon atoms.

The alkyl group having 1 to 20 carbon atoms is a linear, branched, or cyclic alkyl group and is preferably a linear alkyl group.

The number of carbon atoms in the alkyl group having 1 to 20 carbon atoms is preferably 2 to 10 and preferably 2 to 6.

One or two or more —CH₂— groups in the alkyl group may each independently be replaced with —O— and/or —CO—.

One or two or more —CH₂—CH₂— groups in the alkyl group may each independently be replaced with —CH═CH— and/or —C≡C—.

One or two or more hydrogen atoms in the alkyl group may each independently be replaced with a halogen atom.

Examples of the halogen atom include a fluorine atom, a chlorine atom, and a bromine atom.

When the alkyl group is substituted with a prescribed group, no oxygen atoms are bonded directly to each other.

For example, Rⁱⁱⁱ¹ may represent an alkoxy group having 1 to 19 carbon atoms when one —CH₂— group in the alkyl group is replaced with —O—.

The alkoxy group is a linear, branched, or cyclic alkoxy group and is preferably a linear alkoxy group.

The number of carbon atoms in the alkoxy group is preferably 2 to 10 and preferably 2 to 6.

Rⁱⁱⁱ¹ may represent an alkenyl group having 1 to 20 carbon atoms when one or two or more —CH₂—CH₂— groups in the alkyl group are replaced with —CH═CH—.

The alkenyl group is a linear, branched, or cyclic alkenyl group and is preferably a linear alkenyl group.

The number of carbon atoms in the alkenyl group is preferably 2 to 10 and preferably 2 to 6.

Rⁱⁱⁱ¹ may represent an alkynyl group having 1 to 20 carbon atoms when one or two or more —CH₂—CH₂— groups in the alkyl group are replaced with —C≡C—.

The alkynyl group is a linear, branched, or cyclic alkynyl group and is preferably a linear alkynyl group.

The number of carbon atoms in the alkynyl group is preferably 2 to 10 and preferably 2 to 6.

Rⁱⁱⁱ¹ may represent an alkenyloxy group having 1 to 19 carbon atoms when one —CH₂— group in the alkyl group is replaced with —O— and one or two or more —CH₂—CH₂— groups are replaced with —CH═CH—.

The alkenyloxy group is a linear, branched, or cyclic alkenyloxy group and is preferably a linear alkenyloxy group.

The number of carbon atoms in the alkenyloxy group is preferably 2 to 10 and preferably 2 to 6.

Rⁱⁱⁱ¹ may represent a halogenated alkyl group having 1 to 20 carbon atoms when one or two or more hydrogen atoms in the alkyl group are replaced with a halogen atom.

The halogenated alkyl group is a linear, branched, or cyclic halogenated alkyl group and is preferably a linear halogenated alkyl group.

The number of carbon atoms in the halogenated alkyl group is preferably 2 to 10 and preferably 2 to 6.

Specific examples of the alkyl group represented by Rⁱⁱⁱ¹ and having 1 to 20 carbon atoms (including the substituted groups) include groups represented by formulas (Rⁱⁱⁱ¹-1) to (Rⁱⁱⁱ¹-31).

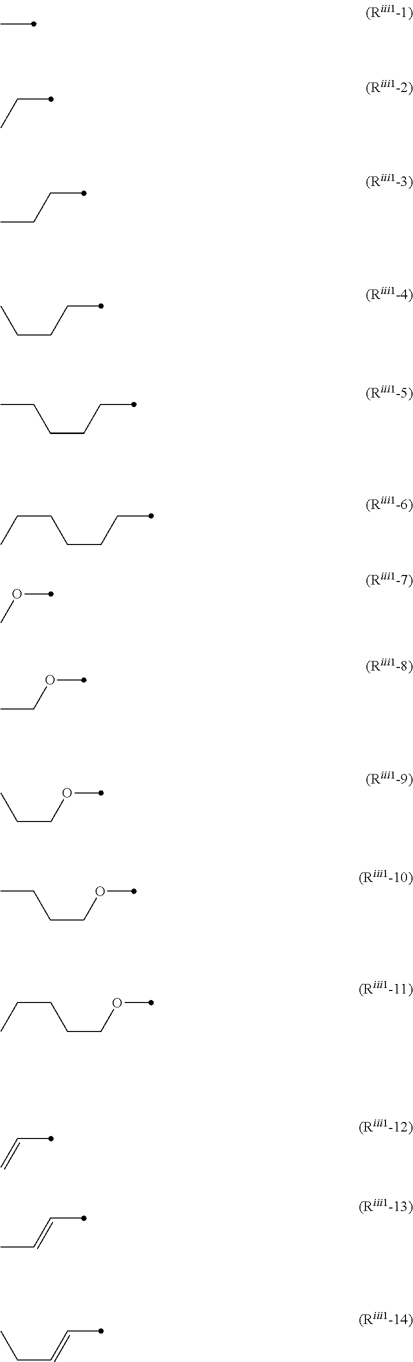

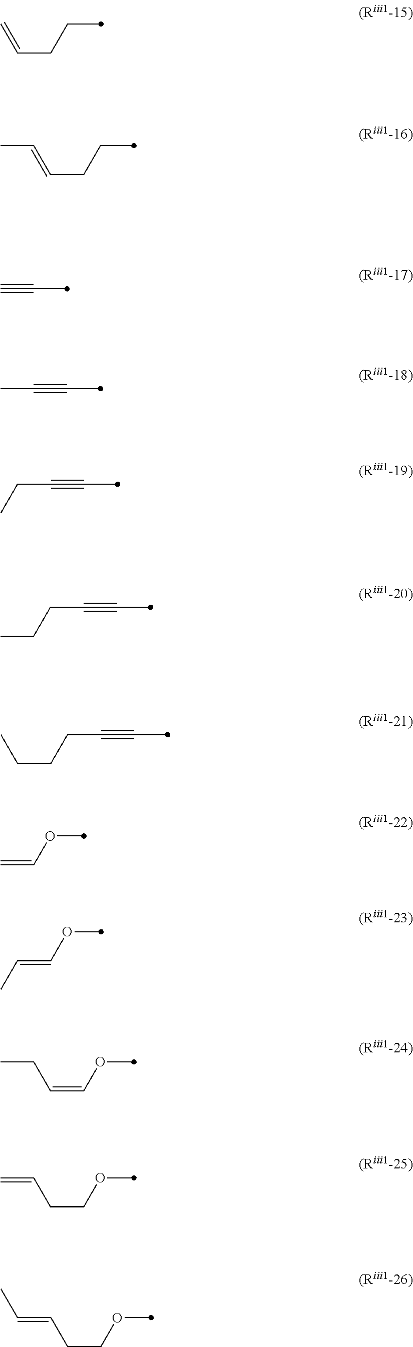

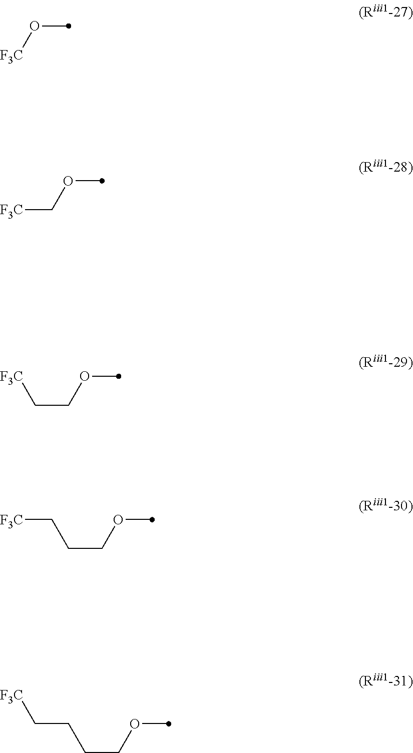

In formulas (Rⁱⁱⁱ¹-1) to (Rⁱⁱⁱ¹-31), each solid circle represents a bond to a cyclic structure.

From the viewpoint of obtaining high solubility and reducing the viscosity of the dye compound-containing liquid crystal composition, Rⁱⁱⁱ¹ is preferably a linear alkyl group having 1 to 6 carbon atoms.

In general formula (iii), Aⁱⁱⁱ¹ and Aⁱⁱⁱ² each independently represent a group selected from the group consisting of the following groups (a) and (b):
(a) a 1,4-cyclohexylene group (one —CH₂— group or two or more non-adjacent —CH₂— groups present in this group may be replaced with —O— and/or —S—); and
(b) a 1,4-phenylene group (one —CH═ group or two or more non-adjacent —CH═ groups present in this group may be replaced with —N═).

One or two or more hydrogen atoms in Aⁱⁱⁱ¹ and Aⁱⁱⁱ² may each independently be replaced with a halogen atom.

Examples of the halogen atom include a fluorine atom, a chlorine atom, a bromine atom, and an iodine atom.

The substitution position of the halogen atom on Aⁱⁱⁱ¹ and Aⁱⁱⁱ² is preferably represented by the following formula (A^{iii1/2}-SP-1),

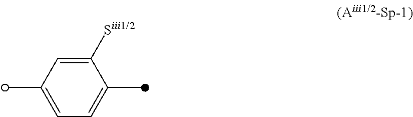

In formula (A^{iii1/2}-SP-1), S^{iii1/2} represents a halogen atom. An open circle represents a bond to Rⁱⁱⁱ¹ or Aⁱⁱⁱ¹, and a solid circle represents a bond to Aⁱⁱⁱ² or the (3F, 5F)-1,4-phenylene group.

Examples of the halogen atom include a fluorine atom, a chlorine atom, a bromine atom, and an iodine atom.

More specifically, Aⁱⁱⁱ¹ and Aⁱⁱⁱ² each represent preferably any of the following formulas (A^{iii1/2}-1) to (A^{iii1/2}-3).

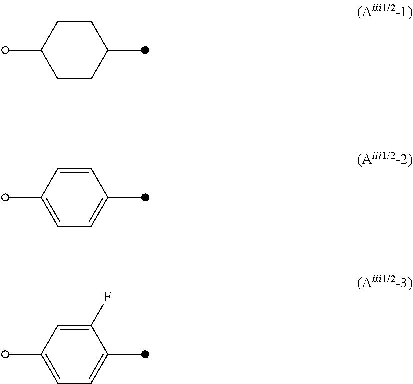

In formulas (A^{iii1/2}-1) to (A^{iii1/2}-3), each open circle represents a bond to Rⁱⁱⁱ¹ or Aⁱⁱⁱ¹, and each solid circle represents a bond to Aⁱⁱⁱ² or a (3F, 5F)-1,4-phenylene group.

The compound represented by general formula (iii) is preferably a compound represented by any of the following general formulas (iii-1) to (iii-5).

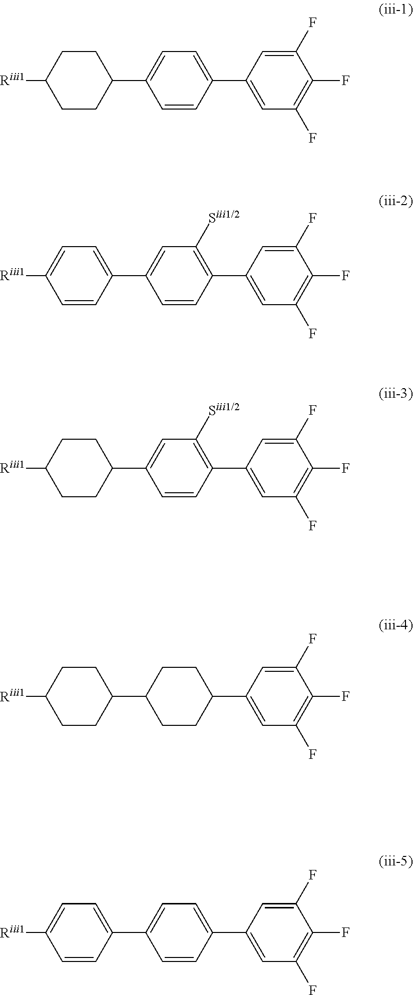

In general formulas (iii-1) to (iii-5), Rⁱⁱⁱ¹ has the same meaning as Rⁱⁱⁱ¹ in general formula (iii) above, and its preferred examples are also the same as the groups exemplified for Rⁱⁱⁱ¹ in general formula (iii).

In general formulas (iii-1) to (iii-5), S^{iii1/2} represents a halogen atom.

Examples of the halogen atom include a fluorine atom, a chlorine atom, a bromine atom, and an iodine atom.

The compound represented by general formula (iii-1) is preferably a compound represented by the following structural formula (iii-1.1).

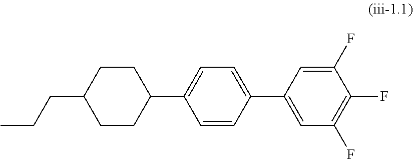

The compound represented by general formula (iii-2) is preferably a compound represented by the following structural formula (iii-2.1).

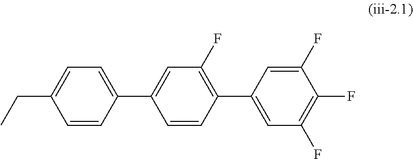

The compound represented by general formula (iii-3) is preferably a compound represented by the following structural formula (iii-3.1).

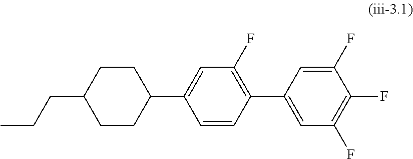

The compound represented by general formula (iii-4) is preferably a compound represented by the following structural formula (iii-4.1).

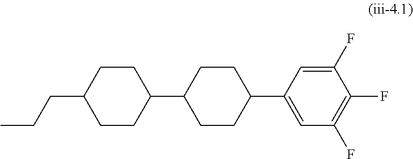

The compound represented by general formula (iii-5) is preferably a compound represented by the following structural formula (iii-5.1).

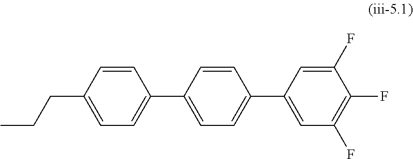

The number of compounds represented by general formula (iii), general formulas (iii-1) to (iii-5), structural formula (iii-1.1), structural formula (iii-2.1), structural formula (iii-3.1), structural formula (iii-4.1), and structural formula (iii-5.1) that are used for the dye compound-containing liquid crystal composition is one or two or more and is preferably one to five, preferably one to four, preferably one to three, and preferably one to two.

The lower limit of the total content of the compounds represented by general formula (iii), general formulas (iii-1) to (iii-5), structural formula (iii-1.1), structural formula (iii-2.1), structural formula (iii-3.1), structural formula (iii-4.1), and structural formula (iii-5.1) based on 100% by mass of the dye compound-containing liquid crystal composition is preferably 1% by mass or more, preferably 5% by mass or more, and preferably 10% by mass or more.

The upper limit of the total content of the compounds represented by general formula (iii), general formulas (iii-1) to (iii-5), structural formula (iii-1.1), structural formula (iii-2.1), structural formula (iii-3.1), structural formula (iii-4.1), and structural formula (iii-5.1) based on 100% by mass of the dye compound-containing liquid crystal composition is preferably 35% by mass or less, preferably 30% by mass or less, and preferably 25% by mass or less.

The total content of the compounds represented by general formula (iii), general formulas (iii-1) to (iii-5), structural formula (iii-1.1), structural formula (iii-2.1), structural formula (iii-3.1), structural formula (iii-4.1), and structural formula (iii-5.1) based on 100% by mass of the dye compound-containing liquid crystal composition is preferably 1 to 35% by mass, preferably 5 to 30% by mass, and preferably 10 to 25% by mass.

The compounds represented by general formula (iii), general formulas (iii-1) to (iii-5), structural formula (iii-1.1), structural formula (iii-2.1), structural formula (iii-3.1), structural formula (iii-4.1), and structural formula (iii-5.1) can each be synthesized using a well-known synthesis method.

(Compound Represented by General Formula (iv))

From the viewpoint of reducing the viscosity of the dye compound-containing liquid crystal composition in the invention, the dye compound-containing liquid crystal composition may further contain one or two or more compounds represented by the following general formula (iv) including a cyclohexane ring and a benzene ring.

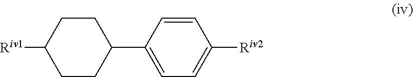

In general formula (iv), R^{iv1} and R^{iv2} each independently represent an alkyl group having 1 to 20 carbon atoms.

The alkyl group having 1 to 20 carbon atoms is a linear, branched, or cyclic alkyl group and is preferably a linear alkyl group.

The number of carbon atoms in the alkyl group having 1 to 20 carbon atoms is preferably 2 to 10 and preferably 2 to 6.

One or two or more —CH₂— groups in the alkyl group may each independently be replaced with —O— and/or —CO—.

One or two or more —CH₂—CH₂— groups in the alkyl group may each independently be replaced with —CH═CH— and/or —C≡C—.

One or two or more hydrogen atoms in the alkyl group may each independently be replaced with a halogen atom.

Examples of the halogen atom include a fluorine atom, a chlorine atom, and a bromine atom.

When the alkyl group is substituted with a prescribed group, no oxygen atoms are bonded directly to each other.

For example, R^{iv1} and R^{iv2} may each represent an alkoxy group having 1 to 19 carbon atoms when one —CH₂— group in the alkyl group is replaced with —O—.

The alkoxy group is a linear, branched, or cyclic alkoxy group and is preferably a linear alkoxy group.

The number of carbon atoms in the alkoxy group is preferably 2 to 10 and preferably 2 to 6.

R^{iv1} and R^{iv2} may each represent an alkenyl group having 1 to 20 carbon atoms when one or two or more —CH₂—CH₂— groups in the alkyl group are replaced with —CH═CH—.

The alkenyl group is a linear, branched, or cyclic alkenyl group and is preferably a linear alkenyl group.

The number of carbon atoms in the alkenyl group is preferably 2 to 10 and preferably 2 to 6.

R^{iv1} and R^{iv2} may each represent an alkynyl group having 1 to 20 carbon atoms when one or two or more —CH₂—CH₂— groups in the alkyl group are replaced with —C≡C—.

The alkynyl group is a linear, branched, or cyclic alkynyl group and is preferably a linear alkynyl group.

The number of carbon atoms in the alkynyl group is preferably 2 to 10 and preferably 2 to 6.

R^{iv1} and R^{iv2} may each represent an alkenyloxy group having 1 to 19 carbon atoms when one —CH₂— group in the alkyl group is replaced with —O— and one or two or more —CH₂—CH₂— groups are replaced with —CH═CH—.

The alkenyloxy group is a linear, branched, or cyclic alkenyloxy group and is preferably a linear alkenyloxy group.

The number of carbon atoms in the alkenyloxy group is preferably 2 to 10 and preferably 2 to 6.

R^{iv1} and R^{iv2} may each represent a halogenated alkyl group having 1 to 20 carbon atoms when one or two or more hydrogen atoms in the alkyl group are replaced with a halogen atom.

The halogenated alkyl group is a linear, branched, or cyclic halogenated alkyl group and is preferably a linear halogenated alkyl group.

The number of carbon atoms in the halogenated alkyl group is preferably 2 to 10 and preferably 2 to 6.

Specific examples of the alkyl groups represented by R^{iv1} and R^{iv2} and having 1 to 20 carbon atoms (including the substituted groups) include groups represented by formulas (R^{iv1/2}-1) to (R^{iv1/2}-31).

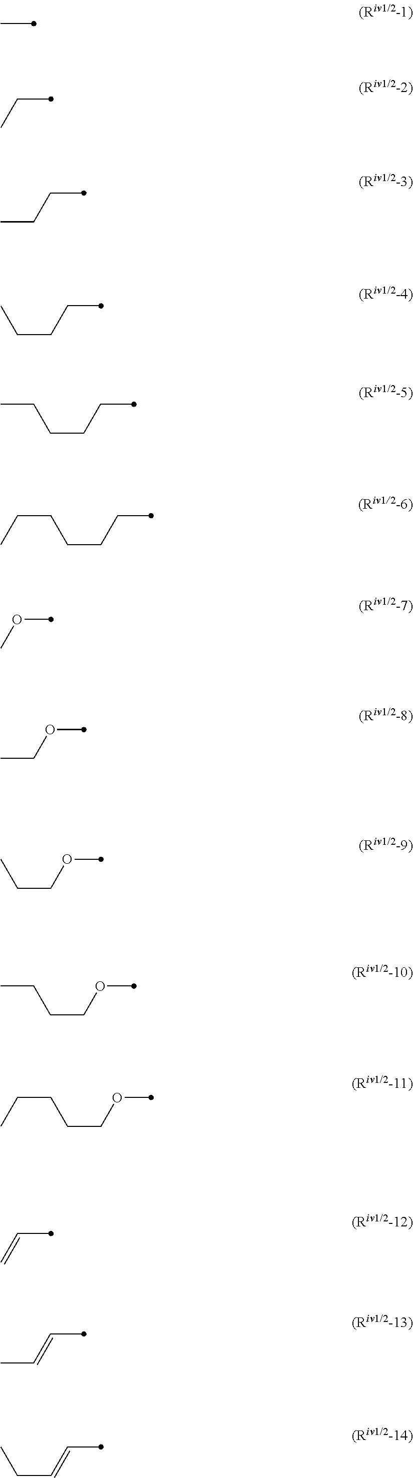

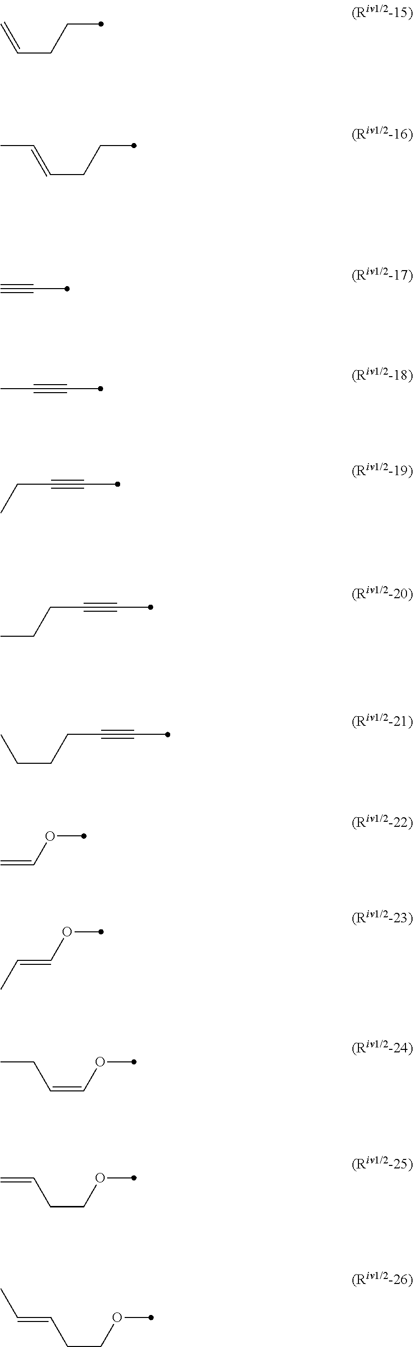

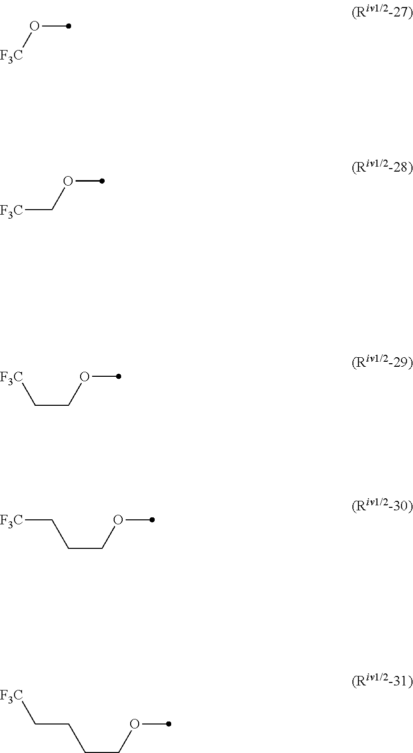

In formulas (R^{iv1/2}-1) to (R^{iv1/2}-31), each solid circle represents a bond to a cyclic structure.

From the viewpoint of reducing the viscosity of the dye compound-containing liquid crystal composition, R^{iv1} is preferably a linear alkyl group having 1 to 6 carbon atoms or a linear alkoxy group having 1 to 6 carbon atoms.

From the viewpoint of increasing the refractive index anisotropy of the dye compound-containing liquid crystal composition, R^{iv2} is preferably a linear alkoxy group having 1 to 6 carbon atoms.

The compound represented by general formula (iv) is preferably a compound represented by any of the following structural formulas (iv-1.1) to (iv-1.5).

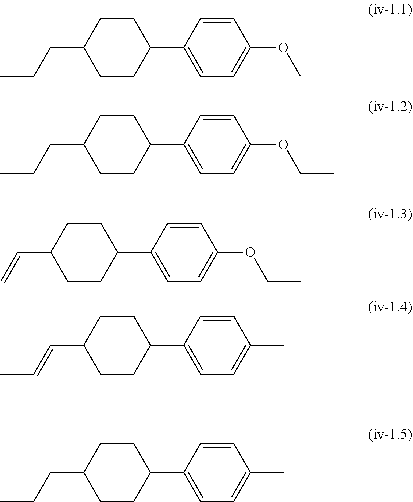

The number of compounds represented by general formula (iv) and structural formulas (iv-1.1) to (iv-1.5) that are used for the dye compound-containing liquid crystal composition is one or two or more and is preferably one to five, preferably one to four, preferably one to three, and preferably one to two.

The lower limit of the total content of the compounds represented by general formula (iv) and structural formulas (iv-1.1) to (iv-1.5) based on 100% by mass of the dye compound-containing liquid crystal composition is preferably 1% by mass or more, preferably 3% by mass or more, and preferably 5% by mass or more.

The upper limit of the total content of the compounds represented by general formula (iv) and structural formulas (iv-1.1) to (iv-1.5) based on 100% by mass of the dye compound-containing liquid crystal composition is preferably 45% by mass or less, preferably 40% by mass or less, and preferably 35% by mass or less.

The total content of the compounds represented by general formula (iv) and structural formulas (iv-1.1) to (iv-1.5) based on 100% by mass of the dye compound-containing liquid crystal composition is preferably 1 to 45% by mass, preferably 3 to 40% by mass, and preferably 5 to 35% by mass.

The compounds represented by general formula (iv) and structural formulas (iv-1.1) to (iv-1.5) can each be synthesized using a well-known synthesis method.

### (Compound Represented by General Formula (v))

From the viewpoint of driving the liquid crystal at an appropriate voltage, the dye compound-containing liquid crystal composition in the invention may contain one or two or more liquid crystal compounds having a positive dielectric anisotropy (2≤Δε) at 25° C., i.e., one or two or more P-type compounds represented by general formula (v) below.

The dielectric anisotropy (Δε) of a liquid crystal compound is a value determined by extrapolation using measurement values of the dielectric anisotropy of compositions prepared by adding the liquid crystal compound to a composition that is substantially dielectrically neutral at 25° C.

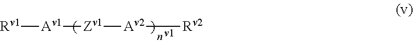

In general formula (v), R^{v1} represents an alkyl group having 1 to 20 carbon atoms.

The alkyl group having 1 to 20 carbon atoms is a linear, branched, or cyclic alkyl group and is preferably a linear alkyl group.

The number of carbon atoms in the alkyl group having 1 to 20 carbon atoms is preferably 2 to 10 and preferably 2 to 6.

One or two or more —CH₂— groups in the alkyl group may each independently be replaced with —O— and/or —CO—.

One or two or more —CH₂—CH₂— groups in the alkyl group may each independently be replaced with —CH═CH— and/or —C≡C—.

One or two or more hydrogen atoms in the alkyl group may each independently be replaced with a halogen atom.

Examples of the halogen atom include a fluorine atom, a chlorine atom, and a bromine atom.

When the alkyl group is substituted with a prescribed group, no oxygen atoms are bonded directly to each other.

For example, R^{v1} may represent an alkoxy group having 1 to 19 carbon atoms when one —CH₂— group in the alkyl group is replaced with —O—.

The alkoxy group is a linear, branched, or cyclic alkoxy group and is preferably a linear alkoxy group.

The number of carbon atoms in the alkoxy group is preferably 2 to 10 and preferably 2 to 6.

R^{v1} may represent an alkenyl group having 1 to 20 carbon atoms when one or two or more —CH₂—CH₂— groups in the alkyl group are replaced with —CH═CH—.

The alkenyl group is a linear, branched, or cyclic alkenyl group and is preferably a linear alkenyl group.

The number of carbon atoms in the alkenyl group is preferably 2 to 10 and preferably 2 to 6.

R^{v1} may represent an alkynyl group having 1 to 20 carbon atoms when one or two or more —CH₂—CH₂— groups in the alkyl group are replaced with —C≡C—.

The alkynyl group is a linear, branched, or cyclic alkynyl group and is preferably a linear alkynyl group.

The number of carbon atoms in the alkynyl group is preferably 2 to 10 and preferably 2 to 6.

R^{v1} may represent an alkenyloxy group having 1 to 19 carbon atoms when one —CH₂— group in the alkyl group is replaced with —O— and one or two or more —CH₂—CH₂— groups are replaced with —CH═CH—.

The alkenyloxy group is a linear, branched, or cyclic alkenyloxy group and is preferably a linear alkenyloxy group.

The number of carbon atoms in the alkenyloxy group is preferably 2 to 10 and preferably 2 to 6.

R^{v1} may represent a halogenated alkyl group having 1 to 20 carbon atoms when one or two or more hydrogen atoms in the alkyl group are replaced with a halogen atom.

The halogenated alkyl group is a linear, branched, or cyclic halogenated alkyl group and is preferably a linear halogenated alkyl group.

The number of carbon atoms in the halogenated alkyl group is preferably 2 to 10 and preferably 2 to 6.

Specific examples of the alkyl group represented by R^{v1} and having 1 to 20 carbon atoms (including the substituted groups) include groups represented by formulas (R^{v1-1}) to (R^{v1-31}).

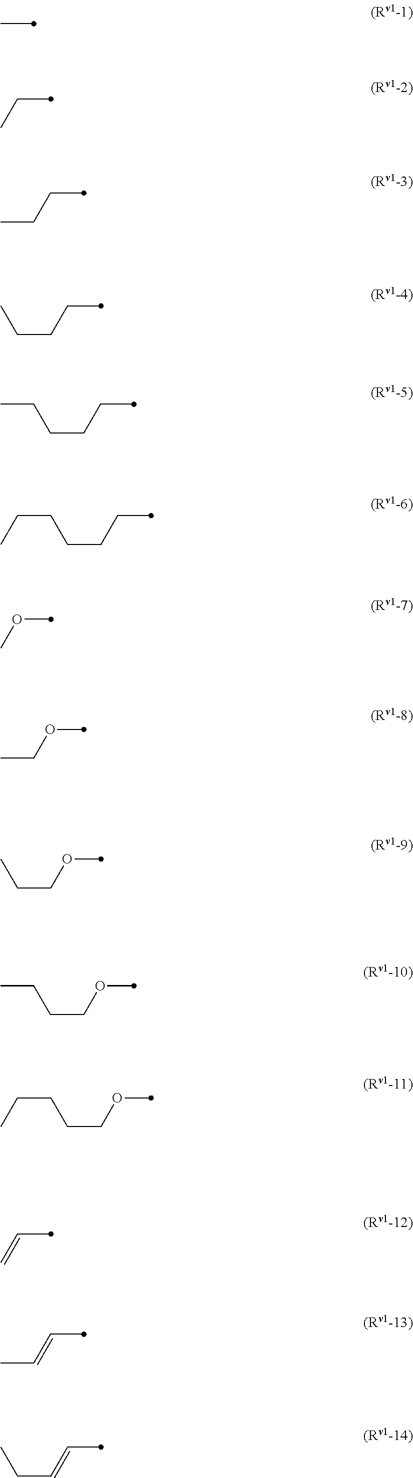

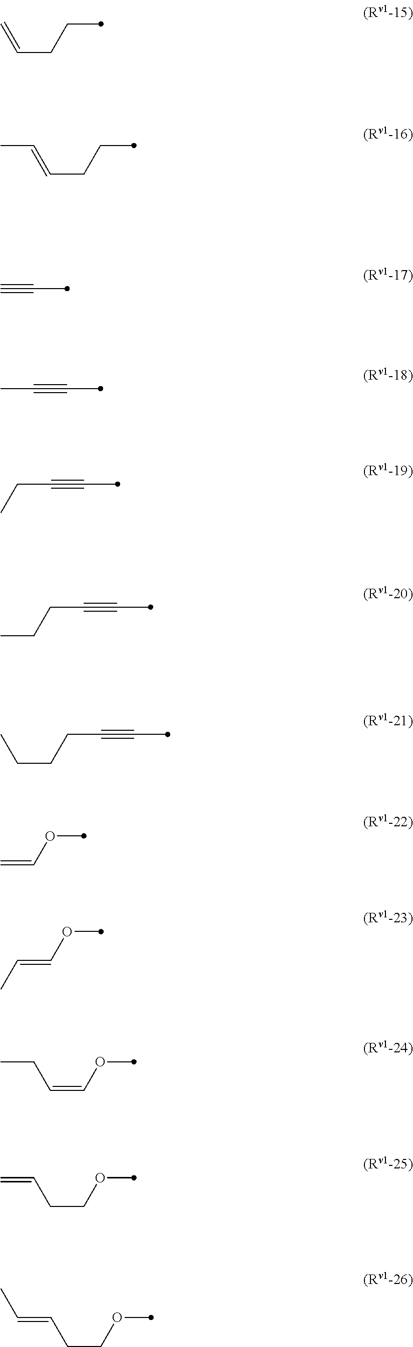

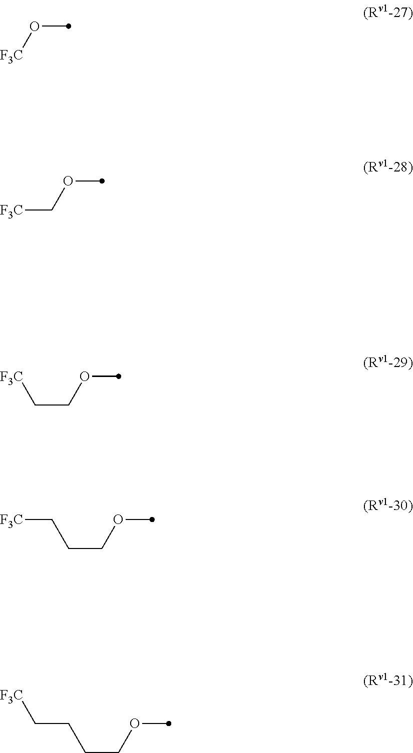

In formulas (R^{v1-1}) to (R^{v1-31}), each solid circle represents a bond to a cyclic structure.

From the viewpoint of reducing the viscosity of the dye compound-containing liquid crystal composition, R^{v1} is preferably a linear alkyl group having 1 to 6 carbon atoms.

In general formula (v), R^{v2} represents a halogen atom, —CN, —OCN, or —C≡CCN.

Examples of the halogen atom include a fluorine atom, a chlorine atom, a bromine atom, and an iodine atom.

From the viewpoint of allowing the dye compound-containing liquid crystal composition to have high light fastness and high solubility, R^{v2} is preferably a fluorine atom or —CN.

A^{v1} and A^{v2} in general formula (v) each independently represent a group selected from the group consisting of the following groups (a), (b), and (c):
(a) a 1,4-cyclohexylene group (one —CH₂— group or two or more non-adjacent —CH₂— groups present in this group may be replaced with —O— and/or —S—);
(b) a 1,4-phenylene group (one —CH═ group or two or more non-adjacent —CH═ groups present in this group may be replaced with —N═); and
(c) a naphthalene-2,6-diyl group or a decahydronaphthalene-2,6-diyl group (one —CH═ group or two or more non-adjacent —CH═ groups present in the naphthalene-2,6-diyl group may be replaced with —N═).

One or two or more hydrogen atoms in A^{v1} and A^{v2} may each independently be replaced with a halogen atom.

Examples of the halogen atom include a fluorine atom, a chlorine atom, a bromine atom, and an iodine atom.

The substitution position of the halogen atom on A^{v1} and A^{v2} is preferably represented by any of the following formulas (A^{v1/2}-SP-1) to (A^{v1/2}-SP-2).

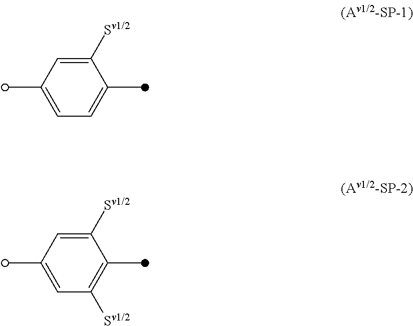

In formulas (A^{v1/2}-SP-1) to (A^{v1/2}-SP-2), S^{v1/2}s each independently represent a halogen atom. Each open circle represents a bond to R^{v1} or Z^{v1}, and each solid circle represents a bond to Z^{v1} or R^{v2}.

Examples of the halogen atom include a fluorine atom, a chlorine atom, a bromine atom, and an iodine atom.

More specifically, A^{v1} and A^{v2} each represent any of the following formulas (A^{v1/2}-1) to (A^{v1/2}-5).

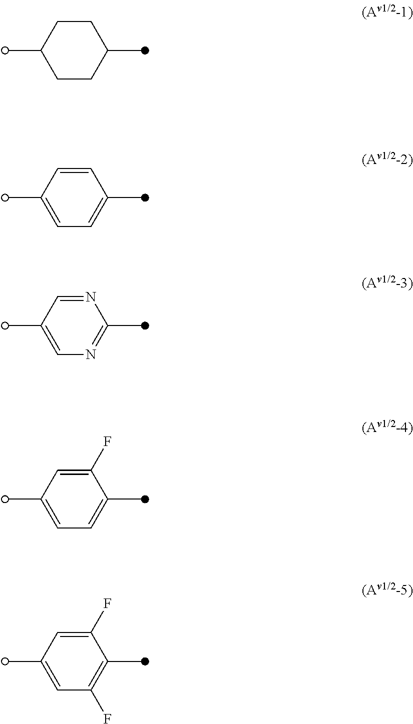

In formulas (A^{v1/2}-1) to (A^{v1/2}-5), each open circle represents a bond to R^{v1} or Z^{v1}, and each solid circle represents a bond to Z^{v1} or R^{v2}.

In general formula (v), Z^{v1} represents a single bond or an alkylene group having 1 to 20 carbon atoms.

The alkylene group is a linear, branched, or cyclic alkylene group and is preferably a linear alkylene group.

The number of carbon atoms in the alkylene group is preferably 2 to 10 and preferably 2 to 6.

One or two or more —CH₂— groups in the alkylene group may each independently be replaced with —O—, —CH(CH₃)—, —CO— and/or —CF₂—.

One or two or more —CH₂—CH₂— groups in the alkylene group may each independently be replaced with —CH═CH—, —CF═CH—, —CH═CF—, —CF═CF—, —CH═C(CH₃)—, —C(CH₃)═CH—, —CH═N—, —N═CH—, —N═N—, and/or —C≡C—.

When the alkylene group is substituted with a prescribed group, no oxygen atoms are bonded directly to each other.

Specific examples of the alkylene group having 1 to 20 carbon atoms (including the substituted groups) include groups represented by formulas (Z^{v1}-1) to (Z^{v1}-24).

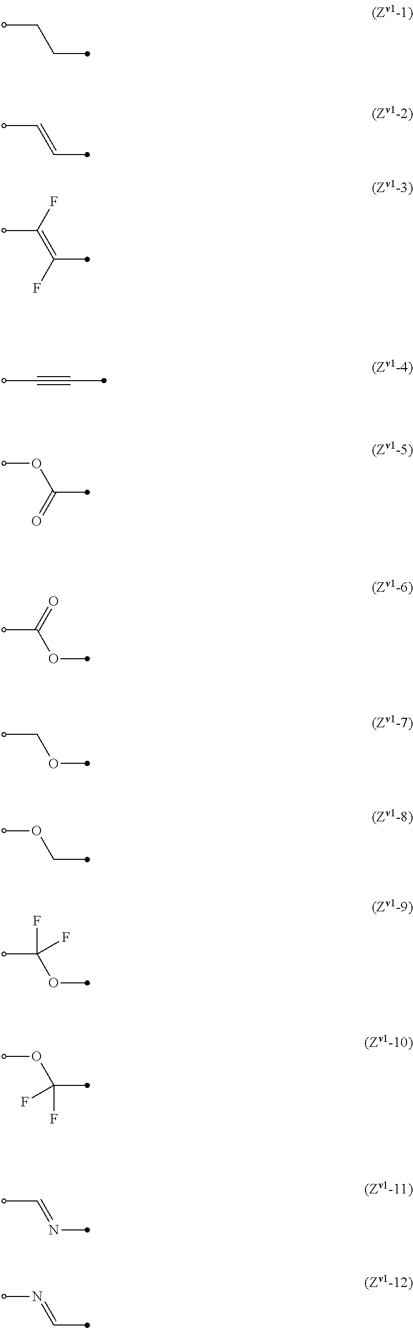

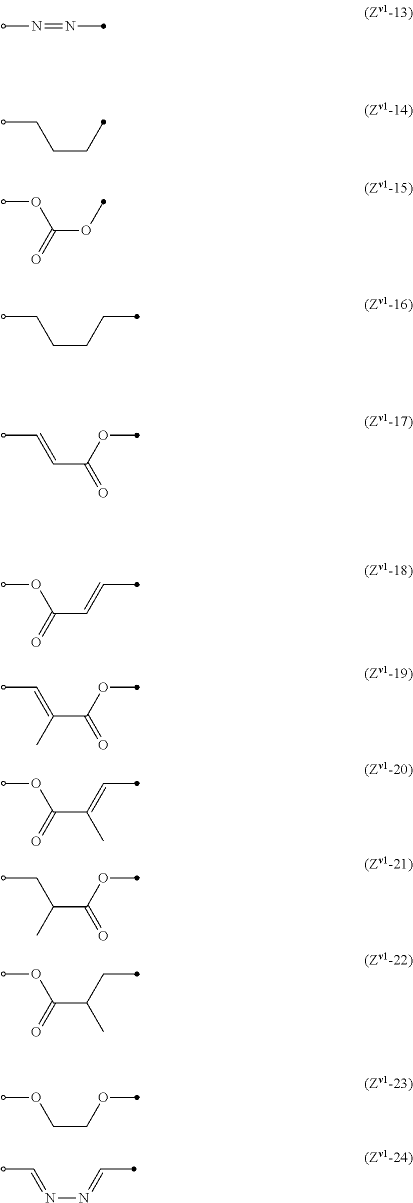

In formulas (Z^{v1}-1) to (Z^{v1}-24), each open circle represents a bond to A^{v1} or A^{v2}, and each solid circle represents a bond to A^{v2}.

From the viewpoint of allowing the dye compound-containing liquid crystal composition to have high light fastness, Z^{vi1} is preferably a single bond, —CO—O—, —O—CO—, or a linear alkylene group having 1 to 6 carbon atoms.

n^{v1} represents an integer of 1 to 3.

When a plurality of A^{v2}s are present, they may be the same or different. When a plurality of Z^{v1}s are present, they may be the same or different.

The compounds represented by general formulas (ii) and (iii) (including their subordinate concepts) are excluded from the compound represented by general formula (v).

The compound represented by general formula (v) is preferably a compound represented by any of the following general formulas (v-1) to (v-3).

R^{v1}-A^{v1}-Z^{v1}-A^{v2}-R^{v2} (v-1)

R^{v1}-A^{v1}-Z^{v1}-A^{v2}-Z^{v1-2}-A^{v2-2}-R^{v2} (v-2)

R^{v1}-A^{v1}-Z^{v1}-A^{v2}-Z^{v1-2}-A^{v2-2}-Z^{v1-3}-A^{v2-3}-R^{v2} (v-3)

In general formulas (v-1) to (v-3), R^{v1}, R^{v2}, Z^{v1}, A^{v1}, and A^{v2} have the same meanings as R^{v1}, R^{v2}, Z^{v1}, A^{v1}, and A^{v2}, respectively, in general formula (v), and their preferred examples are also the same as the groups exemplified for R^{v1}, R^{v2}, Z^{v1}, A^{v1}, and A^{v2} in general formula (v).

In general formulas (v-1) to (v-3), Z^{v1-2} and Z^{v1-3} each independently have the same meaning as Z^{v1} in general formula (v) above, and their preferred examples are also the same as the groups exemplified for Z^{v1} in general formula (v).

In general formulas (v-1) to (v-3), A^{v2-2} and A^{v2-3} each independently have the same meaning as A^{v1} in general formula (v) above, and their preferred examples are also the same as the groups exemplified for A^{v1} in general formula (v).

The compound represented by general formula (v-1) is preferably a compound represented by any of the following general formulas (v-1-1) to (v-1-10).

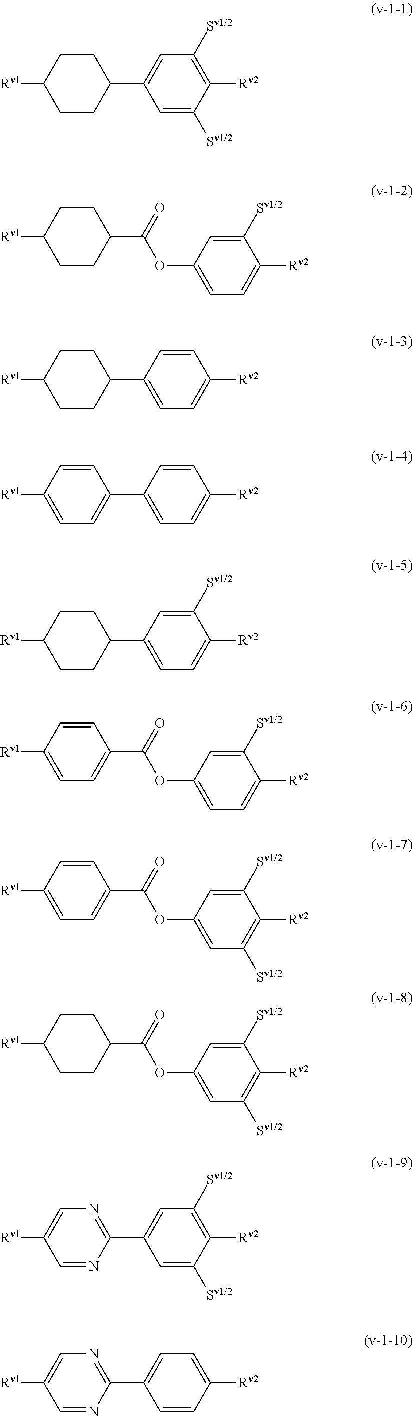

In general formulas (v-1-1) to (v-1-10), R^{v1} and R^{v2} have the same meanings as R^{v1} and R^{v2}, respectively, in general formula (v) above, and their preferred examples are also the same as the groups exemplified for R^{v1} and R^{v2} in general formula (v).

In general formulas (v-1-1) to (v-1-10), S^{v1/2}s each independently represent a halogen atom.

Examples of the halogen atom include a fluorine atom, a chlorine atom, a bromine atom, and an iodine atom.

The compound represented by general formula (v-1-1) is preferably a compound represented by any of the following structural formulas (v-1-1.1) to (v-1-1.4).

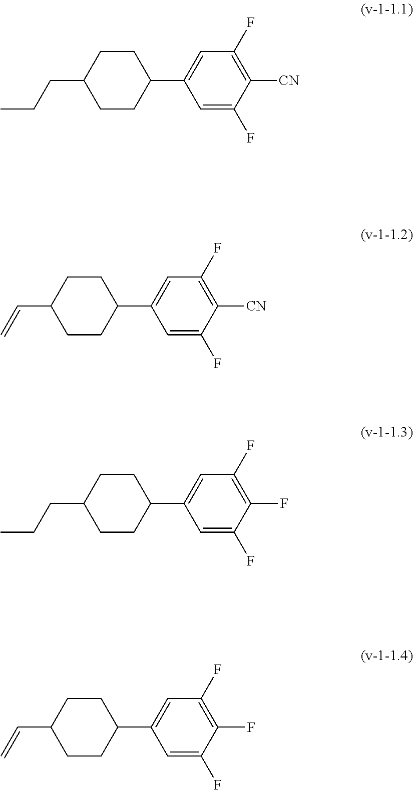

The compound represented by general formula (v-1-2) is preferably a compound represented by the following structural formula (v-1-2.1).

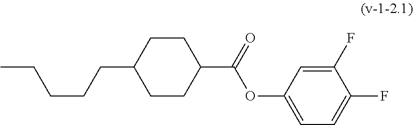

The compound represented by general formula (v-1-3) is preferably a compound represented by any of the following structural formulas (v-1-3.1) to (v-1-3.4).

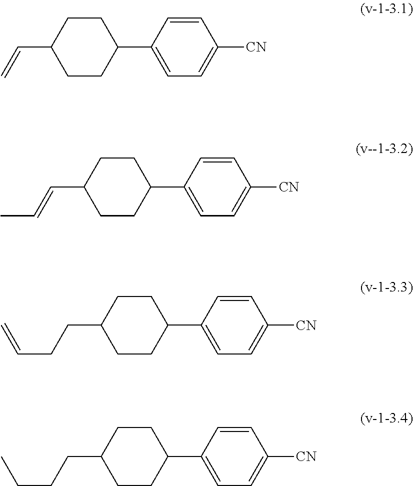

The compound represented by general formula (v-1-4) is preferably a compound represented by any of the following structural formulas (v-1-4.1) to (v-1-4.2).

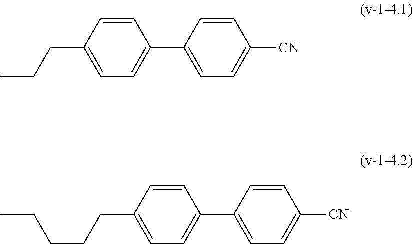

The compound represented by general formula (v-1-5) is preferably a compound represented by the following structural formula (v-1-5.1).

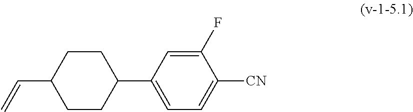

The compound represented by general formula (v-1-6) is preferably a compound represented by any of the following structural formulas (v-1-6.1) to (v-1-6.2).

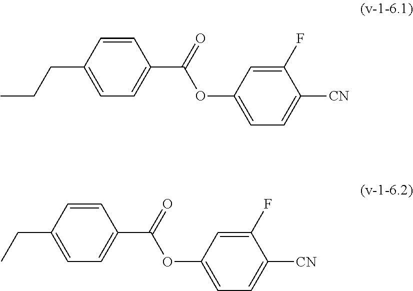

The compound represented by general formula (v-1-7) is preferably a compound represented by the following structural formula (v-1-7.1).

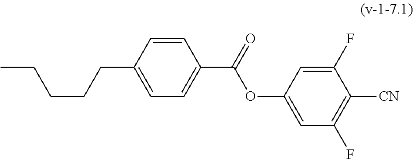

The compound represented by general formula (v-1-8) is preferably a compound represented by the following structural formula (v-1-8.1).

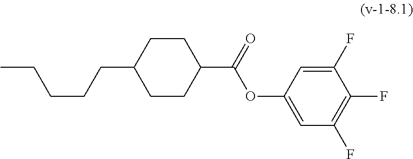

The compound represented by general formula (v-1-9) is preferably a compound represented by the following structural formula (v-1-9.1).

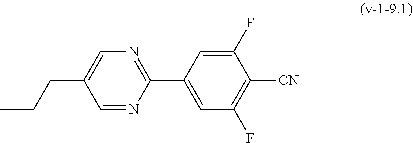

The compound represented by general formula (v-1-10) is preferably a compound represented by the following structural formula (v-1-10.1).

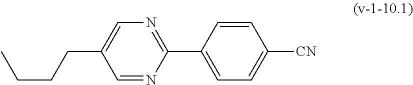

The compound represented by general formula (v-2) is preferably a compound represented by any of the following general formulas (v-2-1) to (v-2-5).

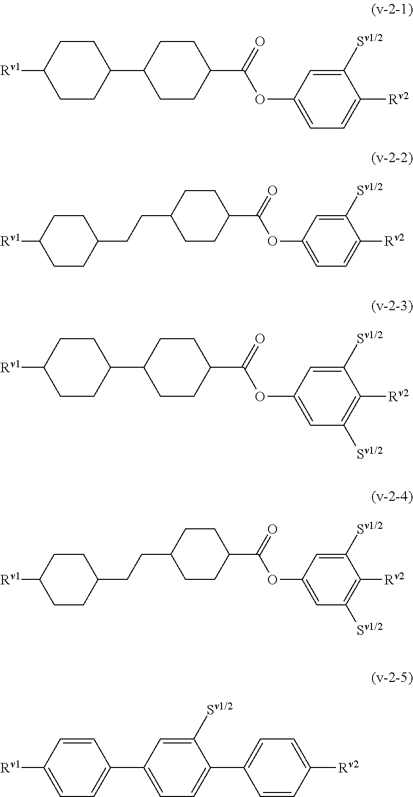

In general formulas (v-2-1) to (v-2-5), R^{v1} and R^{v2} have the same meanings as R^{v1} and R^{v2}, respectively, in general formula (v) above, and their preferred examples are also the same as the groups exemplified for R^{v1} and R^{v2} in general formula (v).

In general formulas (v-2-1) to (v-2-5), S^{v1/2}s each independently represent a halogen atom.

Examples of the halogen atom include a fluorine atom, a chlorine atom, a bromine atom, and an iodine atom.

The compound represented by general formula (v-2-1) is preferably a compound represented by the following structural formula (v-2-1.1).

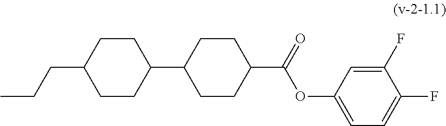

The compound represented by general formula (v-2-2) is preferably a compound represented by any of the following structural formulas (v-2-2.1) to (v-2-2.2).

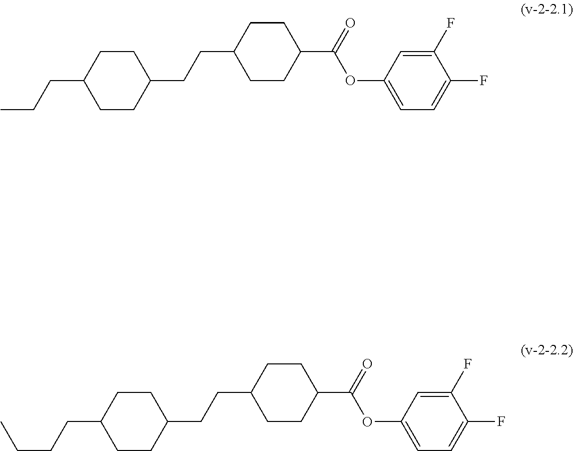

The compound represented by general formula (v-2-3) is preferably a compound represented by the following structural formula (v-2-3.1).

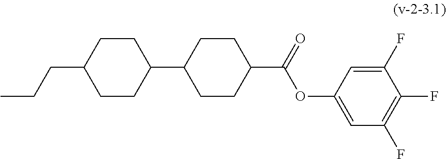

The compound represented by general formula (v-2-4) is preferably a compound represented by any of the following structural formulas (v-2-4.1) to (v-4-4.2).

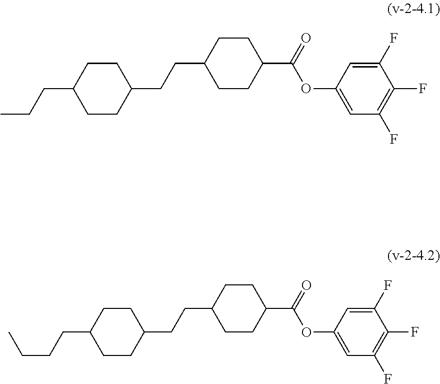

The compound represented by general formula (v-2-5) is preferably a compound represented by the following structural formula (v-2-5.1).

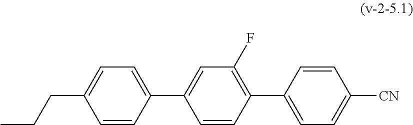

The compound represented by general formula (v-3) is preferably a compound represented by any of the following general formulas (v-3-1) to (v-3-2).

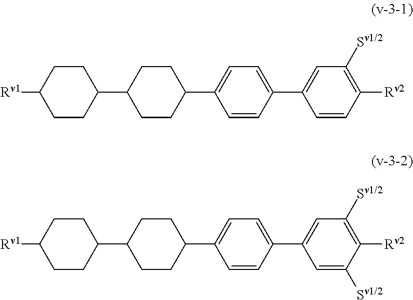

In general formulas (v-3-1) to (v-3-2), R^{v1} and R^{v2} have the same meanings as R^{v1} and R^{v2}, respectively, in general formula (v) above, and their preferred examples are also the same as the groups exemplified for R^{v1} and R^{v2} in general formula (v).

In general formulas (v-3-1) to (v-3-2), S^{v1/2}s each independently represent a halogen atom.

Examples of the halogen atom include a fluorine atom, a chlorine atom, a bromine atom, and an iodine atom.

The compound represented by general formula (v-3-1) is preferably a compound represented by any of the following structural formulas (v-3-1.1) to (v-3-1.2).

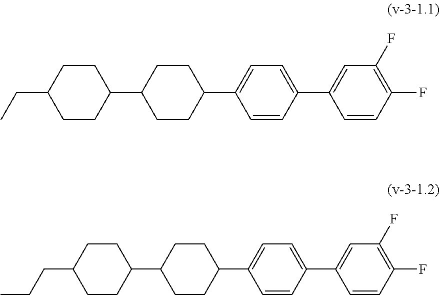

The compound represented by general formula (v-3-1) is preferably a compound represented by any of the following structural formulas (v-3-2.1) to (v-3-2.2).

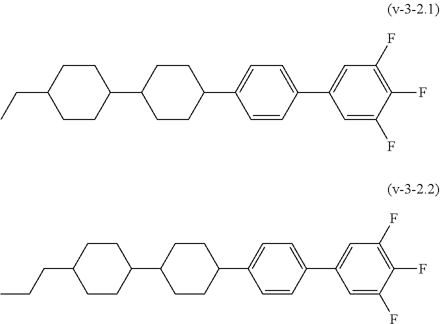

The number of compounds represented by general formula (v), general formulas (v-1) to (v-3), general formulas (v-1-1) to (v-1-10), general formulas (v-2-1) to (v-2-5), general formulas (v-3-1) to (v-3-2), structural formulas (v-1-1.1) to (v-1-1.4), structural formula (v-1-2.1), structural formulas (v-1-3.1) to (v-1-3.4), structural formulas (v-1-4.1) to (v-1-4.2), structural formula (v-1-5.1), structural formulas (v-1-6.1) to (v-1-6.2), structural formula (v-1-7.1), structural formula (v-1-8.1), structural formula (v-1-9.1), structural formula (v-1-10.1), structural formula (v-2-1.1), structural formulas (v-2-2.1) to (v-2-2.2), structural formula (v-2-3.1), structural formulas (v-2-4.1) to (v-4-4.2), structural formula (v-2-5.1), structural formulas (v-3-1.1) to (v-3-1.2), and structural formulas (v-3-2.1) to (v-3-2.2) that are used for the dye compound-containing liquid crystal composition is one or two or more and is preferably one to six, preferably one to five, preferably one to four, and preferably one to three.

The lower limit of the total content of the compounds represented by general formula (v), general formulas (v-1) to (v-3), general formulas (v-1-1) to (v-1-10), general formulas (v-2-1) to (v-2-5), general formulas (v-3-1) to (v-3-2), structural formulas (v-1-1.1) to (v-1-1.4), structural formula (v-1-2.1), structural formulas (v-1-3.1) to (v-1-3.4), structural formulas (v-1-4.1) to (v-1-4.2), structural formula (v-1-5.1), structural formulas (v-1-6.1) to (v-1-6.2), structural formula (v-1-7.1), structural formula (v-1-8.1), structural formula (v-1-9.1), structural formula (v-1-10.1), structural formula (v-2-1.1), structural formulas (v-2-2.1) to (v-2-2.2), structural formula (v-2-3.1), structural formulas (v-2-4.1) to (v-4-4.2), structural formula (v-2-5.1), structural formulas (v-3-1.1) to (v-3-1.2), and structural formulas (v-3-2.1) to (v-3-2.2) based on 100% by mass of the dye compound-containing liquid crystal composition is preferably 1% by mass or more, preferably 3% by mass or more, and preferably 5% by mass or more.

The upper limit of the total content of the compounds represented by general formula (v), general formulas (v-1) to (v-3), general formulas (v-1-1) to (v-1-10), general formulas (v-2-1) to (v-2-5), general formulas (v-3-1) to (v-3-2), structural formulas (v-1-1.1) to (v-1-1.4), structural formula (v-1-2.1), structural formulas (v-1-3.1) to (v-1-3.4), structural formulas (v-1-4.1) to (v-1-4.2), structural formula (v-1-5.1), structural formulas (v-1-6.1) to (v-1-6.2), structural formula (v-1-7.1), structural formula (v-1-9.1), structural formula (v-1-9.1), structural formula (v-1-10.1), structural formula (v-2-1.1), structural formulas (v-2-2.1) to (v-2-2.2), structural formula (v-2-3.1), structural formulas (v-2-4.1) to (v-4-4.2), structural formula (v-2-5.1), structural formulas (v-3-1.1) to (v-3-1.2), and structural formulas (v-3-2.1) to (v-3-2.2) based on 100% by mass of the dye compound-containing liquid crystal composition is preferably 50% by mass or less, preferably 45% by mass or less, and preferably 40% by mass or less.

The total content of the compounds represented by general formula (v), general formulas (v-1) to (v-3), general formulas (v-1-1) to (v-1-10), general formulas (v-2-1) to (v-2-5), general formulas (v-3-1) to (v-3-2), structural formulas (v-1-1.1) to (v-1-1.4), structural formula (v-1-2.1), structural formulas (v-1-3.1) to (v-1-3.4), structural formulas (v-1-4.1) to (v-1-4.2), structural formula (v-1-5.1), structural formulas (v-1-6.1) to (v-1-6.2), structural formula (v-1-7.1), structural formula (v-1-8.1), structural formula (v-1-9.1), structural formula (v-1-10.1), structural formula (v-2-1.1), structural formulas (v-2-2.1) to (v-2-2.2), structural formula (v-2-3.1), structural formulas (v-2-4.1) to (v-4-4.2), structural formula (v-2-5.1), structural formulas (v-3-1.1) to (v-3-1.2), and structural formulas (v-3-2.1) to (v-3-2.2) based on 100% by mass of the dye compound-containing liquid crystal composition is preferably 1 to 50% by mass, preferably 3 to 45% by mass, and preferably 5 to 40% by mass.

The compounds represented by general formula (v), general formulas (v-1) to (v-3), general formulas (v-1-1) to (v-1-10), general formulas (v-2-1) to (v-2-5), general formulas (v-3-1) to (v-3-2), structural formulas (v-1-1.1) to (v-1-1.4), structural formula (v-1-2.1), structural formulas (v-1-3.1) to (v-1-3.4), structural formulas (v-1-4.1) to (v-1-4.2), structural formula (v-1-5.1), structural formulas (v-1-6.1) to (v-1-6.2), structural formula (v-1-7.1), structural formula (v-1-8.1), structural formula (v-1-9.1), structural formula (v-1-10.1), structural formula (v-2-1.1), structural formulas (v-2-2.1) to (v-2-2.2), structural formula (v-2-3.1), structural formulas (v-2-4.1) to (v-4-4.2), structural formula (v-2-5.1), structural formulas (v-3-1.1) to (v-3-1.2), and structural formulas (v-3-2.1) to (v-3-2.2) can each be synthesized using a well-known synthesis method.

(Compound Represented by General Formula (vi))

From the viewpoint of improving the solubility of the dye compound-containing liquid crystal composition in the invention and improving its light fastness, the liquid crystal composition may contain one or two or more liquid crystal compounds having a neutral dielectric anisotropy (−2<Δε<2) at 25° C., i.e., one or two or more np-type compounds represented by general formula (vi) below.

The dielectric anisotropy (Δε) of a liquid crystal compound is a value determined by extrapolation using measurement values of the dielectric anisotropy of compositions prepared by adding the liquid crystal compound to a composition that is substantially dielectrically neutral at 25° C.

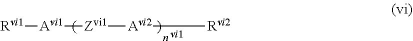

In general formula (vi), R^{vi1} and R^{vi2} each independently represent an alkyl group having 1 to 20 carbon atoms.

The alkyl group having 1 to 20 carbon atoms is a linear, branched, or cyclic alkyl group and is preferably a linear alkyl group.

The number of carbon atoms in the alkyl group having 1 to 20 carbon atoms is preferably 2 to 10 and preferably 2 to 6.

One or two or more —CH═ groups in the alkyl group may each independently be replaced with —O— and/or —CO—.

One or two or more —CH₂—CH₂— groups in the alkyl group may each independently be replaced with —CH═CH— and/or —C≡C—.

When the alkyl group is substituted with a prescribed group, no oxygen atoms are bonded directly to each other.

For example, R^{vi1} and R^{vi2} may each represent an alkoxy group having 1 to 19 carbon atoms when one —CH₂— group in the alkyl group is replaced with —O—.

The alkoxy group is a linear, branched, or cyclic alkoxy group and is preferably a linear alkoxy group.

The number of carbon atoms in the alkoxy group is preferably 2 to 10 and preferably 2 to 6.

R^{vi1} and R^{vi2} may each represent an alkenyl group having 1 to 20 carbon atoms when one or two or more —CH₂—CH₂— groups in the alkyl group are replaced with —CH═CH—.

The alkenyl group is a linear, branched, or cyclic alkenyl group and is preferably a linear alkenyl group.

The number of carbon atoms in the alkenyl group is preferably 2 to 10 and preferably 2 to 6.

R^{vi1} and R^{vi2} may each represent an alkynyl group having 1 to 20 carbon atoms when one or two or more —CH₂—CH₂— groups in the alkyl group are replaced with —C≡C—.

The alkynyl group is a linear, branched, or cyclic alkynyl group and is preferably a linear alkynyl group.

The number of carbon atoms in the alkynyl group is preferably 2 to 10 and preferably 2 to 6.

R^{vi1} and R^{vi2} may each represent an alkenyloxy group having 1 to 19 carbon atoms when one —CH₂— group in the alkyl group is replaced with —O— and one or two or more —CH₂—CH₂— groups are replaced with —CH═CH—.

The alkenyloxy group is a linear, branched, or cyclic alkenyloxy group and is preferably a linear alkenyloxy group.

The number of carbon atoms in the alkenyloxy group is preferably 2 to 10 and preferably 2 to 6.

Specific examples of the alkyl groups represented by R^{vi1} and R^{vi2} and having 1 to 20 carbon atoms (including the substituted groups) include groups represented by formulas (R^{vi1/2}-1) to (R^{vi1/2}-26).

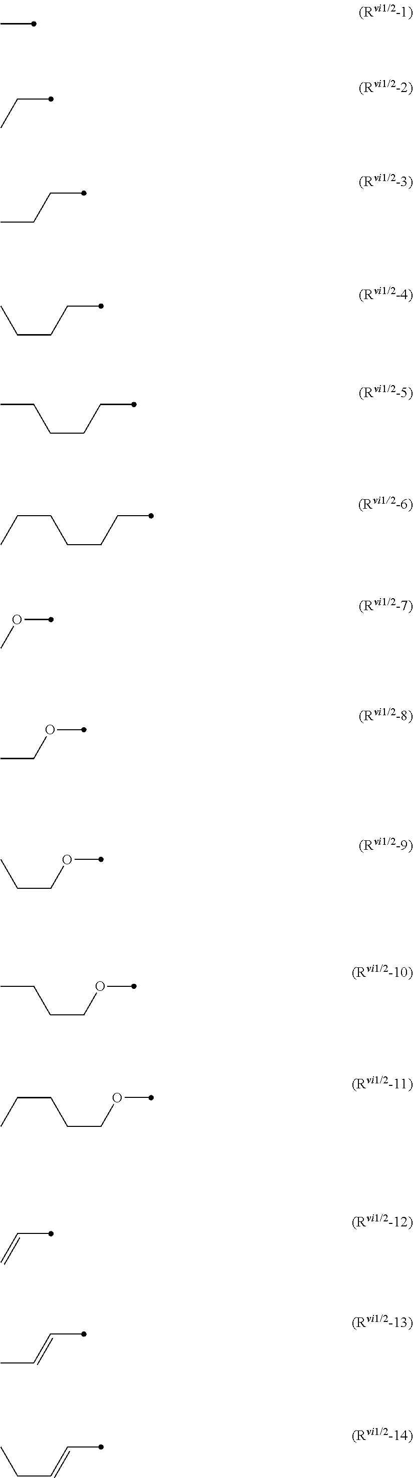

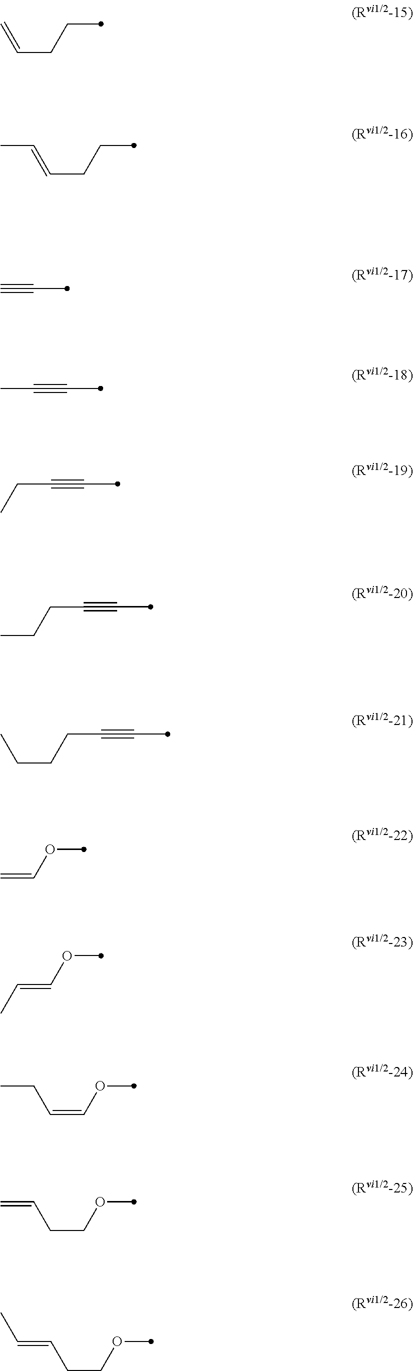

In formulas (R^{vi1/2}-1) to (R^{vi1/2}-26), each solid circle represents a bond to a cyclic structure.

From the viewpoint of improving the solubility of the dye compound-containing liquid crystal composition and improving its light fastness, R^{vi1} and R^{vi2} are each preferably a linear alkyl group having 1 to 6 carbon atoms or a linear alkenyl group having 2 to 6 carbon atoms.

In general formula (vi), A^{vi1} and A^{vi2} each independently represent a group selected from the group consisting of the following groups (a), (b), and (c):
(a) a 1,4-cyclohexylene group (one —CH₂— group or two or more non-adjacent —CH₂— groups present in this group may be replaced with —O— and/or —S—);
(b) a 1,4-phenylene group (one —CH═ group or two or more non-adjacent —CH═ groups present in this group may be replaced with —N═); and
(c) a naphthalene-2,6-diyl group or a decahydronaphthalene-2,6-diyl group (one —CH═ group or two or more non-adjacent —CH═ groups present in the naphthalene-2,6-diyl group may be replaced with —N═).

In A^{vi1} and A^{vi2}, one or two or more hydrogen atoms may each independently be replaced with an alkyl group having 1 to 6 carbon atoms.

The alkyl group having 1 to 6 carbon atoms is preferably a methyl group, an ethyl group, or a n-propyl group.

In A^{vi1} and A^{vi2}, the substitution position of the alkyl group having 1 to 6 carbon atoms is preferably represented by the following formula (A^{vi1/2}-SP-1).

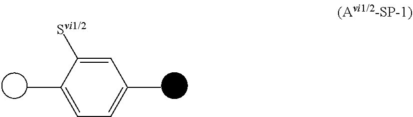

In formula (A^{vi1/2}-SP-1), S^{vi1/2} represents an alkyl group having 1 to 6 carbon atoms. An open circle represents a bond to R^{vi1} or Z^{vi2}, and a solid circle represents a bond to Z^{vi1} or R^{vi2}.

The alkyl group having 1 to 6 carbon atoms is preferably a methyl group, an ethyl group, or a n-propyl group.

More specifically, A^{vi1} and A^{vi2} each represent any of the following formulas (A^{vi1/2}-1) to (A^{vi1/2}-3).

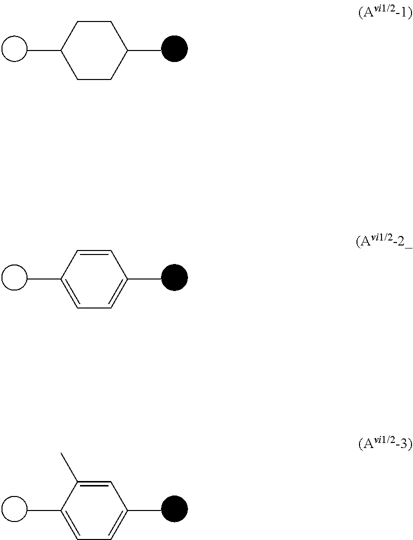

In formulas (A^{vi1/1}-1) to (A^{vi1/2}-3), each open circle represents a bond to R^{vi1} or Z^{vi1}, and each solid circle represents a bond to Z^{vi1} or R^{vi2}.

In general formula (vi), Z^{vi1} represents a single bond or an alkylene group having 1 to 20 carbon atoms.

The alkylene group is a linear, branched, or cyclic alkylene group and is preferably a linear alkylene group.

The number of carbon atoms in the alkylene group is preferably 2 to 10 and preferably 2 to 6.

One or two or more —CH₂— groups in the alkylene group may each independently be replaced with —O—, —CH(CH₃)—, —CO— and/or —CF₂—.

One or two or more —CH₂—CH₂— groups in the alkylene group may each independently be replaced with —CH═CH—, —CF═CH—, —CH═CF—, —CF═CF—, —CH═C(CH₃)—, —C(CH₃)═CH—, —CH═N—, —N═CH—, —N═N— and/or —C≡C—.

When the alkylene group is substituted with a prescribed group, no oxygen atoms are bonded directly to each other.

Specific examples of the alkylene group having 1 to 20 carbon atoms (including the substituted groups) include groups represented by formulas (Z^{vi1}-1) to (Z^{vi1}-24).

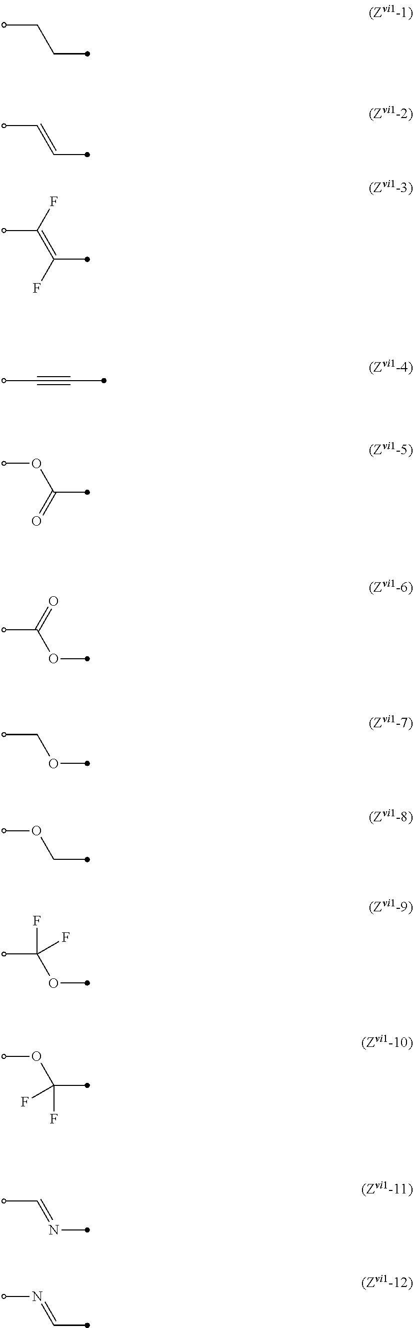

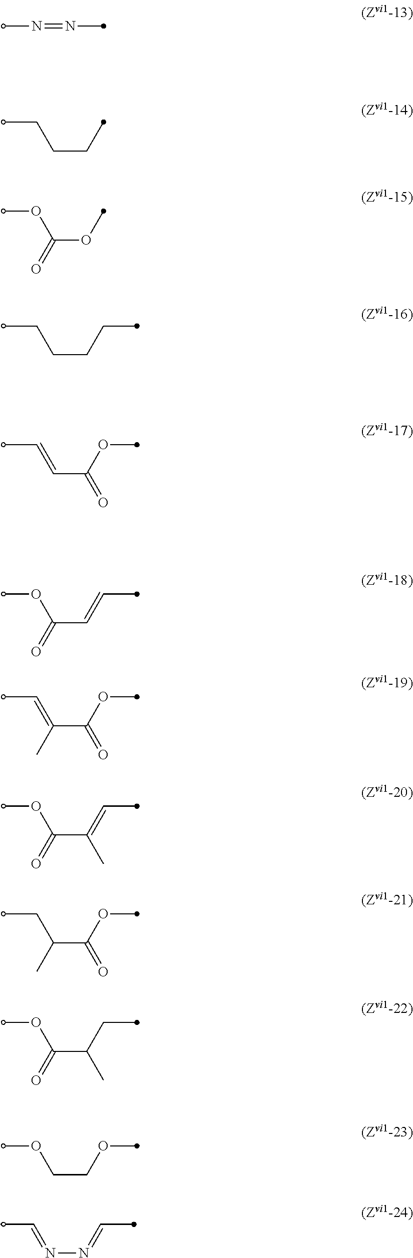

In formulas (Z^{vi1}-1) to (Z^{vi1}-24), each open circle represents a bond to A^{vi1} or A^{vi2}, and each solid circle represents a bond to A^{vi2}.

From the viewpoint of improving the solubility of the dye compound-containing liquid crystal composition and improving its light fastness, Z^{vi1} is preferably a single bond, —CO—O—, or —O—CO—.

n^{vi1} represents an integer of 1 to 3.

When a plurality of A^{vi2}s are present, they may be the same or different. When a plurality of Z^{vi1}s are present, they may be the same or different.

The compounds represented by general formulas (i) and (iv) (including their subordinate concepts) are excluded from the compound represented by general formula (vi).

The compound represented by general formula (vi) is preferably a compound represented by any of the following general formulas (vi-1) to (vi-3).

R^{vi1}-A^{vi1}-Z^{vi1}-A^{vi2}-R^{vi2} (vi-1)

R^{vi1}-A^{vi1}-Z^{vi1}-A^{vi2}-Z^{vi1-2}-A^{vi2-2}-R^{vi2} (vi-2)

R^{vi1}-A^{vi1}-Z^{vi1}-A^{vi2}-Z^{vi1-2}-A^{vi2-2}-Z^{vi1-3}-A^{vi2-3}-R^{vi2} (vi-3)

In general formulas (vi-1) to (vi-3), R^{vi1}, R^{vi2}, Z^{vi1}, A^{vi1}, and A^{vi2} have the same meanings as R^{vi1}, R^{vi2}, Z^{vi1}, A^{vi1}, and A^{vi2}, respectively, in general formula (vi) above, and their preferred examples are also the same as the groups exemplified for R^{vi1}, R^{vi2}, Z^{vi1}, A^{vi1}, and A^{vi2} in general formula (vi).

In general formulas (vi-1) to (vi-3), Z^{vi1}-2 and Z^{vi1}-3 each independently have the same meaning as Z^{vi1} in general formula (vi) above, and their preferred examples are also the same as the groups exemplified for Z^{vi1} in general formula (vi).

In general formulas (vi-1) to (vi-3), A^{vi2}-2 and A^{vi2}-3 each independently have the same meaning as A^{vi1} in general formula (vi) above, and their preferred examples are also the same as the groups exemplified for A^{vi1} in general formula (vi).

The compound represented by general formula (vi-1) is preferably a compound represented by any of the following general formulas (vi-1-1) to (vi-1-4).

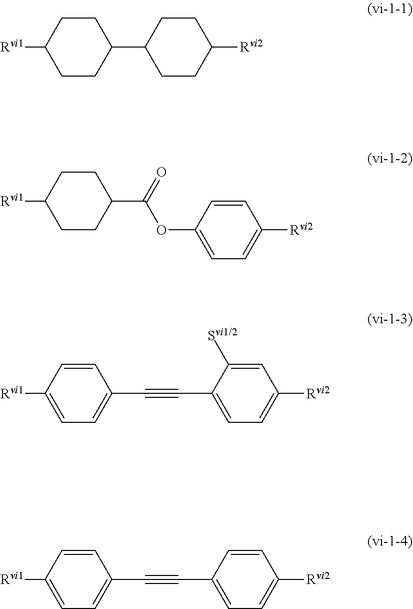

In general formulas (vi-1-1) to (vi-1-4), R^{vi1} and R^{vi2} have the same meanings as R^{vi1} and R^{vi2}, respectively, in general formula (v) above, and their preferred examples are also the same as the groups exemplified for R^{vi1} and R^{vi2} in general formula (v).

In general formulas (vi-1-1) to (vi-1-4), S^{vi1/2} represents an alkyl group having 1 to 6 carbon atoms.

The alkyl group having 1 to 6 carbon atoms is preferably a methyl group, an ethyl group, or a n-propyl group.

The compound represented by general formula (vi-1-1) is preferably a compound represented by any of the following structural formulas (vi-1-1.1) to (vi-1-1.8).

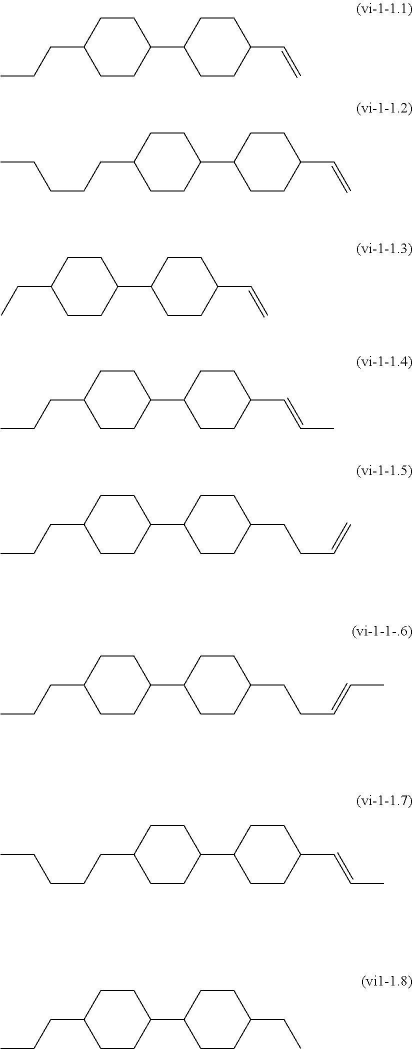

The compound represented by general formula (vi-1-2) is preferably a compound represented by any of the following structural formulas (vi-1-2.1) to (vi-1-2.5).

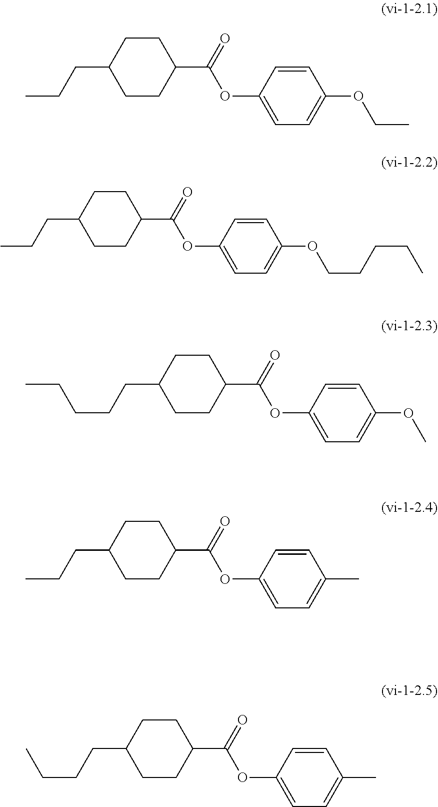

The compound represented by general formula (vi-1-3) is preferably a compound represented by the following structural formula (vi-1-3.1).

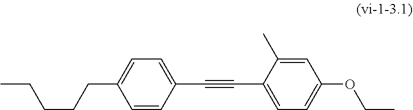

The compound represented by general formula (vi-1-4) is preferably a compound represented by any of the following structural formulas (vi-1-4.1) to (vi-1-4.2).

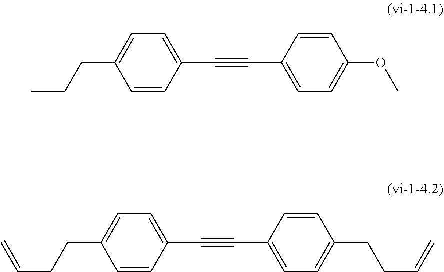

The compound represented by general formula (vi-28 is preferably a compound represented by any of the following general formulas (vi-2-1) to (vi-2-8).

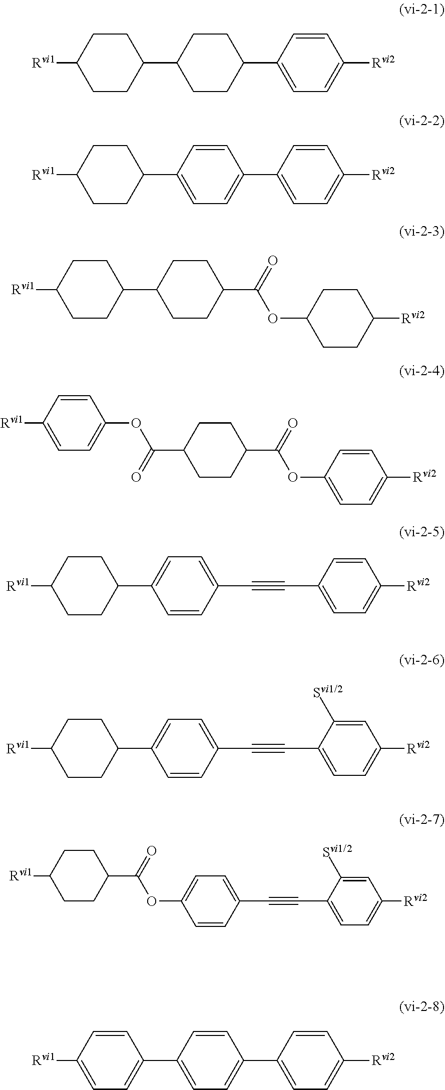

In general formulas (vi-2-1) to (vi-2-8), R^{vi1} and R^{vi2} have the same meanings as R^{vi1} and R^{vi2}, respectively, in general formula (vi) above, and their preferred examples are also the same as the groups exemplified for R^{vi1} and R^{vi2} in general formula (vi).

In general formulas (vi-2-1) to (vi-2-8), S^{vi1/2} represents an alkyl group having 1 to 6 carbon atoms.

The alkyl group having 1 to 6 carbon atoms is preferably a methyl group, an ethyl group, or a n-propyl group.

The compound represented by general formula (vi-2-1) is preferably a compound represented by any of the following structural formulas (vi-2-1.1) to (vi-2-1.4).

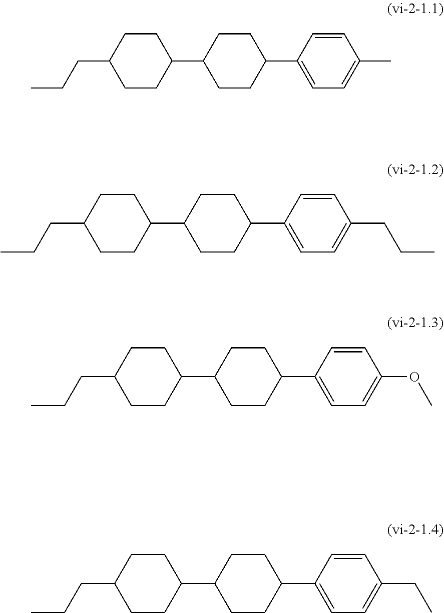

The compound represented by general formula (vi-2-2) is preferably a compound represented by any of the following structural formulas (vi-2-2.1) to (vi-2-2.5).

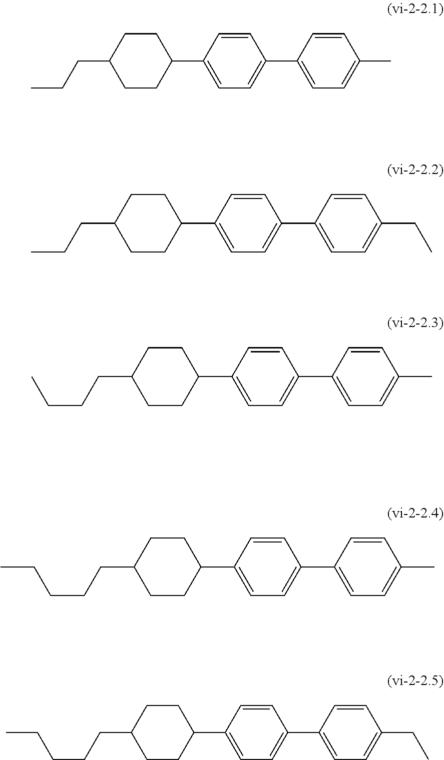

The compound represented by general formula (vi-2-3) is preferably a compound represented by any of the following structural formulas (vi-2-3.1) to (vi-2-3.3).

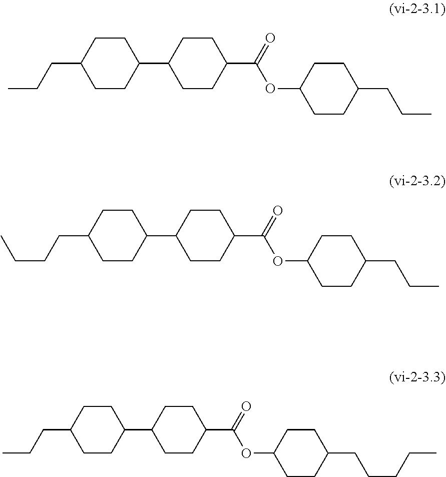

The compound represented by general formula (vi-2-4) is preferably a compound represented by any of the following structural formulas (vi-2-4.1) to (vi-2-4.2).

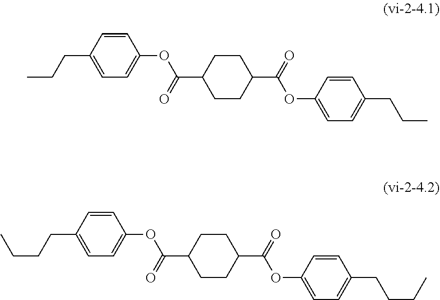

The compound represented by general formula (vi-2-5) is preferably a compound represented by the following structural formula (vi-2-5.1).

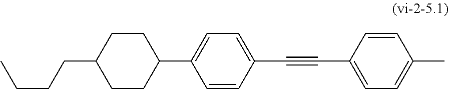

The compound represented by general formula (vi-2-6) is preferably a compound represented by the following structural formula (vi-2-6.1).

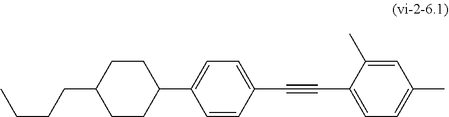

The compound represented by general formula (vi-2-7) is preferably a compound represented by the following structural formula (vi-2-7.1).

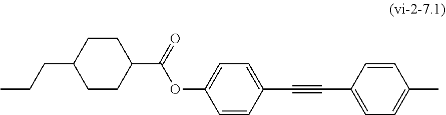

The compound represented by general formula (vi-2-8) is preferably a compound represented by any of the following structural formulas (vi-2-8.1) to (vi-2-8.2).

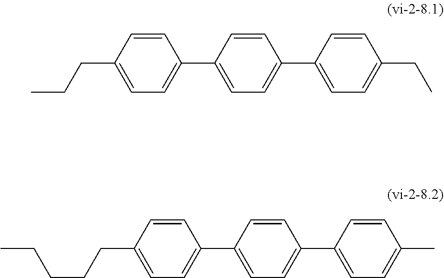

The compound represented by general formula (vi-3) is preferably a compound represented by any of the following general formulas (vi-3-1) to (vi-3-2).

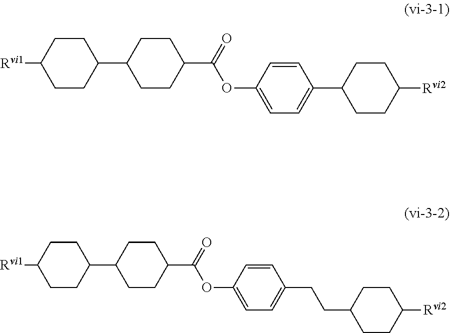

In general formulas (vi-3-1) to (vi-3-2), R^{vi1} and R^{vi2} have the same meanings as R^{vi1} and R^{vi2}, respectively, in general formula (v) above, and their preferred examples are also the same as the groups exemplified for R^{vi1} and R^{vi2} in general formula (v).

The compound represented by general formula (vi-3-1) is preferably a compound represented by any of the following structural formulas (vi-3-1.1) to (vi-3-1.3).

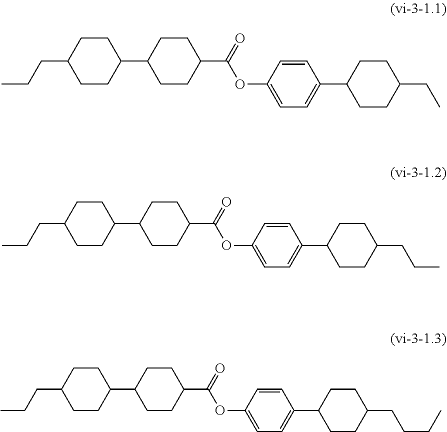

The compound represented by general formula (vi-3-2) is preferably a compound represented by any of the following structural formulas (vi-3-2.1) to (vi-3-2.2).

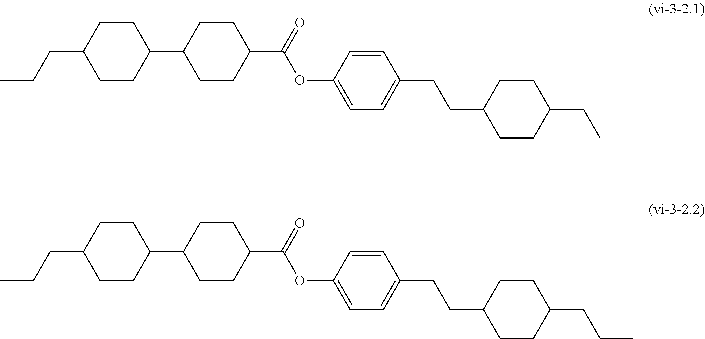

The number of compounds represented by general formula (vi), general formulas (vi-1) to (vi-3), general formulas (vi-1-1) to (vi-1-4), general formulas (vi-2-1) to (vi-2-8), general formulas (vi-3-1) to (vi-3-2), structural formulas (vi-1-1.1) to (vi-1-1.8), structural formulas (vi-1-2.1) to (vi-1-2.5), structural formula (vi-1-3.1), structural formulas (vi-1-4.1) to (vi-1-4.2), structural formulas (vi-2-1.1) to (vi-2-1.4), structural formulas (vi-2-2.1) to (vi-2-2.5), structural formulas (vi-2-3.1) to (vi-2-3.3), structural formulas (vi-2-4.1) to (vi-2-4.2), structural formula (vi-2-5.1), structural formula (vi-2-6.1), structural formula (vi-2-7.1), structural formulas (vi-2-8.1) to (vi-2-8.2), structural formulas (vi-3-1.1) to (vi-3-1.3), and structural formulas (vi-3-2.1) to (vi-3-2.2) that are used for the liquid crystal composition is one or two or more and is preferably one to five, preferably one to four, preferably one to three, and preferably one to two.

The lower limit of the total content of the compounds represented by general formula (vi), general formulas (vi-1) to (vi-3), general formulas (vi-1-1) to (vi-1-4), general formulas (vi-2-1) to (vi-2-8), general formulas (vi-3-1) to (vi-3-2), structural formulas (vi-1-1.1) to (vi-1-1.8), structural formulas (vi-1-2.1) to (vi-1-2.5), structural formula (vi-1-3.1), structural formulas (vi-1-4.1) to (vi-1-4.2), structural formulas (vi-2-1.1) to (vi-2-1.4), structural formulas (vi-2-2.1) to (vi-2-2.5), structural formulas (vi-2-3.1) to (vi-2-3.3), structural formulas (vi-2-4.1) to (vi-2-4.2), structural formula (vi-2-5.1), structural formula (vi-2-6.1), structural formula (vi-2-7.1), structural formulas (vi-2-8.1) to (vi-2-8.2), structural formulas (vi-3-1.1) to (vi-3-1.3), and structural formulas (vi-3-2.1) to (vi-3-2.2) based on 100% by mass of the liquid crystal composition is preferably 1% by mass or more, preferably 3% by mass or more, and preferably 5% by mass or more.

The upper limit of the total content of the compounds represented by general formula (vi), general formulas (vi-1) to (vi-3), general formulas (vi-1-1) to (vi-1-4), general formulas (vi-2-1) to (vi-2-8), general formulas (vi-3-1) to (vi-3-2), structural formulas (vi-1-1.1) to (vi-1-1.8), structural formulas (vi-1-2.1) to (vi-1-2.5), structural formula (vi-1-3.1), structural formulas (vi-1-4.1) to (vi-1-4.2), structural formulas (vi-2-1.1) to (vi-2-1.4), structural formulas (vi-2-2.1) to (vi-2-2.5), structural formulas (vi-2-3.1) to (vi-2-3.3), structural formulas (vi-2-4.1) to (vi-2-4.2), structural formula (vi-2-5.1), structural formula (vi-2-6.1), structural formula (vi-2-7.1), structural formulas (vi-2-8.1) to (vi-2-8.2), structural formulas (vi-3-1.1) to (vi-3-1.3), and structural formulas (vi-3-2.1) to (vi-3-2.2) based on 100% by mass of the liquid crystal composition is preferably 50% by mass or less, preferably 45% by mass or less, and preferably 40% by mass or less.

The total content of the compounds represented by general formula (vi), general formulas (vi-1) to (vi-3), general formulas (vi-1-1) to (vi-1-4), general formulas (vi-2-1) to (vi-2-8), general formulas (vi-3-1) to (vi-3-2), structural formulas (vi-1-1.1) to (vi-1-1.8), structural formulas (vi-1-2.1) to (vi-1-2.5), structural formula (vi-1-3.1), structural formulas (vi-1-4.1) to (vi-1-4.2), structural formulas (vi-2-1.1) to (vi-2-1.4), structural formulas (vi-2-2.1) to (vi-2-2.5), structural formulas (vi-2-3.1) to (vi-2-3.3), structural formulas (vi-2-4.1) to (vi-2-4.2), structural formula (vi-2-5.1), structural formula (vi-2-6.1), structural formula (vi-2-7.1), structural formulas (vi-2-8.1) to (vi-2-8.2), structural formulas (vi-3-1.1) to (vi-3-1.3), and structural formulas (vi-3-2.1) to (vi-3-2.2) based on 100% by mass of the liquid crystal composition is preferably 1 to 50% by mass, preferably 3 to 45% by mass, and preferably 5 to 40% by mass.

The compounds represented by general formula (vi), general formulas (vi-1) to (vi-3), general formulas (vi-1-1) to (vi-1-4), general formulas (vi-2-1) to (vi-2-8), general formulas (vi-3-1) to (vi-3-2), structural formulas (vi-1-1.1) to (vi-1-1.8), structural formulas (vi-1-2.1) to (vi-1-2.5), structural formula (vi-1-3.1), structural formulas (vi-1-4.1) to (vi-1-4.2), structural formulas (vi-2-1.1) to (vi-2-1.4), structural formulas (vi-2-2.1) to (vi-2-2.5), structural formulas (vi-2-3.1) to (vi-2-3.3), structural formulas (vi-2-4.1) to (vi-2-4.2), structural formula (vi-2-5.1), structural formula (vi-2-6.1), structural formula (vi-2-7.1), structural formulas (vi-2-8.1) to (vi-2-8.2), structural formulas (vi-3-1.1) to (vi-3-1.3), and structural formulas (vi-3-2.1) to (vi-3-2.2) can each be synthesized using a well-known synthesis method.

### (Dye Compound)

The liquid crystal composition in the invention contains one or two or more dye compounds.

Each dye compound has maximum absorption at preferably 350 to 700 nm and more preferably 400 to 650 nm.

The maximum absorption wavelength of a dye compound is measured using the following method.

First, 1.0 part by mass of the dye compound is added to and dissolved in 100 parts by mass of a liquid crystal composition capable of dissolving the dye compound to prepare a specimen.

Next, two 2 cm×2 cm glass substrates including respective ITO electrodes (the pair of electrodes 32 and 34) and horizontal alignment films disposed on the respective ITO electrodes are used to produce a cell having an injection port and including plastic particles used to adjust the cell thickness to 10 μm with the ITO electrode layers disposed on the inner side of the cell.

The specimen is injected into the cell, and the injection port is sealed with a sealing material to thereby produce a device.

Next, a spectrum meter (“LCD-5200” manufactured by Otsuka Electronics Co., Ltd.) and the produced device are used to measure the absorption spectrum in the range of 350 to 750 nm at 25° C. with no voltage applied, and the maximum absorption wavelength of the dye compound can thereby be determined.

When a plurality of dye compounds are used, it is preferable that the plurality of dye compounds have mutually different absorption wavelengths, and this allows a desired color such as a black color can be obtained.

Preferably, the dye compound is a dichroic dye.

Preferably, the dye compound is selected from the group consisting of azo-based compounds, anthraquinone-based compounds, methine-based compounds, azomethine-based compounds, merocyanine-based compounds, quinone-based compounds, naphthoquinone-based compounds, tetrazine-based compounds, perylene-based compounds, terrylene-based compounds, quaterrylene-based compounds, higher rylene-based compounds, indigo-based compounds, dioxazine-based compounds, azulene-based compounds, pyrromethene-based compounds, spiropyran-based compounds, and diarylethene-based compounds.

Examples of the azo-based compounds include disazo-based compounds and trisazo-based compounds.

Specific examples of the dye compound include SI-486 (yellow, dichroic dye, azo-based compound), SI-426 (red, dichroic dye, azo-based compound), G-472 (blue, dichroic dye, azo-based compound), M-483 (dichroic dye, blue), and M-412 (dichroic dye, blue).

The number of dye compounds used for the dye compound-containing liquid crystal composition is one or two or more and is preferably one to five, preferably one to four, and preferably one to three.

The lower limit of the total content of the dye compounds based on 100% by mass of the dye compound-containing liquid crystal composition is preferably 0.1% by mass or more, preferably 0.5% by mass or more, and preferably 1% by mass or more.

The upper limit of the total content of the dye compounds based on 100% by mass of the dye compound-containing liquid crystal composition is preferably 20% by mass or less, preferably 15% by mass or less, and preferably 10% by mass or less.

The total content of the dye compounds based on 100% by mass of the dye compound-containing liquid crystal composition is preferably 0.1 to 20% by mass, preferably 0.5 to 15% by mass, and preferably 1 to 10% by mass.

The lower limit of the amount of the dye compounds added based on 100 parts by mass of the liquid crystal composition containing no dye compounds and no additives is preferably 0.1 parts by mass or more, preferably 0.5 parts by mass or more, and preferably 1 part by mass or more.

The upper limit of the amount of the dye compounds added based on 100 parts by mass of the liquid crystal composition containing no dye compounds and no additives is preferably 20 parts by mass or less, preferably 15 parts by mass or less, and preferably 10 parts by mass or less.

The amount of the dye compounds added based on 100 parts by mass of the liquid crystal composition containing no dye compounds and no additives is preferably 0.1 to 20 parts by mass, preferably 0.5 to 15 parts by mass, and preferably 1 to 10 parts by mass.

### (Dye Compound-Containing Liquid Crystal Composition)

The dye compound-containing liquid crystal composition in the invention can be produced, for example, by mixing any of the compounds represented by the above-described general formulas (i) to (ii), a dye compound, any of the above-described additional compounds, and additives.

More specifically, the dye compound-containing liquid crystal composition can be produced through: the step of mixing any of the compounds represented by the above-described general formulas (i) to (ii) and any of the above-described additional compounds to obtain a liquid crystal composition used for the dye compound-containing liquid crystal composition; and the step of mixing a dye compound and an optional additive with the liquid crystal composition used for the dye compound-containing liquid crystal composition.

Alternatively, the dye compound-containing liquid crystal composition can be produced through the step of mixing a liquid crystal compound for a liquid crystal composition used for the dye compound-containing liquid crystal composition, a dye compound, and an optional additive in any order.

Examples of the additive include a stabilizer, a chiral agent, an antistatic agent, nematic liquid crystals, smectic liquid crystals, cholesteric liquid crystals, a chiral agent, and polymerizable compounds.

Examples of the stabilizer include an antioxidant, an ultraviolet (UV) absorber, a light stabilizer, and an infrared absorber.

Examples of the antioxidant include hydroquinone derivatives, nitrosoamine-based polymerization inhibitors, and hindered phenol-based antioxidants.

More specific examples include: tert-butylhydroquinone; methylhydroquinone; “Q-1300” and “Q-1301” manufactured by Wako Pure Chemical Industries, Ltd.; and “IRGANOX 1010,” “IRGANOX 1035,” “IRGANOX 1076,” “IRGANOX 1098,” “IRGANOX 1135,” “IRGANOX 1330,” “IRGANOX 1425,” “IRGANOX 1520,” “IRGANOX 1726,” “IRGANOX 245,” “IRGANOX 259,” “IRGANOX 3114,” “IRGANOX 3790,” “IRGANOX 5057,” and “IRGANOX 565” manufactured by BASF.

Preferably, the ultraviolet (UV) absorber has high absorption ability for UV light with a wavelength of 370 nm or shorter and absorbs less visible light with a wavelength of 400 nm or longer, from the viewpoint of good liquid crystal display ability.

More specific examples include hindered phenol-based compounds, benzotriazole-based compounds, hydroxybenzophenone-based compounds, salicylate-based compounds, benzophenone-based compounds, cyanoacrylate-based compounds, nickel complex salt-based compounds, and triazine-based compounds.

Examples of the hindered phenol-based compounds include 2,6-di-tert-butyl-p-cresol, pentaerythrityl-tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, and tris-(3,5-di-tert-butyl-4-hydroxybenzyl)-isocyanurate.

Examples of the benzotriazole-based compounds include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, (2-(2′-hydroxy-3′,5-di-tert-amylphenyl)-5-chlorobenzotriazole, 2,6-di-tert-butyl-p-cresol, and pentaerythrityl-tetrakis[3-(3,5-di-tert-butyl-4-hydroxyphenyl)propionate].

More specific examples include: “TINUVIN 109,” “TINUVIN 171,” “TINUVIN 326,” “TINUVIN 327,” “TINUVIN 328,” “TINUVIN 770,” “TINUVIN 900,” and “TINUVIN 928” manufactured by BASF Japan Ltd.; and “KEMISORB 71,” “KEMISORB 73,” and “KEMISORB 74” manufactured by Chemipro Kasei Kaisha, Ltd.

The number of stabilizers used for the dye compound-containing liquid crystal composition is one or two or more and is preferably one to five, preferably one to four, preferably one to three, and preferably one to two.

When the stabilizers are used, the lower limit of the total content of the stabilizers based on 100% by mass of the dye compound-containing liquid crystal composition is preferably 0.01% by mass or more, preferably 0.05% by mass or more, and preferably 0.1% by mass or more.

When the stabilizers are used, the upper limit of the total content of the stabilizers based on 100% by mass of the dye compound-containing liquid crystal composition is preferably 2.0% by mass or less, preferably 1.5% by mass or less, and preferably 1.0% by mass or less.

When the stabilizers are used, the total content of the stabilizers based on 100% by mass of the dye compound-containing liquid crystal composition is preferably 0.01 to 2.0% by mass, preferably 0.05 to 1.5% by mass, and preferably 0.1 to 1.0% by mass.

When the stabilizers are used, the lower limit of the amount of the stabilizers added based on 100 parts by mass of the liquid crystal composition containing no dye compounds and no additives is preferably 0.01 parts by mass or more, preferably 0.05 parts by mass or more, and preferably 0.1 parts by mass or more.

When the stabilizers are used, the upper limit of the amount of the stabilizers added based on 100 parts by mass of the liquid crystal composition containing no dye compounds and no additives is preferably 2.0 parts by mass or less, preferably 1.5 parts by mass or less, and preferably 1.0 parts by mass or less.

When the stabilizers are used, the amount of the stabilizers added based on 100 parts by mass of the liquid crystal composition containing no dye compounds and no additives is preferably 0.01 to 2.0 parts by mass, preferably 0.05 to 1.5 parts by mass, and preferably 0.1 to 1.0 parts by mass.

When a chiral agent is used for the dye compound-containing liquid crystal composition, twists can be induced in the liquid crystal.

The chiral agent may be a right-handed chiral agent or a left-handed chiral agent, and a suitable chiral agent may be used according to the structure of the device.

The chiral agent used may be a chiral agent used for a TN mode or an STN mode.

The chiral agent may be, for example, “Chiral S-811 (a compound represented by the following structural formula (CA-1)).”

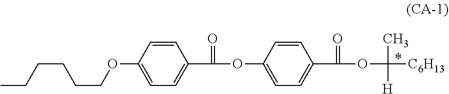

In structural formula (CA-1), “*” represents the asymmetric center.

The number of chiral agents used for the dye compound-containing liquid crystal composition is one or two or more and is preferably one to five, preferably one to four, preferably one to three, preferably one to two, and preferably one.

When one or more chiral agents are used, the lower limit of the amount of the stabilizers based on 100% by mass of the dye compound-containing liquid crystal composition is preferably 0.05% by mass or more, preferably 0.1% by mass or more, preferably 0.3% by mass or more, and preferably 0.5% by mass or more.

When one or more chiral agents are used, the upper limit of the amount of the stabilizers based on 100% by mass of the dye compound-containing liquid crystal composition is preferably 5% by mass or less, preferably 3.0% by mass or less, preferably 2.0% by mass or less, and preferably 1.5% by mass or less.

When one or more chiral agents are used, the total content of the stabilizers based on 100% by mass of the dye compound-containing liquid crystal composition is preferably 0.05 to 5% by mass, preferably 0.1 to 3.0% by mass, preferably 0.3 to 2.0% by mass, and preferably 0.5 to 1.5% by mass.

When one or more chiral agents are used, the lower limit of the amount of the one or more chiral agents added based on 100 parts by mass of the liquid crystal composition containing no dye compounds and no additives is preferably 0.05 parts by mass or more, preferably 0.1 parts by mass or more, preferably 0.3 parts by mass or more, and preferably 0.5% by mass or more.

When one or more chiral agents are used, the upper limit of the amount of the one or more chiral agents added based on 100 parts by mass of the liquid crystal composition containing no dye compounds and no additives is preferably 5 parts by mass or less, preferably 3.0 parts by mass or less, preferably 2.0 parts by mass or less, and preferably 1.5 parts by mass or less.

When one or more chiral agents are used, the amount of the one or more chiral agents added based on 100 parts by mass of the liquid crystal composition containing no dye compounds and no additives is 0.05 to 5 parts by mass, preferably 0.1 to 3.0 parts by mass, preferably 0.3 to 2.0 parts by mass, and preferably 0.5 to 1.5 parts by mass.

From the viewpoint of allowing the dye compound-containing liquid crystal composition to have high light fastness and high solubility simultaneously, the content of the compound represented by general formula (i) and/or the compound represented by general formula (ii) is preferably 10% by mass or more and preferably 10 to 20% by mass.

The above relation for the content is applicable to any subordinate concept of the compound represented by general formula (i) and/or any subordinate concept of the compound represented by general formula (ii) and is also applicable to any combination of the compound represented by general formula (i) and its subordinate concepts and/or the compound represented by general formula (ii) and its subordinate concepts.

When the compound represented by general formula (iii) is used, the total content of the compound represented by general formula (i), the compound represented by general formula (ii), and the compound represented by general formula (iii) based on 100% by mass of the dye compound-containing liquid crystal composition is preferably 20% by mass or more, preferably 25 to 65% by mass, preferably 30 to 60% by mass, and preferably 35 to 55% by mass, from the viewpoint of allowing the dye compound-containing liquid crystal composition to have high light fastness and high solubility simultaneously.

The above relation for the content is applicable to any subordinate concept of the compound represented by general formula (i), any subordinate concept of the compound represented by general formula (ii), and/or any subordinate concept of the compound represented by general formula (iii) and is also applicable to any combination of the compound represented by general formula (i) and its subordinate concepts, the compound represented by general formula (ii) and its subordinate concepts, and/or the compound represented by general formula (iii) and its subordinate concepts.

When the compound represented by general formula (iv) is used, the total content of the compound represented by general formula (i), the compound represented by general formula (ii), and the compound represented by general formula (iv) based on 100% by mass of the dye compound-containing liquid crystal composition is preferably 20% by mass or more, preferably 25 to 75% by mass, preferably 30 to 70% by mass, and preferably 35 to 65% by mass, from the viewpoint of allowing the dye compound-containing liquid crystal composition to have high light fastness and high solubility simultaneously.

The above relation for the content is applicable to any subordinate concept of the compound represented by general formula (i), any subordinate concept of the compound represented by general formula (ii), and/or any subordinate concept of the compound represented by general formula (iv) and is also applicable to any combination of the compound represented by general formula (i) and its subordinate concepts, the compound represented by general formula (ii) and its subordinate concepts, and/or the compound represented by general formula (iv) and its subordinate concepts.

A liquid crystal phase upper limit temperature (TNI) of a liquid crystal composition is the temperature at which the liquid crystal composition undergoes phase transition from a nematic phase to an isotropic phase.

The higher the liquid crystal phase upper limit temperature (TNI) of the liquid crystal composition used for the dye compound-containing liquid crystal composition in the invention, the higher the temperature at which the nematic phase can be maintained, and the wider the driving temperature range. Therefore, the TNI is preferably 95° C. or higher, preferably 100 to 150° C., and preferably 100 to 130° C.

A liquid crystal phase lower limit temperature (T→N) of a liquid crystal composition is the temperature at which the liquid crystal composition undergoes phase transition to the nematic phase from a different phase (glass, a smectic phase, or a crystalline phase).

The lower the liquid crystal phase lower limit temperature (T→N) of the liquid crystal composition used for the dye compound-containing liquid crystal composition in the invention, the lower the temperature at which the nematic phase can be maintained, and the wider the driving temperature range. Therefore, the T→N is preferably −15° C. or lower, preferably −78 to −20° C., and preferably −65 to −25° C.

The refractive index anisotropy (Δn) of the liquid crystal composition used for the dye compound-containing liquid crystal composition in the invention at 25° C. and 589 nm is preferably 0.05 or more, preferably 0.06 to 0.20, preferably 0.07 to 0.15, and preferably 0.08 to 0.13.

The refractive index (ne), in the major axis direction of the liquid crystal molecules, of the liquid crystal composition used for the dye compound-containing liquid crystal composition in the invention at 25° C. and 589 nm is preferably 1.4 or more, preferably 1.45 to 1.65, and preferably 1.50 to 1.63.

The refractive index (no), in the minor axis direction of the liquid crystal molecules, of the liquid crystal composition used for the dye compound-containing liquid crystal composition in the invention at 25° C. and 589 nm is preferably 1.3 or more, preferably 1.35 to 1.55, and preferably 1.40 to 1.53.

The ne and no of the liquid crystal composition used for the dye compound-containing liquid crystal composition can be measured using an Abbe refractometer, and its an can be computed from the ne and no.

The dielectric anisotropy (Δε) of the liquid crystal composition used for the dye compound-containing liquid crystal composition in the invention at 25° C. is preferably positive (2≤Δε).

More specifically, the dielectric anisotropy (Δε) of the liquid crystal composition used for the dye compound-containing liquid crystal composition in the invention at 25° C. is preferably 2.0 to 20.0, preferably 2.5 to 15.0, preferably 3.0 to 10.0, preferably 3.5 to 7.0, and preferably 4.0 to 6.0.

The dielectric constant (ε//), in the major axis direction of the liquid crystal molecules, of the liquid crystal composition used for the dye compound-containing liquid crystal composition in the invention at 25° C. is preferably 5.0 or more, preferably 5.5 to 30.0, preferably 6.0 to 20.0, preferably 6.0 to 15.0, and preferably 6.5 to 10.0.

The dielectric constant (ε⊥), in the minor axis direction of the liquid crystal molecules, of the liquid crystal composition used for the dye compound-containing liquid crystal composition in the invention at 25° C. is preferably 1.5 or more, preferably 2.0 to 7.0, preferably 2.5 to 5.0, and preferably 2.5 to 4.0.

The rotational viscosity (γ1) of the liquid crystal composition used for the dye compound-containing liquid crystal composition in the invention at 25° C. is preferably 100 to 180 mPa·s, preferably 105 to 175 mPa·s, preferably 110 to 170 mPa·s, and preferably 115 to 165 mPa·s.

The elastic constant K11 of the liquid crystal composition used for the dye compound-containing liquid crystal composition in the invention at 25° C. is preferably 1.0 to 30.0 pN, preferably 5.0 to 25.0 pN, and preferably 10.0 to 20.0 pN.

The elastic constant K22 of the liquid crystal composition used for the dye compound-containing liquid crystal composition in the invention at 25° C. is preferably 1.0 to 25.0 pN, preferably 3.0 to 20.0 pN, and preferably 5.0 to 15.0 pN.

The elastic constant K33 of the liquid crystal composition used for the dye compound-containing liquid crystal composition in the invention at 25° C. is preferably 1.0 to 35.0 pN, preferably 5.0 to 30.0 pN, and preferably 10.0 to 25.0 pN.

### (Device)

Next, a device (the liquid crystal panel 30) using the above-described dye compound-containing liquid crystal composition will be described.

The application of the device is preferably a light control device, as described above.

Preferably, the device has the following structure. A substrate including a first transparent electrode layer (32) and a substrate including a second transparent electrode layer (34) are disposed so as to face each other with the transparent electrode layers disposed on the inner side, and the above-described liquid crystal composition is held between the substrates.

The transparent electrode layers are preferably ITO electrodes.

As for the substrate including the first transparent electrode layer and/or the substrate including the second transparent electrode layer, an alignment film may be disposed on the transparent electrode layer.

The alignment film used is preferably a horizontal alignment film.

By adding a chiral agent to the dye compound-containing liquid crystal composition, the liquid crystal aligned can be twisted.

The twist of the liquid crystal molecules can also be adjusted by adjusting the angle of the alignment axis by changing the configuration of the substrate including the first transparent electrode layer and the substrate including the second transparent electrode layer.

Specifically, it is preferable that the relation d/p between the twist pitch (p (μm)) and the cell thickness (d (μm)) is controlled to an optimal value according to the twist angle.

The optimal d/p value means a range in which no alignment defects such as reverse twisted domains and stripe domains are formed.

Preferably, while the domains are observed visually or under a microscope, the d/p value is controlled such that no alignment defects occur.

The pretilt angle of the dye compound-containing liquid crystal composition in the device is preferably 0.1 to 10° and preferably 0.5 to 5°.

The pretilt angle can be measured using OPTIPRO manufactured by Shintech Inc.

The gap between the substrates (the cell thickness) is preferably 1 to 100 μm, preferably 1.5 to 30 μm, and preferably 5 to 20 μm.

The gap between the substrates may be adjusted using a spacer.

Examples of the spacer include glass particles, plastic particles, alumina particles, and photoresist materials.

From the viewpoint of preventing deterioration caused by UV light, the device in the invention may include a UV blocking film.

For example, an ultraviolet (UV) blocking film that blocks light with a wavelength of 400 nm or shorter may be stacked on the device or applied thereto.

One device in the invention may be used alone, or a stack of a plurality of the devices, e.g., two or three devices, may be used.

When a stack of a plurality of the devices is used, it is preferable, from the viewpoint of improving the contrast ratio, that the devices are subjected to antiparallel alignment treatment and stacked such that their alignment treatment directions are orthogonal to each other.

The device may be produced as follows.

For example, a sealing agent such as an epoxy-based thermosetting composition is applied to the substrate including the first transparent electrode layer such that an injection hole is formed. This substrate and the substrate including the second transparent electrode layer are laminated together and then heated to cure the sealing agent, and an empty cell can thereby be produced.

Then an ordinary vacuum injection method or an ODF method is used to cause the dye compound-containing liquid crystal composition to be held between the two substrates in the cell, and a liquid crystal device can thereby be produced.

To further improve the contrast ratio, an optical film having a polarization axis oriented at a prescribed angle may be disposed in the device.

### EXAMPLES

The present invention will be described in more detail by way of Examples. However, the invention is not limited to the following Examples.

Compositions in the following Examples and Comparative Examples contain respective compounds at ratios shown in tables, and each content is expressed in terms of “% by mass.”

The following abbreviations are used to describe compounds. For a compound that can assume cis and trans forms, the trans forms is shown unless otherwise specified.

### <Cyclic Structures>

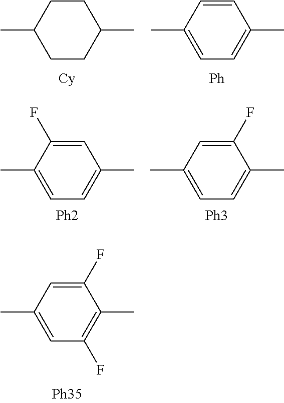

### <Terminal Structures>

TABLE 1

| Abbreviation | Chemical structure |
|---|---|
| -n | —CₙH₂ₙ₊₁ |
| n- | CₙH₂ₙ₊₁— |
| —On | —OCₙH₂ₙ₊₁ |
| nO— | CₙH₂ₙ₊₁O— |
| —F | —F |
| —CN | —CN |
| —V | —CH═CH₂ |
| V— | CH₂═CH— |
| —2V | —CH₂—CH₂—CH═CH₂ |
| V2— | CH₂═CH—CH₂—CH₂— |
| —V1 | —CH═CH—CH₃ |
| 1V— | CH₃—CH═CH— |

(n in the table is a natural number.)

### <Linkage Structures>

TABLE 2

| Abbreviation | Chemical structure |
|---|---|
| — | Single bond |
| -n- | —CₙH₂ₙ— |
| —E1— | —C(═O)—O— |
| —E2— | —O—C(═O)— |

### <Dye Compounds>

SI-426: Dichroic dye compound (azo-based) that develops a red color; maximum absorption wavelength: 414 nm
SI-486: Dichroic dye compound (azo-based) that develops a yellow color; maximum absorption wavelength: 513 nm
G-472: Dichroic dye compound (azo-based) that develops a blue color; maximum absorption wavelength: 636 nm

### <Antioxidant>

IRGANOX 1076: Hindered phenol-based antioxidant

### <Ultraviolet (UV) Absorber>

KEMISORB 71: Benzotriazole-based compound

### <Physical Properties of Liquid Crystal Compositions Used for Dye Compound-Containing Liquid Crystal Compositions>

The following physical properties of a liquid crystal composition used for a dye compound-containing liquid crystal composition were measured.

TNI (° C.): Temperature at which the liquid crystal composition undergoes transition from a nematic phase to an isotropic phase (upper limit temperature).

T→N (° C.): Temperature at which the liquid crystal composition undergoes transition to the nematic phase from a different phase (lower limit temperature).

Δn: Refractive index anisotropy of the liquid crystal composition at 25° C. and 589 nm.

ne: Refractive index of the liquid crystal composition in the major axis direction of the liquid crystal molecules at 25° C. and 589 nm.

no: Refractive index of the liquid crystal composition in the minor axis direction of the liquid crystal molecules at 25° C. and 589 nm.

Δε: Dielectric anisotropy of the liquid crystal composition at 25° C.

ε//: Dielectric constant of the liquid crystal composition in the major axis direction of the liquid crystal molecules at 25° C.

ε⊥: Dielectric constant of the liquid crystal composition in the minor axis direction of the liquid crystal molecules at 25° C.

γ1 (mPa·s): Rotational viscosity at 25° C.

K11 (pN): Elastic constant K11 of the liquid crystal composition at 25° C.

K22 (pN): Elastic constant K22 of the liquid crystal composition at 25° C.

K33 (pN): Elastic constant K33 of the liquid crystal composition at 25° C.

### Examples 1 to 18 and Comparative Examples 1 to 2

### <Preparation of Liquid Crystal Compositions Used for Dye Compound-Containing Liquid Crystal Compositions>

Liquid crystal compounds were mixed at ratios shown in Table 3 to prepare liquid crystal compositions LC-1 to LC-11 used for dye compound-containing liquid crystal compositions, and the physical properties of the liquid crystal compositions were measured. The results are shown in Table 4.

TABLE 3

| Liquid crystal | | | | | | | | | | | |
|---|---|---|---|---|---|---|---|---|---|---|---|
| compound | LC-1 | LC-2 | LC-3 | LC-4 | LC-5 | LC-6 | LC-7 | LC-8 | LC-9 | LC-10 | LC-11 |
| V2-Cy-Cy-Ph-1 | | | | 15 | | | | | | | |
| V-Cy-Cy-Ph-1 | 15 | 15 | 20 | | 15 | 15 | 15 | 15 | 15 | 15 | |
| 3-Cy-Cy-Ph3—F | 14 | 14 | 15 | 14 | 14 | | 10 | 14 | 14 | | 14 |
| V-Cy-Cy-Ph3—F | | | | | | | 4 | | | | |
| V2-Cy-Cy-Ph3—F | | | | | | 14 | | | | | |
| 3-Cy-Ph—Ph35—F | 15 | 15 | 15 | 12 | | 15 | 15 | | 15 | 15 | 15 |
| 2-Ph—Ph3—Ph35—F | 8 | | 5 | 11 | 8 | 8 | 8 | | 8 | 8 | 8 |
| 3-Cy-Ph—Ph35—F | | | | | 15 | | | | | | |
| 3-Cy-Ph—O1 | | 15 | 16 | 12 | | | | | | | |
| 3-Cy-Ph—O2 | 12 | 12 | 16 | | 12 | 12 | 12 | 12 | | 12 | 12 |
| 3-Cy-Ph35—CN | | | | | | | | 10 | | | |
| 5-Cy-E1-Ph3—F | | 8 | | | | | | | | | |
| 3-Cy-Cy-E1-Ph3—F | 5 | 5 | | 5 | 5 | 5 | | 5 | 5 | 5 | 5 |
| 3-Cy-2-Cy-E1-Ph3—F | | | | | | | | 7 | | 5 | |
| 4-Cy-2-Cy-E1-Ph3—F | | | | | | | | 6 | | 5 | |
| 2-Cy-Cy-Ph—Ph3—F | 4 | 4 | | 4 | 4 | 4 | 4 | 4 | 4 | 4 | 4 |
| 3-Cy-Cy-Ph—Ph3—F | 4 | 4 | | 4 | 4 | 4 | 4 | 4 | 4 | 4 | 4 |
| 3-Cy-Cy-V | 15 | | | | 15 | 15 | | 15 | 27 | 15 | 15 |
| 3-Cy-Cy-Ph-1 | | | | | | | 5 | | | 4 | |
| 3-Cy-Cy-Ph-3 | | | | | | | | | | | 7 |
| 3-Cy-Ph—Ph-1 | | | 5 | | | | | | | | 8 |
| 3-Cy-Cy-E1-Ph-Cy-2 | 4 | 4 | 4 | 4 | 4 | 4 | 4 | 4 | 4 | 4 | 4 |
| 3-Cy-Cy-E1-Ph-Cy-4 | 4 | 4 | 4 | 4 | 4 | 4 | 4 | 4 | 4 | 4 | 4 |
| 3-Cy-Cy-2 | | | | 15 | | | | | | | |
| 3-Cy-Cy-V1 | | | | | | | 15 | | | | |
| Total (% by mass) | 100 | 100 | 100 | 100 | 100 | 100 | 100 | 100 | 100 | 100 | 100 |

TABLE 4

| Physical | | | | | | | | | | | |
|---|---|---|---|---|---|---|---|---|---|---|---|
| properties | LC-1 | LC-2 | LC-3 | LC-4 | LC-5 | LC-6 | LC-7 | LC-8 | LC-9 | LC-10 | LC-11 |
| T_{NI} (° C.) | 118.4 | 1064 | 103.0 | 111.5 | 114.8 | 118.7 | 127.8 | 116.0 | 121.7 | 122.4 | 118.3 |
| T_{→N} (° C.) | G-49 | G-55 | G-54 | G-53 | G-55 | G-51 | G-41 | G-51 | G-49 | G-51 | G-40 |
| Δₙ | 0.110 | 0.102 | 0.111 | 0.108 | 0.107 | 0.110 | 0.114 | 0.090 | 0.104 | 0.109 | 0.115 |
| nₑ | 1.602 | 1.594 | 1.610 | 1.604 | 1.601 | 1.606 | 1.610 | 1.579 | 1.597 | 1.604 | 1.611 |
| nₒ | 1.492 | 1.492 | 1.499 | 1.496 | 1.494 | 1.496 | 1.496 | 1.489 | 1.493 | 1.495 | 1.496 |
| Δε | 4.9 | 3.8 | 3.4 | 4.9 | 5.3 | 4.7 | 4.6 | 5.4 | 4.9 | 4.7 | 4.9 |
| ε_{//} | 8.1 | 7.2 | 6.6 | 8.2 | 8.7 | 7.9 | 7.7 | 9.0 | 7.9 | 7.9 | 8.1 |
| ε_{⊥} | 3.2 | 3.4 | 3.2 | 3.3 | 3.4 | 3.2 | 3.0 | 3.7 | 3.0 | 3.2 | 3.2 |
| γ₁ (mPa · s) | 139 | 145 | 133 | 127 | 136 | 134 | 161 | 139 | 123 | 155 | 136 |
| K₁₁ (pN) | 14.7 | 12.9 | 14.1 | 13.3 | 13.8 | 14.6 | 17.3 | 13.6 | 14.5 | 15.7 | 15.6 |
| K₂₂ (pN) | 8.6 | 7.7 | 7.9 | 7.6 | 8.1 | 8.1 | 9.5 | 8.0 | 8.7 | 8.7 | 8.4 |
| K₃₃ (pN) | 19.5 | 18.0 | 17.2 | 16.8 | 18.9 | 19.6 | 21.4 | 19.4 | 19.6 | 19.6 | 17.7 |

### <Production of Devices>

Dye compounds, antioxidants, and a chiral agent were added to and dissolved in LC1 to 11 as shown in Tables 5 and 6 to prepare dye compound-containing liquid crystal compositions. Next, two 2 cm×2 cm glass substrates each including an ITO electrode and a horizontal alignment film (AL1051) disposed on the ITO electrode were used to produce a cell having an injection port. The ITO electrode layers were disposed on the inner side of the cell, and plastic particles were used to adjust the cell thickness to 10 μm. One of the dye compound-containing liquid crystal compositions was injected into the cell, and the injection port was sealed with a sealing material to thereby produce a device.

In Tables 5 and 6, the amounts of the dye compounds and the antioxidants (parts by mass) are amounts added based on 100 parts by mass of the liquid crystal composition.

TABLE 5

| | | Example | Example | Example | Example | Example | Example |
|---|---|---|---|---|---|---|---|
| | | 1 | 2 | 3 | 4 | 5 | 6 |
| Liquid crystal composition | | LC-1 | LC-2 | LC-3 | LC-4 | LC-5 | LC-6 |
| Dye | SI-426 | 1.0 | 1.0 | 1.0 | 1.0 | 1.0 | 1.0 |
| compound | SI-486 | 1.0 | 1.0 | 1.0 | 1.0 | 1.0 | 1.0 |
| | G-472 | 2.0 | 2.0 | 2.0 | 2.0 | 2.0 | 2.0 |

| | | Example | Example | Example | Example | Example |
|---|---|---|---|---|---|---|
| | | 7 | 8 | 9 | 19 | 20 |
| Liquid crystal composition | | LC-7 | LC-8 | LC-9 | LC-10 | LC-11 |
| Dye | SI-426 | 1.0 | 1.0 | 1.0 | 1.0 | 1.0 |
| compound | SI-486 | 1.0 | 1.0 | 1.0 | 1.0 | 1.0 |
| | G-472 | 2.0 | 2.0 | 2.0 | 2.0 | 2.0 |

TABLE 6

| | | Example | Example | Example | Example | Example | Example | Example | Example | Example |
|---|---|---|---|---|---|---|---|---|---|---|
| | | 10 | 11 | 12 | 13 | 14 | 15 | 16 | 17 | 18 |
| Liquid crystal composition | | LC-1 | LC-2 | LC-3 | LC-4 | LC-5 | LC-6 | LC-7 | LC-8 | LC-9 |
| Dye | SI-426 | 1.0 | 1.0 | 1.0 | 1.0 | 1.0 | 1.0 | 1.0 | 1.0 | 1.0 |
| compound | SI-486 | 1.0 | 1.0 | 1.0 | 1.0 | 1.0 | 1.0 | 1.0 | 1.0 | 1.0 |
| | G-472 | 2.0 | 2.0 | 2.0 | 2.0 | 2.0 | 2.0 | 2.0 | 2.0 | 2.0 |
| Antioxidant | IRGANOX1076 | 0.1 | 0.1 | 0.1 | 0.1 | 0.1 | 0.1 | 0.1 | 0.1 | 0.1 |
| | KEMISORB71 | 0.2 | 0.2 | 0.2 | 0.2 | 0.2 | 0.2 | 0.2 | 0.2 | 0.2 |

A chiral agent was added to the dye compound-containing liquid crystal compositions in Tables 5 and 6 to change d/p. The results are shown in FIG. 4. The amount of the chiral agent added (parts by mass) is the amount added based on 100 parts by mass of the dye compound-containing liquid crystal composition. The results shown in FIGS. 14 and 15 are test results for the test panels (liquid crystal panels) using the dye compound-containing liquid crystal compositions with d/p=3 and 4 in FIG. 4. It was found that the use of the light control method for the liquid crystal light control apparatus according to the techniques of the disclosure can improve the response of the apparatus.

For other host liquid crystals, test panels were produced under the same conditions, and the improvement in response was also found.

In connection with the foregoing disclosure, the following appendixes are proposed.

### (Appendix 1)

A dye compound-containing liquid crystal composition containing:

one or two or more compounds represented by the following general formula (i)

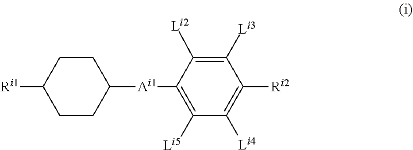

(wherein, in general formula (i),

Rⁱ¹ represents an alkenyl group having 2 to 20 carbon atoms,

one or two or more —CH₂— groups in the alkenyl group may each independently be replaced with —O— and/or —CO—,

one or two or more —CH₂—CH₂— groups in the alkenyl group may each independently be replaced with —CH═CH— and/or —C≡C—,

one or two or more hydrogen atoms in the alkenyl group may each independently be replaced with a halogen atom,

provided that no oxygen atoms are bonded directly to each other,

Rⁱ² represents an alkyl group having 1 to 20 carbon atoms,

one or two or more —CH₂— groups in the alkyl group may each independently be replaced with —O— and/or —CO—,

one or two or more —CH₂—CH₂— groups in the alkyl group may each independently be replaced with —CH═CH— and/or —C≡C—,

one or two or more hydrogen atoms in the alkyl group may each independently be replaced with a halogen atom,

provided that no oxygen atoms are bonded directly to each other,

Aⁱ¹ represents a group selected from the group consisting of groups (a) and (b):
(a) a 1,4-cyclohexylene group (one —CH₂— group or two or more non-adjacent —CH₂— groups present in this group may be replaced with —O— and/or —S—); and
(b) a 1,4-phenylene group (one —CH═ group or two or more non-adjacent —CH═ groups present in this group may be replaced with —N═),

one or two or more hydrogen atoms in Aⁱ¹ may each independently be replaced a with halogen atom, and

Lⁱ², Lⁱ³, Lⁱ⁴, and Lⁱ⁵ each independently represent a hydrogen atom or a halogen atom),

one or two or more compounds represented by the following general formula (ii)

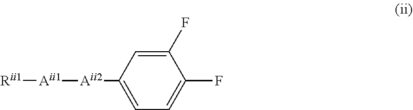

(wherein, in general formula (ii),

Rⁱⁱ¹ represents an alkyl group having 1 to 20 carbon atoms,

one or two or more —CH₂— groups in the alkyl group may each independently be replaced with —O— and/or —CO—,

one or two or more —CH₂—CH₂— groups in the alkyl group may each independently be replaced with —CH═CH— and/or —C≡C—,

one or two or more hydrogen atoms in the alkyl group may each independently be replaced with a halogen atom,

provided that no oxygen atoms are bonded directly to each other,

Aⁱⁱ¹ and Aⁱⁱ² each independently represent a group selected from the group consisting of the following groups (a) and (b):
(a) a 1,4-cyclohexylene group (one —CH₂— group or two or more non-adjacent —CH₂— groups present in this group may be replaced with —O— and/or —S—); and
(b) a 1,4-phenylene group (one —CH═ group or two or more non-adjacent —CH═ groups present in this group may be replaced with —N═), and

one or two or more hydrogen atoms in Aⁱⁱ¹ and Aⁱⁱ² may each independently be replaced with a halogen atom); and

one or two or more dye compounds.

### (Appendix 2)

The dye compound-containing liquid crystal composition according to Appendix 1, further containing one or two or more compounds represented by the following general formula (iii)

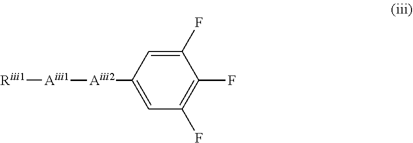

(wherein, in general formula (iii),

Rⁱⁱⁱ¹ represents an alkyl group having 1 to 20 carbon atoms,

one or two or more —CH₂— groups in the alkyl group may each independently be replaced with —O— and/or —CO—,

one or two or more —CH₂—CH₂— groups in the alkyl group may each independently be replaced with —CH═CH— and/or —C≡C—,

one or two or more hydrogen atoms in the alkyl group may each independently be replaced with a halogen atom,

provided that no oxygen atoms are bonded directly to each other,

Aⁱⁱⁱ¹ and Aⁱⁱⁱ² each independently represent a group selected from the group consisting of the following groups (a) and (b):
(a) a 1,4-cyclohexylene group (one —CH₂— group or two or more non-adjacent —CH₂— groups present in this group may be replaced with —O— and/or —S—); and
(b) a 1,4-phenylene group (one —CH═ group or two or more non-adjacent —CH═ groups present in this group may be replaced with —N═), and

one or two or more hydrogen atoms in Aⁱⁱⁱ¹ and Aⁱⁱⁱ² may each independently be replaced with a halogen atom).

### (Appendix 3)

The dye compound-containing liquid crystal composition according to Appendix 1 or 2, further containing one or two or more compounds represented by the following general formula (iv)

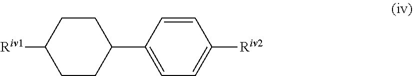

(wherein, in general formula (iv),

R^{iv1} and R^{iv2} each independently represent an alkyl group having 1 to 20 carbon atoms,

one or two or more —CH₂— groups in the alkyl group may each independently be replaced with —O— and/or —CO—,

one or two or more —CH₂—CH₂— groups in the alkyl group may each independently be replaced with —CH═CH— and/or —C≡C—, and

one or two or more hydrogen atoms in the alkyl group may each independently be replaced with a halogen atom,

provided that no oxygen atoms are bonded directly to each other).

### (Appendix 4)

The dye compound-containing liquid crystal composition according to any one of Appendixes 1 to 3, further containing one or two or more compounds represented by the following general formula (v)

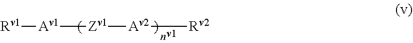

(wherein, in general formula (v),

R^{v1} represents an alkyl group having 1 to 20 carbon atoms,

one or two or more —CH₂— groups in the alkyl group may each independently be replaced with —O— and/or —CO—,

one or two or more —CH₂—CH₂— groups in the alkyl group may each independently be replaced with —CH═CH— and/or —C≡C—,

one or two or more hydrogen atoms in the alkyl group may each independently be replaced with a halogen atom,

provided that no oxygen atoms are bonded directly to each other,

R^{v2} represents a halogen atom, —CN, —OCN, or —C≡CCN,

A^{v1} and A^{v2} each independently represent a group selected from the group consisting of the following groups (a), (b), and (c):
(a) a 1,4-cyclohexylene group (one —CH₂— group or two or more non-adjacent —CH₂— groups present in this group may be replaced with —O— and/or —S—);
(b) a 1,4-phenylene group (one —CH═ group or two or more non-adjacent —CH═ groups present in this group may be replaced with —N═); and
(c) a naphthalene-2,6-diyl group or a decahydronaphthalene-2,6-diyl group (one —CH═ group or two or more non-adjacent —CH═ groups present in the naphthalene-2,6-diyl group may be replaced with —N═),

one or two or more hydrogen atoms in A^{v1} and A^{v2} may each independently be replaced with a halogen atom,

Z^{v1} represents a single bond or an alkylene group having 1 to 20 carbon atoms,

one or two or more —CH₂— groups in the alkylene group may each independently be replaced with —O—, —CH(CH₃)—, —CO— and/or —CF₂—,

one or two or more —CH₂—CH₂— groups in the alkylene group may each independently be replaced with —CH═CH—, —CF═CH—, —CH═CF—, —CF═CF—, —CH═C(CH₃)—, —C(CH₃)═CH—, —CH═N—, —N═CH—, —N═N— and/or —C≡C—,

provided that no oxygen atoms are bonded directly to each other,

n^{v1} represents an integer of 1 to 3,

when a plurality of A^{v2} are present, they may be the same or different, and

when a plurality of Z^{v1} are present, they may be the same or different,

provided that the compounds represented by general formulas (ii) and (iii) are excluded).

### (Appendix 5)

The dye compound-containing liquid crystal composition according to any one of Appendixes 1 to 4, further containing one or two or more compounds represented by the following general formula (vi)

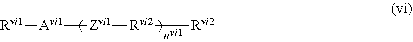

(wherein, in general formula (vi),

R^{vi1} and R^{vi2} each independently represent an alkyl group having 1 to 20 carbon atoms,

one or two or more —CH₂— groups in the alkyl group may each independently be replaced with —O— and/or —CO—,

one or two or more —CH₂—CH₂— groups in the alkyl group may each independently be replaced with —CH═CH— and/or —C≡C—,

provided that no oxygen atoms are bonded directly to each other,

A^{vi1} and A^{vi2} each independently represent a group selected from the group consisting of the following groups (a), (b), and (c):
(a) a 1,4-cyclohexylene group (one —CH₂— group or two or more non-adjacent —CH₂— groups present in this group may be replaced with —O— and/or —S—);
(b) a 1,4-phenylene group (one —CH═ group or two or more non-adjacent —CH═ groups present in this group may be replaced with —N═); and
(c) a naphthalene-2,6-diyl group or a decahydronaphthalene-2,6-diyl group (one —CH═ group or two or more non-adjacent —CH═ groups present in the naphthalene-2,6-diyl group may be replaced with —N═),

one or two or more hydrogen atoms in A^{vi1} and A^{vi2} may each independently be replaced with an alkyl group having 1 to 6 carbon atoms,

Z^{vi1} represents a single bond or an alkylene group having 1 to 20 carbon atoms,

one or two or more —CH₂— groups in the alkylene group may each independently be replaced with —O—, —CH(CH₃)—, —CO— and/or —CF₂—,

one or two or more —CH₂—CH₂— groups in the alkylene group may each independently be replaced with —CH═CH—, —CF═CH—, —CH═CF—, —CF═CF—, —CH═C(CH₃)—, —C(CH₃)═CH—, —CH═N—, —N═CH—, —N═N— and/or —C≡C—,

provided that no oxygen atoms are bonded directly to each other,

n^{vi1} represents an integer of 1 to 3,

when a plurality of A^{vi2} are present, they may be the same or different, and

when a plurality of Z^{vi1} are present, they may be the same or different,

provided that the compounds represented by general formulas (i) and (iv) are excluded).

### (Appendix 6)

The dye compound-containing liquid crystal composition according to any one of Appendixes 1 to 5, wherein the one or two or more dye compounds each have maximum absorption at 350 to 700 nm.

### (Appendix 7)

The dye compound-containing liquid crystal composition according to Appendix 6, wherein the one or two or more dye compounds are each a dichroic dye compound.

### (Appendix 8)

The dye compound-containing liquid crystal composition according to any one of Appendixes 1 to 7, further containing a chiral agent.

### (Appendix 9)

The dye compound-containing liquid crystal composition according to any one of Appendixes 1 to 8, wherein the content of the compound represented by general formula (i) and/or the compound represented by general formula (ii) is 10% by mass or more.

### (Appendix 10)

A device including the dye compound-containing liquid crystal composition according to any one of Appendixes 1 to 9.

### (Appendix 11)

The device according to Appendix 10, wherein the device is a light control device.

In the present disclosure, the number of components (such as devices) may be one and may be two or more, so long as no contradiction arises.

In the exemplary embodiments described above, a software configuration using a computer is used to implement information output processing, but the techniques of the present disclosure are not limited thereto. For example, instead of the software configuration using the computer, only a hardware configuration such as an FPGA (Field-Programmable Gate Array) or an ASIC (Application Specific Integrated Circuit) may be used to execute the liquid crystal light control processing. Part of the liquid crystal light control processing may be executed by a software configuration, and the rest of the processing may be executed by a hardware configuration.

The above-described program can be stored and provided to a computer using any type of non-transitory computer readable media. Non-transitory computer readable media include any type of tangible storage media. Examples of the non-transitory computer readable media include magnetic storage media (such as flexible disks, magnetic tapes, and hard disk drives), optical magnetic storage media (such as magneto-optical disks), CD-ROM (compact disc read only memory), CD-R, CD-R/W, and semiconductor memories (such as mask ROM, PROM (Programmable ROM), EPROM (erasable PROM), flash ROM, and RAM (Random Access Memory)). The program may be provided to a computer using any type of transitory computer readable media. Examples of the transitory computer readable media include electric signals, optical signals, and electromagnetic waves. Transitory computer readable media can provide the program to a computer via a wired communication line such as electric wires or optical fibers or a wireless communication line.

The above-described information output processing is merely an example. Therefore, it will be appreciated that any unnecessary step may be omitted, that a new step may be added, or that the order of the processing may be changed, so long as they do not depart from the scope of the disclosure.

All the documents, patent applications, and technical standards described in the present specification are incorporated herein by reference to the same extent as if each individual document, patent application, or technical standard was specifically and individually indicated to be incorporated by reference.

1. A liquid crystal light control apparatus comprising:
a pair of electrodes;
a liquid crystal composition that is disposed between the pair of electrodes and satisfies d/p≥2, where d is a distance between the pair of electrodes and p is a chiral pitch;
a voltage application unit that applies a voltage between the pair of electrodes; and
a controller that controls the voltage application unit such that an intermediate voltage for aligning liquid crystal molecules of the liquid crystal composition in a focal conic alignment state is applied between the pair of electrodes after a first voltage for aligning the liquid crystal molecules in a homeotropic alignment state is applied between the pair of electrodes but before a second voltage that is different in magnitude from the first voltage and is for aligning the liquid crystal molecules in a planar alignment state is applied between the pair of electrodes.

2. The liquid crystal light control apparatus according to claim 1, wherein the intermediate voltage includes a voltage whose magnitude is between a magnitude of the first voltage and a magnitude of the second voltage.

3. The liquid crystal light control apparatus according to claim 1, wherein the controller controls the voltage application unit such that the intermediate voltage is applied according to a predetermined application pattern.

4. The liquid crystal light control apparatus according to claim 2, wherein the controller controls the voltage application unit such that the intermediate voltage gradually decreases.

5. The liquid crystal light control apparatus according to claim 2, wherein the intermediate voltage includes a plurality of voltages that differ in magnitude, and
wherein the controller controls the voltage application unit such that the plurality of voltages are applied in descending order of magnitude.

6. The liquid crystal light control apparatus according to claim 2, wherein the intermediate voltage includes a first intermediate voltage and a second intermediate voltage larger in magnitude than the first intermediate voltage, and
wherein the controller controls the voltage application unit such that the first intermediate voltage and the second intermediate voltage are alternately applied at least one time.

7. The liquid crystal light control apparatus according to claim 6, wherein the controller controls the voltage application unit such that the second intermediate voltage of a constant magnitude is applied a plurality of times while an application time of the second intermediate voltage is reduced.

8. The liquid crystal light control apparatus according to claim 1, wherein the controller changes an application state of the voltage according to at least one of a physical property value of the liquid crystal composition and the distance between the pair of electrodes.

9. The liquid crystal light control apparatus according to claim 8, wherein the application state of the voltage is determined by at least one of a magnitude of the voltage and an application time of the voltage.

10. The liquid crystal light control apparatus according to claim 1, wherein a liquid crystal panel including the pair of electrodes and the liquid crystal composition is formed, and
wherein, when the voltage is applied to the liquid crystal composition, a transmission state of light passing through the liquid crystal panel changes.

11. The liquid crystal light control apparatus according to claim 10, wherein the first voltage is a voltage for changing the transmission state to a designated transmission state.

12. The liquid crystal light control apparatus according to claim 10, wherein the transmission state is defined by transmittance or haze.

13. The liquid crystal light control apparatus according to claim 2, wherein the liquid crystal composition contains a dichroic dye.

14. The liquid crystal light control apparatus according to claim 1, wherein, when the first voltage is applied, the liquid crystal molecules are aligned such that a major axis direction of the liquid crystal molecules is oriented in a direction of an electric field between the pair of electrodes.

15. The liquid crystal light control apparatus according to claim 2, wherein the second voltage is a voltage for aligning the liquid crystal molecules in a twisted state.

16. The liquid crystal light control apparatus according to claim 1, wherein the pair of electrodes includes a pair of alignment films that causes the liquid crystal molecules of the liquid crystal composition to align horizontally.

17. A light control method for a liquid crystal light control apparatus including
a pair of electrodes,
a liquid crystal composition that is disposed between the pair of electrodes and satisfies d/p≥2, where d is a distance between the pair of electrodes and p is a chiral pitch, and
a voltage application unit that applies a voltage between the pair of electrodes,
the method comprising applying, between the pair of electrodes, an intermediate voltage for aligning liquid crystal molecules of the liquid crystal composition in a focal conic alignment state after a first voltage for aligning the liquid crystal molecules in a homeotropic alignment state is applied between the pair of electrodes but before a second voltage that is different in magnitude from the first voltage and is for aligning the liquid crystal molecules in a planar alignment state is applied between the pair of electrodes.

18. A non-transitory computer readable medium storing a liquid crystal light control program that causes a computer to function as the controller in the liquid crystal light control apparatus according to claim 1.
